(19) United States
(12) Patent Application Publication
(10) Pub. No.: US 2022/0205959 A1
(43) Pub. Date: Jun. 30, 2022

(54) ACOUSTIC SPECTROMETER

(71) Applicant: Massachusetts Institute of Technology, Cambridge, MA (US)

(72) Inventors: Nickolas Peter DEMAS, Watertown, MA (US); Ian W. HUNTER, Lincoln, MA (US)

(73) Assignee: Massachusetts Institute of Technology, Cambridge, MA (US)

(21) Appl. No.: 17/441,713

(22) PCT Filed: Nov. 18, 2019
(86) PCT No.: PCT/US2019/061913

§ 371 Date: Sep. 22, 2021

Related U.S. Application Data
(60) Provisional application No. 62/793,054, filed on Jan. 16, 2019.

(51) Int. Cl. G01N 29/46; G01N 29/02; G01N 29/34

(52) U.S. Cl. CPC G01N 29/46; G01N 29/02; G01N 2291/103; G01N 2291/021; G01N 2291/02809; G01N 29/348

(57) ABSTRACT

Disclosed herein are acoustic spectrometers with broadband actuators and advanced system identification techniques for modeling the characteristic response of a gas. Benefits of the spectrometer devices and methods disclosed herein, which can include speed of sound measurements (or combined therewith), provide for more robust and less expensive solutions than previous technologies.

### CROSS-REFERENCE TO RELATED APPLICATION

This application claims priority to U.S. Provisional Application No. 62/793,054 filed Jan. 16, 2019, titled “ACOUSTIC SPECTROMETER”, the entire disclosure of which is incorporated herein by reference.

### BACKGROUND

Existing gas sensing instruments are unable to leverage differences in classical attenuation. Such instruments, that typically measure non-classical acoustic attenuation, rely on highly resonant transducers and vary pressure to produce a quasi-spectrum, making the setups large, bulky, and expensive. Additionally, the analysis techniques used to measure non-classical attenuation by such instruments are rudimentary.

### SUMMARY

A spectrometer includes an emitter to perturb a material with acoustic energy in response to an input signal, the acoustic energy having at least two distinct frequency components. The spectrometer also includes a set of receivers that generates a set of output signals, each receiver disposed at a different distance from the emitter than each other receiver. Each receiver measures a response of the material to the acoustic energy as an output signal of the set of output signals, the output signal for that receiver based on the distance of that receiver to the emitter. The spectrometer also includes a controller, operably coupled to the emitter and the set of receivers, to drive the emitter with the input signal, to measure the set of output signals from the set of receivers, and to perform a signal analysis based on the input signal and the set of output signals. The signal analysis yields a characteristic response of the material to the acoustic energy.

A method of characterizing a material includes perturbing, via an emitter, the material with acoustic energy, the acoustic energy having at least two distinct frequency components. The method also includes measuring, with each receiver of a set of receivers, wherein each receiver is disposed at a different distance from the emitter than each other receiver of the set of receivers, a response of the material to the acoustic energy as an output signal. The output signal for that receiver is based on the distance of that receiver to the emitter. A set of output signals is generated.

A method of detecting methane in ambient air includes driving an emitter with an input signal. The emitter includes an interface to interact with the ambient air. The method also includes perturbing, via the interface of the emitter, the ambient air with acoustic energy generated in response to the input signal. The acoustic energy has at least two distinct frequency components. The method further includes measuring, with each receiver of a set of receivers, wherein each receiver is disposed at a different distance from the emitter than each other receiver of the set of receivers, a response of the methane to the acoustic energy as an output signal to generate a set of output signals. The output signal for each receiver is based on the distance of that receiver to the emitter. The method also includes performing a signal analysis based on the input signal and the set of output signals to generate a characteristic response of the methane to the acoustic energy, thereby identifying the presence of methane in the ambient air. The signal analysis includes segmenting the input signal into a set of input signal segments of length N samples each and segmenting the output signal into a set of output signal segments of length N samples each. The signal analysis further includes calculating an input power auto-correlation spectrum for each input signal segment to generate a set of input power auto-correlation spectrums. The signal analysis also includes calculating an input output power cross-correlation spectrum for each input signal segment and its corresponding output signal segment to generate a set of input output power cross-correlation spectrums. The characteristic response of the methane in the ambient air is calculated based on a ratio of an average of the set of input output power cross-correlation spectrums to an average of the set of input power auto-correlation spectrums.

A spectrometer includes a chamber having a cavity to receive a material, and at least one transducer, mechanically coupled to the chamber, to perturb the material with acoustic energy in response to an input signal and to measure a response of the material to the acoustic energy as an output signal. The acoustic energy has at least two distinct frequency components. The spectrometer also includes a controller, operably coupled to the at least one transducer, to drive the at least one transducer with the input signal, to measure the output signal with the at least one transducer, and to perform a signal analysis based on the input signal and the output signal. The signal analysis yields a characteristic response of the material to the acoustic energy.

A spectrometer includes at least one transducer, mechanically couplable to a chamber having a cavity with a material disposed therein, to perturb the material with acoustic energy in response to an input signal and to measure a response of the material to the acoustic energy as an output signal. The acoustic energy has at least two distinct frequency components. The spectrometer also includes a controller, operably coupled to the at least one transducer, to drive the at least one transducer with the input signal, to measure the output signal with the at least one transducer, and to perform a signal analysis based on the input signal and the output signal. The signal analysis yields a characteristic response of the material to the acoustic energy.

A spectrometer includes at least one transducer to perturb a material with acoustic energy in response to an input signal and to measure a response of the material to the acoustic energy as an output signal. The acoustic energy has at least two distinct frequency components, and a controller, operably coupled to the at least one transducer, to drive the at least one transducer with the input signal, to measure the output signal with the at least one transducer, and to perform a signal analysis based on the input signal and the output signal. The signal analysis yields a characteristic response of the material to the acoustic energy.

A spectrometer includes an emitter to perturb a material with acoustic energy in response to an input signal, the acoustic energy having at least two distinct frequency components. The spectrometer also includes a set of receivers to generate a set of output signals. Each receiver is disposed at a different distance from the emitter than each other receiver. Each receiver measures a response of the material to the acoustic energy as an output signal in the set of output signals. The output signal for that receiver is based on the distance of that receiver to the emitter. The spectrometer also includes a controller to drive the emitter with the input signal, to measure the set of output signals from the set of receivers, and to perform a signal analysis. The signal analysis is based on a first output signal of the set of output signals from a first receiver of the set of receivers as an input signal for the signal analysis. The signal analysis is also based on remaining output signals of the set of output signals as output signals for the signal analysis. The signal analysis yields a characteristic response of the material to the acoustic energy.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates an example acoustic spectrometer.

FIG. 2 illustrates another example acoustic spectrometer.

FIG. 3 illustrates yet another example acoustic spectrometer.

FIG. 4 illustrates yet another example acoustic spectrometer.

FIG. 5 illustrates yet another example acoustic spectrometer.

FIG. 6 illustrates yet another example acoustic spectrometer.

FIG. 7A is a plot of the magnitude of the acoustic spectra for dry nitrogen and dry carbon dioxide.

FIG. 7B is a plot of the phase of the acoustic spectra for dry nitrogen and dry carbon dioxide.

FIG. 7C is a plot of the magnitude squared coherence (MSC) of the acoustic spectra for dry nitrogen and dry carbon dioxide.

FIG. 8A is a plot of the phase of the acoustic spectra for dry carbon dioxide.

FIG. 8B is a plot of the MSC of the acoustic spectra for dry carbon dioxide.

FIG. 9 shows the relationship between relative humidity and partial pressure. The areas that are not colored exceed 100% relative humidity.

FIG. 10 shows the relationship between relative humidity and partial pressure. The y-axis is plotted with logarithmic spacing, as opposed to linear spacing as presented in FIG. 9. The areas that are not colored exceed 100% relative humidity.

FIG. 11 shows the pressure waveform (as a function of position in the direction of propagation and time) of a plane wave with attenuation.

FIG. 12 is a plot showing the relationship between sound speed and the main classical term for “wide” tubes and described herein for a variety of pure gases at P=101.325 kPa and T=298.15 K (25° C.).

FIG. 13 is a plot showing the modeled relationship between sound speed and the main classical term for “wide” tubes for a variety of pure gases at P=101.325 kPa and T ranging from 273.15 K (0° C.) to 348.15 K (75° C.). The labels point to the 75° C. position and the values for each gas extend along a vector pointed towards the bottom left of the plot in the order purple, amber, blue, red (with decreasing temperature).

FIG. 14 is a plot showing the modeled relationship between sound speed and the main classical term for “wide” tubes for a variety of pure gases at T=298.15 K (25° C.) and P ranging from 60 kPa to 140 kPa. The labels point to the 140 kPa position and the values for each gas extend along a vector pointed towards the right of the plot in the order purple, amber, blue, red, green (with decreasing pressure).

FIG. 15 is a nonclassical model diagram showing all relevant components and their relationships. The equations in the dashed box at the right are solved simultaneously.

FIG. 16 is shows representations of Methods A and B. The equations shown are the constraints imposed by Method B. The additional markings indicate the maximum well depth of the Lennard-Jones potential −ε, the radius of minimum potential energy rₘ, the zero potential point σ, and the classical turning point r_{c}.

FIG. 17 is a plot showing the potential difference between the Lennard-Jones and exponential potential at r=r_{c(i,j)} (blue, straight line) and r=σ_{(i,j)} i(red, curved line) for a range of α*_{i,j} values for pure nitrogen at T=25° C. and P=101.325 Pa for vibration-to-translation transfer with a first-order quantum jump. The α*_{i,j} noted is the point where the difference between the potentials at r=σ_{(i,j)} is equal to zero (the potential difference at r=r_{c(i,j)} is zero for all α*_{i,j} given Eqn. 3.43). This technique was repeated for the interactions between different vibrational modes and molecules to find the appropriate α*_{i,j} to meet both constraints imposed by Method B.

FIG. 18 is a plot showing the Lennard-Jones potential and exponential potential fit using Method B for nitrogen for a variety of r values. The potential values match at the classical turning point r=r_{c(i,j)} (the vertical red line on the left) and the zero potential point r=σ_{(i,j)} (or hard-sphere collision diameter, indicated by the vertical red line on the right).

FIG. 19A includes experimental values digitized from the literature, shown as open circles (color coding shown in the legend in FIG. 19B). The non-classical simulation is shown as a line, color coded to match the relevant experiment it represents. FIG. 19A shows attenuation non-dimensionalized by wavelength (the y-axis is unitless). For the simulated lines in FIG. 19A, the lines connect the simulated results.

FIG. 19B shows the difference between the non-classical sound speed (calculated using the real part of the wavenumber calculated using Eqn. 3.78) and the adiabatic sound speed (calculated using Eqn. 2.14) as a function of frequency. For the simulated lines in FIG. 19B, the lines connect the simulated results.

FIG. 20A includes experimental values digitized from the literature, shown as open circles (color coding shown in the legend in FIG. 20B). The non-classical simulation is shown as a line, color coded to match the relevant experiment it represents. For the simulated lines in FIG. 20A, the lines connect the simulated results.

FIG. 20B is identical FIG. 19B and shows the difference between the non-classical sound speed (calculated using the real part of the wavenumber calculated using Eqn. 3.78) and the adiabatic sound speed (calculated using Eqn. 2.14) as a function of frequency. For the simulated lines in FIG. 20B, the lines connect the simulated results.

FIG. 21A includes experimental values digitized from the literature, shown as open circles (color coding shown in the legend in FIG. 21B). The non-classical simulation is shown as a line, color coded to match the relevant experiment it represents. FIG. 21A shows attenuation non-dimensionalized by wavelength (the y-axis is unitless). For the simulated lines in FIG. 21A, the lines connect the simulated results.

FIG. 21B shows the difference between the non-classical sound speed (calculated using the real part of the wavenumber calculated using Eqn. 3.78) and the adiabatic sound speed (calculated using Eqn. 2.14) as a function of frequency. For the simulated lines in FIG. 21B, the lines connect the simulated results.

FIG. 22A includes experimental values digitized from the literature, shown as open circles (color coding shown in the legend in FIG. 22B). The non-classical simulation is shown as a line, color coded to match the relevant experiment it represents. For the simulated lines in both FIG. 22A, the lines connect the simulated results.

FIG. 22B is identical to FIG. 21B and shows the difference between the non-classical sound speed (calculated using the real part of the wavenumber calculated using Eqn. 3.78) and the adiabatic sound speed (calculated using Eqn. 2.14) as a function of frequency. For the simulated lines in both FIGS. 22B, the lines connect the simulated results.

FIG. 23A includes experimental values digitized from the literature, shown as open circles (color coding shown in the legend in FIG. 23B). The non-classical simulation is shown as a line, color coded to match the relevant experiment it represents. Note that FIG. 23A shows attenuation non-dimensionalized by wavelength (the y-axis is unitless). For the simulated lines in FIG. 23A, the lines connect the simulated results.

FIG. 23B shows the difference between the non-classical sound speed (calculated using the real part of the wavenumber calculated using Eqn. 3.78) and the adiabatic sound speed (calculated using Eqn. 2.14) as a function of frequency. For the simulated lines in FIG. 23B, the lines connect the simulated results.

FIG. 24A includes experimental values digitized from the literature, shown as open circles (color coding shown in the legend in FIG. 24B). The non-classical simulation is shown as a line, color coded to match the relevant experiment it represents. For the simulated lines FIG. 24A, the lines connect the simulated results.

FIG. 24B is identical to FIG. 23B and shows the difference between the non-classical sound speed (calculated using the real part of the wavenumber calculated using Eqn. 3.78) and the adiabatic sound speed (calculated using Eqn. 2.14) as a function of frequency. For the simulated lines FIG. 24B, the lines connect the simulated results.

FIG. 25A includes experimental values digitized from the literature, shown as open circles (color coding shown in the legend in FIG. 25B). The non-classical simulation is shown as a line, color coded to match the relevant experiment it represents. FIG. 25A shows attenuation non-dimensionalized by wavelength (the y-axis is unitless). For the simulated lines in FIG. 25A, the lines connect the simulated results.

FIG. 25B shows the difference between the non-classical sound speed (calculated using the real part of the wavenumber calculated using Eqn. 3.78) and the adiabatic sound speed (calculated using Eqn. 2.14) as a function of frequency. For the simulated lines in FIG. 25B, the lines connect the simulated results.

FIG. 26A includes experimental values digitized from the literature, shown as open circles (color coding shown in the legend in FIG. 26B). The non-classical simulation is shown as a line, color coded to match the relevant experiment it represents. For the simulated lines in FIG. 26A, the lines connect the simulated results.

FIG. 26B is identical to FIG. 25B and shows the difference between the non-classical sound speed (calculated using the real part of the wavenumber calculated using Eqn. 3.78) and the adiabatic sound speed (calculated using Eqn. 2.14) as a function of frequency. For the simulated lines in FIG. 26B, the lines connect the simulated results.

FIG. 27A includes experimental values digitized from the literature, shown as open circles (color coding shown in the legend in FIG. 27B). The non-classical simulation is shown as a line, color coded to match the relevant experiment it represents. FIG. 27A shows attenuation non-dimensionalized by wavelength (the y-axis is unitless). For the simulated lines in FIG. 27A, the lines connect the simulated results.

FIG. 27B shows the difference between the non-classical sound speed (calculated using the real part of the wavenumber calculated using Eqn. 3.78) and the adiabatic sound speed (calculated using Eqn. 2.14) as a function of frequency. For the simulated lines in FIG. 27B, the lines connect the simulated results.

FIG. 28A includes experimental values digitized from the literature, shown as open circles (color coding shown in the legend in FIG. 28B). The non-classical simulation is shown as a line, color coded to match the relevant experiment it represents. For the simulated lines in FIG. 28A, the lines connect the simulated results.

FIG. 28B is identical to FIG. 27B and shows the difference between the non-classical sound speed (calculated using the real part of the wavenumber calculated using Eqn. 3.78) and the adiabatic sound speed (calculated using Eqn. 2.14) as a function of frequency. For the simulated lines in FIG. 28B, the lines connect the simulated results.

FIG. 29 is a CAD model showing the design of the first acoustic sensor. The cavity is 50 mm long and 36 mm in diameter. The positions of the microphone and voice coil speaker are not constrained and float in the cavity.

FIG. 30 is an image showing the assembled version 1 hardware. Feedthroughs (sealed with wax) allow the wires leading to the speaker and microphone to emerge from the left end cap.

FIG. 31 shows a simplified block diagram for several acoustic sensors, including versions 1, 2 and 3.1. The dynamics of the speaker and microphone are part of the total measured dynamics in versions 1, 2 and 3.1.

FIG. 32A shows a Bode plot spectrum of magnitude for measurements from samples of nitrogen and methane. The additional overlapping curves offset due to sound speed differences are not plotted. The offset between nitrogen and methane can be explained by the difference in sound speed (a_{N}_{₂}=349 m s⁻¹, a_{CH}_{₄}=446 m s⁻¹ at room temperature). Amplitude on the y-axis in FIG. 32A is in arbitrary units.

FIG. 32B shows a Bode plot spectrum of phase for measurements from samples of nitrogen and methane. The additional overlapping curves offset due to sound speed differences are not plotted. The offset between nitrogen and methane can be explained by the difference in sound speed (a_{N}_{₂}=349 m s⁻¹, a_{CH}_{₄}=446 m s⁻¹ at room temperature).

FIG. 32C shows a Bode plot spectrum of coherence estimate via welch for measurements from samples of nitrogen and methane. MSC on the y-axis of FIG. 32C stands for magnitude squared coherence.

FIG. 33A shows a Bode plot spectrum of magnitude for measurements from samples of nitrogen, methane, carbon monoxide, carbon dioxide, argon and oxygen recast as a function of wavelength. FIG. 33A shows the differences in amplitude below 4×10⁻² m. Amplitude on the y-axis of FIG. 33A is in arbitrary units.

FIG. 33B shows a Bode plot spectrum of phase for measurements from samples of nitrogen, methane, carbon monoxide, carbon dioxide, argon and oxygen recast as a function of wavelength. FIGS. 33B shows the differences in amplitude below 4×10⁻² m.

FIG. 33C shows a Bode plot spectrum of coherence estimate via welch for samples of nitrogen, methane, carbon monoxide, carbon dioxide, argon and oxygen recast as a function of wavelength. MSC on the y-axis of FIG. 33C stands for magnitude squared coherence. FIGS. 33C shows the differences in amplitude below 4×10⁻² m.

FIG. 34 is an image showing several parameters. Version 2 was specifically designed to test how these parameters affected the measured acoustic system.

FIG. 35 is a CAD model showing the design of the second acoustic sensor. Like version 1, the cavity is approximately 50 mm long and 36 mm in diameter. The positions of the microphone and voice coil speaker are well constrained. Temperature sensing and control were added in version 2 (the heaters are shown in FIG. 36). Version 2 has side-mounted inlet and outlet valves versus coaxially mounted valves which provides an improved purge time over version 1.

FIG. 36 shows the relevant hardware for the second acoustic sensor. Two chambers were constructed, each of a different length, which are shown in the upper left. The heater is controlled by a custom-built controller, shown in the bottom left. Various microphones and speakers were mounted on printed circuit boards that were designed and fabricated (shown in the lower left). These elements can be combined in various configurations, as shown in the upper right. A 28 AWG copper magnet wire (Soderon® MW0064) pass through hermetic feedthroughs sealed with potting epoxy connects the sensors and actuators to an exterior strain relief board and interfaces with the DAQ system.

FIG. 37 shows the differences between the version 1 and the version 2 data acquisition system.

FIG. 38 is a screenshot of the LabVIEW custom VI interface that was designed. It includes step-by-step instructions to guide experiments. These steps include embedded fields, check lights, and plots which input or show information relevant to that step. Functions to automatically name files with unique identifiers in addition to archive parameters were integrated into this software.

FIG. 39 shows the fully assembled “short” version 2 sensor with temperature controller in the background.

FIG. 40 is a graph showing the gains for two different microphones as a function of frequency (curves digitized from the respective data sheets). Gain is normalized against the gain at 1 kHz. Neither phase data nor magnitude squared coherence is reported in the data sheet. The ICS40618 microphone that is sensitive in a lower frequency range is produced by TDK InvenSense. The SPU0410LR5H microphone that is sensitive in a higher frequency range is produced by Knowles.

FIG. 41 shows the gains for two different speakers as a function of frequency (curves digitized from the respective data sheets). Gain is normalized against the gain at 1 kHz. Neither phase data nor magnitude squared coherence is reported in the data sheet. Both models are produced by CUI Inc. For implementation with the acoustic spectrometer, CDS15118BL100 was used for versions prior to and including 3.1 whereas CMS15118DL100 was used for version 3.2.

FIG. 42A shows a magnitude (gas cavity) plot for comparisons between three gas mixtures with nearly the same sound speed over a “low” frequency range using version 2. The resonant structures are well aligned. FIG. 42A has been corrected, in that the combined gain of the speaker and microphone have been removed. However, because only gain information was available for the speaker and microphone, the phase and magnitude squared coherence plots are for the whole system. No attenuation is evident between pure oxygen (which has a low (relative) attenuation coefficient) and either of the mixtures containing carbon dioxide (which has a high (relative) attenuation coefficient). The amplitude in FIG. 42A is reported in arbitrary units.

FIG. 42B shows a phase plot for comparisons between three gas mixtures with nearly the same sound speed over a “low” frequency range using version 2.

FIG. 42C shows a magnitude squared coherence via power spectrum FFT plot for comparisons between three gas mixtures with nearly the same sound speed over a “low” frequency range using version 2.

FIG. 43A shows a magnitude (gas cavity) plot for comparisons between three gas mixtures with nearly the same sound speed over a “high” frequency range using version 2. The resonant structures are nearly aligned. FIG. 43A has been corrected, in that the combined gain of the speaker and microphone have been removed. However, because only gain information was available for the speaker and microphone, the phase and magnitude squared coherence plots are for the whole system. These results are not as clear as those shown in FIGS. 42A-42C, but attenuation is again difficult to identify between pure oxygen (which has a low (relative) attenuation coefficient) and either of the mixtures containing carbon dioxide (which has a high (relative) attenuation coefficient). The amplitude in FIG. 43A is reported in arbitrary units.

FIG. 43B shows a phase plot for comparisons between three gas mixtures with nearly the same sound speed over a “high” frequency range using version 2.

FIG. 43C shows a magnitude squared coherence via power spectrum FFT plot for comparisons between three gas mixtures with nearly the same sound speed over a “high” frequency range using version 2.

FIG. 44A shows sound pressure transmission at two lengths for a variety of gases for version 2. Strong attenuation is not observable at a short transmission length of 10 mm, but is readily apparent within the bandwidth of both actuators for a longer transmission length of 629 mm. Black represents pure nitrogen, blue represents pure oxygen, and the shades of purple and orange represent carbon dioxide/nitrogen mixtures and methane/nitrogen mixtures, respectively.

FIG. 44B shows sound pressure transmission at two lengths for a variety of gases for version 3.1. Strong attenuation is not observable at a short transmission length of 10 mm, but is readily apparent within the bandwidth of both actuators for a longer transmission length of 629 mm. Black represents pure nitrogen, blue represents pure oxygen, and the shades of purple and orange represent carbon dioxide/nitrogen mixtures and methane/nitrogen mixtures, respectively.

FIG. 45 is a CAD model showing the design of the third acoustic sensor. Unlike versions 1 and 2, the cavity in FIG. 45 has a very long aspect ratio (it is approximately 629 mm long and 12.7 mm in diameter). The custom PCBs built for version 2 are reused in this design (the horizontally mounted CDS15118BL100 by CUI Inc is visible in the exploded view of the actuator capsule at the bottom).

FIG. 46 is an image showing the assembled version 3.1 linear acoustic sensor. Electrical feedthroughs were filled with wax for this version prototype.

FIG. 47A shows a magnitude plot of comparisons between three gas mixtures with nearly the same sound speed over a “low” frequency range using version 3.1. The resonant structures are well aligned. Attenuation is evident between pure oxygen (for which little attenuation is expected, see FIGS. 44A-44B) and either of the mixtures containing carbon dioxide (for which high attenuation is expected, particularly at higher frequencies, see FIGS. 44A-44B). The amplitude in FIG. 47A is reported in arbitrary units.

FIG. 47B shows a phase plot of comparisons between three gas mixtures with nearly the same sound speed over a “low” frequency range using version 3.1.

FIG. 47C shows a magnitude squared coherence via power spectrum FFT plot of comparisons between three gas mixtures with nearly the same sound speed over a “low” frequency range using version 3.1.

FIG. 48A shows a color-coded representation of the pressure gradient of a plane wave in a tube with circular cross-section. Imagine that this is just a short section of a much longer tube. Based on the literature, waves with λ<1.64 r are expected to propagate in only this way.

FIG. 48B shows a color-coded representation of the pressure gradient of the first transverse sloshing mode in a tube with circular cross-section. Imagine that this is just a short section of a much longer tube. Based on the literature, inputted waves with λ>3.67 r are expected to excite this and other transverse modes. Inputted waves with λ>1.64 r may also excite this first transverse mode.

FIG. 49 is an array of plots showing mₜₒₜₐₗ (labeled as a on the y-axis) for dry air (v1_1_DryAir_0_0127 m_D) and helium (v1_10He_0_0127 m_D) as a function of frequency for a variety of pressures and temperatures. The attenuation coefficient includes both nonclassical and classical attenuation components arising within a straight tube with an internal diameter of 12.7 mm. Three vertical black lines are shown on each plot. From left to right (increasing frequency), the black lines represent the lower limit of the human auditory system (20 Hz), the upper limit of the human auditory system (20 kHz), and the upper limit for the SPU0410LR5H high frequency microphone (80 kHz), which represents the highest frequency that could possibly hope to be measured using commercially available transducers. The two green lines indicate the frequency corresponding to λ=1.64 r for each gas, and the two red lines indicate the frequency corresponding to λ=3.67 r for each gas. At frequencies above the left-most green line, the first transverse sloshing mode may be present, and certainly at frequencies above the right-most red line the transverse sloshing mode would be excited.

FIG. 50 is an array of plots showing ΔPₘₐₓ/P₀ for dry air (v1_10_DryAir_0_0127 m D) and helium (v1_10_He_0_0127 m D) as a function of frequency (x-axis) and transmission length (y-axis) for a variety of pressures and temperatures. The modeled attenuation for each gas includes both nonclassical and classical attenuation components arising within a straight tube with an internal diameter of 12.7 mm. Three vertical black lines are shown on each plot. From left to right (increasing frequency), the black lines represent the lower limit of the human auditory system (20 Hz), the upper limit of the human auditory system (20 kHz), and the upper limit of the SPU0410LR5H high frequency microphone (80 kHz), which represents the highest frequency that could possibly hope to be measured using commercially available transducers. The two green lines indicate the frequency corresponding to λ=1.64 r for each gas, and the two red lines indicate the frequency corresponding to λ=3.67 r for each gas. At frequencies above the left-most green line, the first transverse sloshing mode may be excited, and certainly at frequencies above the right-most red line the transverse sloshing mode (and others) would be excited.

FIG. 51 is an array of plots showing mₜₒₜₐₗ (labeled as a on the y-axis) for dry air (v1_10_DryAir_0_0127m_D) and carbon dioxide (v1-1_CO2_0_0127m_D) as a function of frequency for a variety of pressures and temperatures. The attenuation coefficient includes both nonclassical and classical attenuation components arising within a straight tube with an internal diameter of 12.7 mm. The attenuation coefficient for carbon dioxide is several orders of magnitude stronger than the coefficient for dry air from 10 kHz to 1 MHz. This is due to very strong nonclassical effects. Three vertical black lines are shown on each plot. From left to right (increasing frequency), the black lines represent the lower limit of the human auditory system (20 Hz), the upper limit of the human auditory system (20 kHz), and the upper limit of the SPU0410LR5H high frequency microphone (80 kHz), which represents the highest frequency that could possibly hope to be measured using commercially available transducers. The two green lines indicate the frequency corresponding to λ=1.64 r for each gas, and the two red lines indicate the frequency corresponding to λ=3.67 r for each gas. At frequencies above the left-most green line, the first transverse sloshing mode may be excited, and certainly at frequencies above the right-most red line the transverse sloshing mode (and others) would be excited.

FIG. 52 is an array of plots showing ΔPₘₐₓ/P₀ for dry air (v_10_DryAir_0-0127 m_D) and carbon dioxide (v1_10_CO2-0_0127 m_D) as a function of frequency (x-axis) and transmission length (y-axis) for a variety of pressures and temperatures. Very stark differences (upwards of 90% amplitude difference) arise between the simulated transmittance between these two gases around 10 kHz in a 1 m long, straight tube with a diameter of 12.7 mm. Three vertical black lines are shown on each plot. From left to right (increasing frequency), the black lines represent the lower limit of the human auditory system (20 Hz), the upper limit of the human auditory system (20 kHz), and the upper limit of the SPU0410LR5H high frequency microphone (80 kHz), which represents the highest frequency that could possibly hope to be measured using commercially available transducers. The two green lines indicate the frequency corresponding to λ=1.64 r for each gas, and the two red lines indicate the frequency corresponding to λ=3.67 r for each gas. At frequencies above the left-most green line, the first transverse sloshing mode may be present, and certainly at frequencies above the right-most red line the transverse sloshing mode would be excited.

FIG. 53 is an array of plots showing mₜₒₜₐₗ (labeled as α on the y-axis) for dry air (v1_10_DryAir_0_0127m_D) and sulfur hexafluoride (v1_10_SF6_0_0127 m_D) as a function of frequency for a variety of pressures and temperatures. The attenuation coefficient includes both nonclassical and classical attenuation components arising within a straight tube with an internal diameter of 12.7 mm. The attenuation coefficient for sulfur hexafluoride is several orders of magnitude stronger than the coefficient for dry air from 1 kHz to 100 kHz. This is due to strong nonclassical effects in the model. Three vertical black lines are shown on each plot. From left to right (increasing frequency), the black lines represent the lower limit of the human auditory system (20 Hz), the upper limit of the human auditory system (20 kHz), and the upper limit of the SPU0410LR5H high frequency microphone (80 kHz), which represents the highest frequency that could possibly hope to be measured using commercially available transducers. The two green lines indicate the frequency corresponding to λ=1.64 r for each gas, and the two red lines indicate the frequency corresponding to λ=3.67 r for each gas. At frequencies above the left-most green line, the first transverse sloshing mode may be excited, and certainly at frequencies above the right-most red line the transverse sloshing mode (and others) would be excited.

FIG. 54 is an array of plots showing ΔPₘₐₓ/P₀ for dry air (v_10_DryAir_0-0127 m_D) and sulfur hexafluoride (v1_10_CO2_0_0127 m_D) as a function of frequency (x-axis) and transmission length (y-axis) for a variety of pressures and temperatures. Stark differences (upwards of 50% amplitude difference) arise between the simulated transmittance between these two gases around 5 kHz in a 1 m long, straight tube with a diameter of 12.7 mm. Three vertical black lines are shown on each plot. From left to right (increasing frequency), the black lines represent the lower limit of the human auditory system (20 Hz), the upper limit of the human auditory system (20 kHz), and the upper limit of the SPU0410LR5H high frequency microphone (80 kHz), which represents the highest frequency that could possibly hope to be measured using commercially available transducers. The two green lines indicate the frequency corresponding to λ=1.64 r for each gas, and the two red lines indicate the frequency corresponding to λ=3.67 r for each gas. At frequencies above the left-most green line, the first transverse sloshing mode may be present, and certainly at frequencies above the right-most red line the transverse sloshing mode would be excited.

FIG. 55 is an array of plots showing mₜₒₜₐₗ (labeled as α on the y-axis) for dry air (v1_10_DryAir_Diams, as a solid plot) and sulfur hexafluoride (v1_10_SF6 Diams, as a dashed plot) for different commercially available internal diameters (including 3.175 mm (⅛in), 3.969 mm ( 5/32in), 4.318 mm (0.17 in), 6.350 mm (¼in), 9.525 mm (⅜in), and 12.7 mm (½in)). These were computed as a function of frequency for a variety of pressures and temperatures. The attenuation coefficient includes both nonclassical and classical attenuation components arising within a straight tube with the given diameter. Nonclassical attenuation is, as expected, obscured by the classical attenuation in smaller diameter tubes more so than in larger diameter tubes. The black lines mark the same positions as noted in FIG. 54. The finely dotted vertical lines (color coded for the relevant diameter) indicate the frequency corresponding when λ=1.64r for each gas, and the long-short-long dotted vertical lines (also color coded for the relevant diameter) indicate the frequency corresponding when λ=3.67 r for each gas. At frequencies above the left-most finely dotted vertical line for each diameter, the first transverse sloshing mode may be excited, and certainly at frequencies above the right-most long-short-long dotted vertical line (for each diameter) the transverse sloshing mode (and others) would be excited.

FIG. 56 is a plot showing the ΔPₘₐₓ/P₀ optimization results for dry air versus sulfur hexafluoride for a tube diameter of 3.175 mm. See FIG. 54 for a walkthrough of this plot and a description of the various lines and surfaces shown.

FIG. 57 is a plot showing the ΔPₘₐₓ/P₀ optimization results for dry air versus sulfur hexafluoride for a tube diameter of 3.969 mm. See FIG. 54 for a walkthrough of this plot and a description of the various lines and surfaces shown.

FIG. 58 is a plot showing the ΔPₘₐₓ/P₀ optimization results for dry air versus sulfur hexafluoride for a tube diameter of 4.318 mm. See FIG. 54 for a walkthrough of this plot and a description of the various lines and surfaces shown.

FIG. 59 is a plot showing the ΔPₘₐₓ/P₀ optimization results for dry air versus sulfur hexafluoride for a tube diameter of 6.350 mm. See FIG. 54 for a walkthrough of this plot and a description of the various lines and surfaces shown.

FIG. 60 is a plot showing the ΔP/ₘₐₓ/P₀ optimization results for dry air versus sulfur hexafluoride for a tube diameter of 9.525 mm. See FIG. 54 for a walkthrough of this plot and a description of the various lines and surfaces shown.

FIG. 61 is a plot showing the ΔPₘₐₓ/P₀ optimization results for dry air versus sulfur hexafluoride for a tube diameter of 12.700 mm. See FIG. 54 for a walkthrough of this plot and a description of the various lines and surfaces shown.

FIG. 62 shows gases contained in tubes with curvatures equal to or greater than 5, for the tube diameters noted above filled with pure nitrogen at the pressure and temperature specified (same for all tests), would not experience any measurable attenuation contribution from the curvature (in other words, neglecting the contribution from the curvature was valid). This was not necessarily the case for curvatures of 2.5, and certainly not for curvatures of 1.1.

FIG. 63 is CAD models of tubes with square cross section that have curvatures of 5, 2.5 and 1.1.

FIG. 64 is a schematic showing the critical components for version 3.2. These include the actuator, the upstream “input” microphone (1), and the downstream “output” microphone (2). A system identification was conducted between the input and output microphones. This configuration is different from the previous designs where system ID was conducted between the electrical input to the speaker and electrical output of a single downstream “output” microphone.

FIG. 65 shows the block diagram for version 3.2. A system identification was conducted between the upstream “input” microphone (1), and the downstream “output” microphone (2). In this way, the transfer function of the speaker is excluded from the measured transfer function, and the transfer functions of the microphones cancel (if it is presumed they are identical. The blue arrow shows the pathway through the system being characterized.

FIG. 66 shows the critical hardware components of version 3.2. In the top left, the inline speaker is shown. It consisted of a custom 3D printed housing, a commercial-off-the-shelf actuator (CDM-10008, CUI Inc.), 28 AWG copper magnet wire (Soderon® MW0064), and potting epoxy (MP 54270BK by ASI). The housing was designed to allow gas flow around the speaker when mounted in a 12.7 mm (½inch) diameter push-to-connect adapter, shown at the bottom left. In the top center is shown the front and back of custom microphone printed circuit boards. The microphone unit (InvenSense ICS-40618) was mounted on the back and a surface mount 0402 light emitting diode was mounted on the front to indicate whether the microphone was on. A small drilled hole allowed air flow into the microphone from the front. In the bottom center is shown the front of the pressure, temperature, and relative humidity sensor printed circuit board. Via I2C, the ST LPS25H and TE Connectivity MS583730BA01-50 transmitted pressure and temperature readings. The Sensirion SHT35-DIS-B relayed relative humidity and temperature readings also via I2C. The boards shown in the center images were mounted to off-the-shelf plugs and potted with epoxy (again, MP 54270BK by ASI), as shown in the upper right. The lower right shows connector boards which allowed for easy disconnect from the data acquisition system.

FIG. 67 shows a closeup of the fully assembled sensor plugs with custom printed circuit boards mounted on the front. The light emitting diode on these plugs was turned off to provide a clear view of the sensor face. The microphone on the left plug was mounted on the rear of the printed circuit board. Only the small hole at the center communicates the pressure variation to the sensor.

FIG. 68 shows an assembled configuration of the version 3.2 components including two opposing actuators, two microphone plugs, and a PTR plug (for pressure, temperature, and relative humidity measurement). All other components are off-the-shelf tubing and push-to-connect fittings. A US quarter is included for scale (at a diameter of 24.26 mm). While this is not the configuration used for the testing described herein, it is a particularly clean image of the assembled components and represents a field configuration being used to test mirrored actuators to determine both determine the sound speed in the gas sample and the flow rate.

FIG. 69 shows the version 3.2 sensor configuration used for experimentation. Note correspondence of the components called out in this figure with respect to FIG. 64.

FIG. 70 shows three additional configurations using version 2 hardware. The upper left configuration included two microphones mounted adjacent to the speaker in free space. The upper left configuration had the same hardware shown in the upper right, now mounted in a cylindrical cavity. The bottom configuration had the speaker mounted on one end and the microphone mounted on the other for a straight line, free path.

FIG. 71A shows the phase plot for a trial using the 400 mm separation open sound speed estimate configuration shown at the bottom of FIG. 70. The measured phase (in blue) is not linear with respect to frequency, which leads the estimated slope (in red) to deviate significantly from the expected slope (in yellow). The regions of poor MSC correspond to regions where the slope seems to fall off unexpectedly. The poor MSC may be due to ambient noise from the fans in the power supplies, multiple path lengths, or the dynamics of the speaker and/or microphone.

FIG. 71B shows the magnitude squared coherence (MSC) plot for a trial using the 400 mm separation open sound speed estimate configuration shown at the bottom of FIG. 70. The measured phase (in blue) is not linear with respect to frequency, which leads the estimated slope (in red) to deviate significantly from the expected slope (in yellow). The regions of poor MSC correspond to regions where the slope seems to fall off unexpectedly. The poor MSC may be due to ambient noise from the fans in the power supplies, multiple path lengths, or the dynamics of the speaker and/or microphone.

FIG. 72A is a measured phase plot for various mixtures of nitrogen and carbon dioxide in version 3.2 of. The linearity between frequency and phase in regions with magnitude squared coherence near one matches the expected behavior of a pure delay. The slope of this line is related to the speed of sound for each mixture and the transmission length. Table 2 details the composition of the experimental mixtures.

FIG. 72B is a magnitude squared coherence plot for various mixtures of nitrogen and carbon dioxide in version 3.2. The linearity between frequency and phase in regions with magnitude squared coherence near one matches the expected behavior of a pure delay. The slope of this line is related to the speed of sound for each mixture and the transmission length. Table 2 details the composition of the experimental mixtures.

FIG. 73 is a plot for various mixtures of nitrogen and carbon dioxide in version 3.2, this plot shows the expected sound speed plotted on the x-axis versus the calculated sound speed using the slope from the linear phase fit on the y-axis. Magnitude squared coherence values are used as the fitting weights. The numbers listed in the legend correspond to the test ID number and Table 5.1 details the composition of the experimental mixtures. The black dashed line indicates the location of perfect agreement between the expected and measured sound speed.

FIGS. 74A is a measured phase plot for various mixtures of nitrogen and helium in version 3.2. The linearity between frequency and phase in regions with magnitude squared coherence near one matches the expected behavior of a pure delay. The slope of this line is related to the speed of sound for each mixture and the transmission length. Table 3 details the composition of the experimental mixtures.

FIG. 74B is a magnitude squared coherence plot for various mixtures of nitrogen and helium in version 3.2. The linearity between frequency and phase in regions with magnitude squared coherence near one matches the expected behavior of a pure delay. The slope of this line is related to the speed of sound for each mixture and the transmission length. Table 3 details the composition of the experimental mixtures.

FIG. 75 is a plot for various mixtures of nitrogen and helium in version 3.2, this plot shows the expected sound speed plotted on the x-axis versus the estimated sound speed using the slope from the linear phase fit on the y-axis. Magnitude squared coherence values are used as the fitting weights. The numbers listed in the legend correspond to the test ID number and Table 3 details the composition of the experimental mixtures. The black dashed line indicates the location of perfect agreement between the expected and measured sound speed.

FIG. 76 is a plot for various mixtures of nitrogen and helium, this plot shows the expected adiabatic sound speed plotted on the x-axis versus the calculated sound speed using the linear phase fit on the y-axis. In addition to the results from between up-stream microphone and downstream microphone (M1 and M2), results between the speaker S and each of the microphones is also included with the relevant transmission length. Each concentration and input-output pair includes three measurements. The black dashed line indicates the location of perfect agreement between the expected and measured sound speed.

FIG. 77 is a plot for test ID 110 (nitrogen with trace water), this plot shows the estimated sound speed versus frequency with the color of each point indicating the magnitude squared coherence. These results are determined by averaging the derivative between point n and n+1 with the derivative between point n and n−1 and performing the necessary arithmetic, as described in herein under Pure Delays and a Linear Phase Fitting Method for Sound Speed Estimation, to produce a sound speed estimate from the slope. The line represents the adiabatic sound speed, calculated using Eqn. 2.14.

FIG. 78 is a plot for test ID 119 (helium with trace water), this plot shows the estimated sound speed versus frequency with the color of each point indicating the magnitude squared coherence. These results are determined by averaging the derivative between point n and n+1 with the derivative between point n and n−1 and performing the necessary arithmetic, as described herein under Pure Delays and a Linear Phase Fitting Method for Sound Speed Estimation, to produce a sound speed estimate from the slope. The line represents the adiabatic sound speed, calculated using Eqn. 2.14.

FIG. 79 is a plot for test ID 64 (carbon dioxide with trace water), this plot shows the estimated sound speed versus frequency with the color of each point indicating the magnitude squared coherence. These results are determined using by averaging the derivative between point n and n+1 with the derivative between point n and n+1 and performing the necessary arithmetic, as described herein under Pure Delays and a Linear Phase Fitting Method for Sound Speed Estimation, to produce a sound speed estimate from the slope. The line represents the adiabatic sound speed, calculated using Eqn. 2.14.

FIG. 80 is a plot for various mixtures of nitrogen and helium, this plot shows the expected adiabatic sound speed plotted on the x-axis versus the calculated sound speed using the average derivative weighted by the magnitude squared coherence on the y-axis. In addition to the results from between the upstream microphone and down-stream microphone (M1 and M2), results between the speaker S and each of the microphones is also included with the relevant transmission length. Each concentration and input-output pair includes three measurements. The black dashed line indicates the location of perfect agreement between the expected and measured sound speed.

FIG. 81 is a plot for carbon dioxide (with trace amounts of water) with test ID 64, this plot shows the modeled classical and nonclassical attenuation components. All components except the curvature term are independent of length. For the curvature term, the attenuation caused by curvature in the geometry specified (1 m length with a center curvature radius of 50 mm with a tube diameter of 9.525 mm [⅜ inch]) is normalized over the full transmission length for an average curvature-based attenuation measure per unit length. Relevant parameters for this simulation are: α_{carbon_dioxide}=0.99657, α_{water}=0.00343 (equivalent to 9.26% relative humidity), P=101.325 kPa, T=298.15 K, and a tube diameter of 9.525 mm [⅜ inch] with circular cross section.

FIG. 82 is a plot for nitrogen (with trace amounts of water) with test ID 110, this plot shows the modeled classical and nonclassical attenuation components. All components except the curvature term are independent of length. For the curvature term, the attenuation caused by curvature in the geometry specified (1m length with a center curvature radius of 50 mm with a tube diameter of 9.525 mm [⅜ inch]) is normalized over the full transmission length for an average curvature-based attenuation measure per unit length. The relevant parameters for this simulation are: α_{nitrogen}=0.99892, α_{water}=0.00108 (equivalent to 3.19% relative humidity), P=101.325 kPa, T=298.15 K, and a tube diameter of 9.525 mm [⅜ inch] with circular cross section.

FIG. 83 is a plot for various mixtures of nitrogen and carbon dioxide (with trace amounts of water), this plot shows the predicted attenuation for a transmission length of 1.0348 m and a tube diameter of 9.525 mm [⅜ inch] with circular cross section. The numbers listed in the legend correspond to the test ID number for which the simulated mixture matched.

FIG. 84 is a plot for various mixtures of nitrogen and carbon dioxide (with trace amounts of water), this plot shows the predicted attenuation plotted as a function of wavelength for a transmission length of 1.0348 m and a tube diameter of 9.525 mm [⅜ inch] with circular cross section. These curves were created by combining the simulations in FIG. 83 with the adiabatic sound speed of the mixture. The numbers listed in the legend correspond to the test ID number for which the simulated mixture matched.

FIG. 85 is a plot for various mixtures of nitrogen and carbon dioxide (with trace amounts of water), this plot shows the predicted normalized attenuation (normalized with respect to the pure nitrogen standard (in this case, ID number 110 having trace amounts of water)) plotted as a function of wavelength for a transmission length of 1.0348 m and a tube diameter of 9.525 mm [⅜ inch] with circular cross section. These plots were created using the results shown in FIG. 84. The numbers listed in the legend correspond to the test ID number for which the simulated mixture matched.

FIG. 86 is a plot for various mixtures of nitrogen and carbon dioxide (with trace amounts of water), this plot shows the predicted normalized attenuation (taking the normalized curves from FIG. 85 and, using the adiabatic sound speed, recasting as a function of frequency) for a transmission length of 1.0348 m and a tube diameter of 9.525 mm [⅜ inch] with circular cross section. The numbers listed in the legend correspond to the test ID number for which the simulated mixture matched.

FIG. 87A is a magnitude plot for various mixtures of nitrogen and carbon dioxide (with trace amounts of water showing the experimental results from the version 3.2 instrument as a function of frequency in Hz. The numbers listed in the legend correspond to the test ID number. Amplitude in FIG. 87A is in arbitrary units.

FIG. 87B is a phase plot for various mixtures of nitrogen and carbon dioxide (with trace amounts of water) showing the experimental results from the version 3.2 instrument as a function of frequency in Hz. The numbers listed in the legend correspond to the test ID number.

FIG. 87B is a magnitude squared coherence plot for various mixtures of nitrogen and carbon dioxide (with trace amounts of water) showing the experimental results from the version 3.2 instrument as a function of frequency in Hz. The numbers listed in the legend correspond to the test ID number.

FIG. 88A is a magnitude plot for nitrogen (with trace amounts of water showing the experimental results from the version 3.2 instrument as a function of frequency in Hz. Pure nitrogen (with trace amounts of water) has been isolated from the others presented in FIGS. 87A-87C for easier inspection of a set of result curves for a single gas. The numbers listed in the legend correspond to the test ID number. Amplitude in FIG. 88A is in arbitrary units.

FIG. 88B is a phase plot for nitrogen (with trace amounts of water) showing the experimental results from the version 3.2 instrument as a function of frequency in Hz. Pure nitrogen (with trace amounts of water) has been isolated from the others presented in FIGS. 87A-87C for easier inspection of a set of result curves for a single gas. The numbers listed in the legend correspond to the test ID number.

FIG. 88C is a magnitude squared coherence plot for nitrogen (with trace amounts of water) showing the experimental results from the version 3.2 instrument as a function of frequency in Hz. Pure nitrogen (with trace amounts of water) has been isolated from the others presented in FIGS. 87A-87C for easier inspection of a set of result curves for a single gas. The numbers listed in the legend correspond to the test ID number.

FIG. 89A is a magnitude plot for various mixtures of nitrogen and carbon dioxide (with trace amounts of water) showing the results from the version 3.2 instrument as a function of wavelength in m. Sound speed estimation using values derived from the slope of the linear phase fit (FIG. 73 allowed the results presented in FIGS. 87A to be converted into a function of wavelength. The resonant structures visible in the magnitude plot arise from the geometry of the device. Because the geometry is constant between these tests, the supported resonant modes all have the same wavelengths, which is why the resonant structures now align between tests with different sound speeds. The numbers listed in the legend correspond to the test ID number. Amplitude in FIG. 88A is in arbitrary units.

FIG. 89B is a phase plot for various mixtures of nitrogen and carbon dioxide (with trace amounts of water) showing the results from the version 3.2 instrument as a function of wavelength in m. Sound speed estimation using values derived from the slope of the linear phase fit (FIG. 73 allowed the results presented in FIGS. 87B to be converted into a function of wavelength. The resonant structures visible in the magnitude plot arise from the geometry of the device. Because the geometry is constant between these tests, the supported resonant modes all have the same wavelengths, which is why the resonant structures now align between tests with different sound speeds. The numbers listed in the legend correspond to the test ID number.

FIG. 89C is a magnitude squared coherence plot for various mixtures of nitrogen and carbon dioxide (with trace amounts of water) showing the results from the version 3.2 instrument as a function of wavelength in m. Sound speed estimation using values derived from the slope of the linear phase fit (FIG. 73 allowed the results presented in FIGS. 87C to be converted into a function of wavelength. The resonant structures visible in the magnitude plot arise from the geometry of the device. Because the geometry is constant between these tests, the supported resonant modes all have the same wavelengths, which is why the resonant structures now align between tests with different sound speeds. The numbers listed in the legend correspond to the test ID number.

FIG. 90A is a normalized magnitude plot for various mixtures of nitrogen and carbon dioxide (with trace amounts of water) showing the results from the version 3.2 instrument as a function of frequency in Hz. Normalization of the magnitude was completed against a pure nitrogen standard (in this case, ID number 110) as a function of wavelength (as shown in FIGS. 89A-89C). The results were then converted back to a function of frequency using sound speed estimation using values derived from the slope of the linear phase fit (FIG. 73). Instead of normalizing the pure nitrogen standard (110) against itself, a second set of results are normalized for pure nitrogen with trace amounts of water (ID number 111) against the nitrogen standard (110). As expected, this normalization leads to unity magnitude across the range with good magnitude squared coherence. The fluctuations present give an indication of the measurement stability between tests conducted approximately within 2 min of each other. Periodic oscillations present in the other normalized magnitude results are due to slight misalignments as a function of wavelength with the normalization standard. The numbers listed in the legend correspond to the test ID number.

FIG. 90B is a phase plot for various mixtures of nitrogen and carbon dioxide (with trace amounts of water) showing the results from the version 3.2 instrument as a function of frequency in Hz. Normalization of the magnitude was completed against a pure nitrogen standard (in this case, ID number 110) as a function of wavelength (as shown in FIGS. 89A-89C). The results were then converted back to a function of frequency using sound speed estimation using values derived from the slope of the linear phase fit (FIG. 73). Instead of normalizing the pure nitrogen standard (110) against itself, a second set of results are normalized for pure nitrogen with trace amounts of water (ID number 111) against the nitrogen standard (110). As expected, this normalization leads to unity magnitude across the range with good magnitude squared coherence. The fluctuations present give an indication of the measurement stability between tests conducted approximately within 2 min of each other. Periodic oscillations present in the other normalized magnitude results are due to slight misalignments as a function of wavelength with the normalization standard. The numbers listed in the legend correspond to the test ID number.

FIG. 90C is a magnitude squared coherence plot showing the results from the version 3.2 instrument as a function of frequency in Hz. Normalization of the magnitude was completed against a pure nitrogen standard (in this case, ID number 110) as a function of wavelength (as shown in FIGS. 89A-89C). The results were then converted back to a function of frequency using sound speed estimation using values derived from the slope of the linear phase fit (FIG. 73). Instead of normalizing the pure nitrogen standard (110) against itself, a second set of results are normalized for pure nitrogen with trace amounts of water (ID number 111) against the nitrogen standard (110). As expected, this normalization leads to unity magnitude across the range with good magnitude squared coherence. The fluctuations present give an indication of the measurement stability between tests conducted approximately within 2 min of each other. Periodic oscillations present in the other normalized magnitude results are due to slight misalignments as a function of wavelength with the normalization standard. The numbers listed in the legend correspond to the test ID number.

FIG. 91A is a normalized magnitude plot for various mixtures of nitrogen and carbon dioxide (with trace amounts of water)showing the results from the version 3.2 instrument as a function of frequency in Hz, plotted in thin lines (also shown in FIGS. 90A-90C), and attenuation results as predicted by classical and nonclassical theory for each mixture makeup, plotted in thick lines. The theory predicts the measured attenuation extremely well. Curiously, one experimental configuration which deviates from the modeled behavior is the single configuration for which the theoretical attenuation behavior deviated from monotonicity (ID number 73, shown in amber). While the measured result for this test is also not monotonic, it falls far above (versus below) the theoretical attenuation for pure carbon dioxide with trace amounts of water (ID number 64). The numbers listed in the legend correspond to the test ID number.

FIG. 91B is a phase plot showing the results from the version 3.2 instrument as a function of frequency in Hz, plotted in thin lines (also shown in FIGS. 90A-90C), and attenuation results as predicted by classical and nonclassical theory for each mixture makeup, plotted in thick lines. The theory predicts the measured attenuation extremely well. Curiously, one experimental configuration which deviates from the modeled behavior is the single configuration for which the theoretical attenuation behavior deviated from monotonicity (ID number 73, shown in amber). While the measured result for this test is also not monotonic, it falls far above (versus below) the theoretical attenuation for pure carbon dioxide with trace amounts of water (ID number 64). The numbers listed in the legend correspond to the test ID number.

FIG. 91C is a magnitude squared coherence plot showing the results from the version 3.2 instrument as a function of frequency in Hz, plotted in thin lines (also shown in FIGS. 90A-90C), and attenuation results as predicted by classical and nonclassical theory for each mixture makeup, plotted in thick lines. The theory predicts the measured attenuation extremely well. Curiously, one experimental configuration which deviates from the modeled behavior is the single configuration for which the theoretical attenuation behavior deviated from monotonicity (ID number 73, shown in amber). While the measured result for this test is also not monotonic, it falls far above (versus below) the theoretical attenuation for pure carbon dioxide with trace amounts of water (ID number 64). The numbers listed in the legend correspond to the test ID number.

FIG. 92A is a normalized magnitude plot that the same as FIG. 90A except for the fact that 2 more results per mixture are now plotted in addition to the results plotted in FIG. 90A.

FIG. 92B is a phase plot that is the same as FIG. 90B except for the fact that 2 more results per mixture are now plotted in addition to the results plotted in FIG. 90B.

FIG. 92C is a magnitude squared coherence plot that is the same as FIG. 90C except for the fact that 2 more results per mixture are now plotted in addition to the results plotted in FIG. 90C.

FIG. 92D is the legend for FIGS. 92A-92C. The numbers listed in FIG. 92D correspond to the test ID number.

FIG. 93 is a plot for various mixtures of nitrogen and helium (with trace amounts of water), this plot shows the predicted attenuation for a transmission length of 1.0348 m and a tube diameter of 9.525 mm [⅜ inch] with circular cross section. The numbers listed in the legend correspond to the test ID number for which the simulated mixture matched.

FIG. 94 is a plot for various mixtures of nitrogen and helium (with trace amounts of water), this plot shows the predicted attenuation plotted as a function of wavelength for a transmission length of 1.0348 m and a tube diameter of 9.525 mm [⅜ inch] with circular cross section. These curves were created by combining the simulations in FIG. 93 with the adiabatic sound speed of the mixture. The numbers listed in the legend correspond to the test ID number for which the simulated mixture matched.

FIG. 95 is a plot for various mixtures of nitrogen and helium (with trace amounts of water), this plot shows the predicted normalized attenuation (normalized with respect to the pure nitrogen standard (in this case, ID number 168 having trace amounts of water)) plotted as a function of wavelength for a transmission length of 1.0348 m and a tube diameter of 9.525 mm [⅜ inch] with circular cross section. These plots were created using the results shown in FIG. 94. The numbers listed in the legend correspond to the test ID number for which the simulated mixture matched.

FIG. 96 is a plot for various mixtures of nitrogen and helium (with trace amounts of water), this plot shows the predicted normalized attenuation (taking the normalized curves from FIG. 95 and, using the adiabatic sound speed, recasting as a function of frequency) for a transmission length of 1.0348 m and a tube diameter of 9.525 mm [⅜] with circular cross section. The numbers listed in the legend correspond to the test ID number for which the simulated mixture matched.

FIG. 97A is a magnitude plot for various mixtures of nitrogen and helium (with trace amounts of water) showing the experimental results from the version 3.2 instrument as a function of frequency in Hz. The numbers listed in the legend correspond to the test ID number. The amplitude in FIG. 97A is in arbitrary units.

FIG. 97B is a phase plot for various mixtures of nitrogen and helium (with trace amounts of water) showing the experimental results from the version 3.2 instrument as a function of frequency in Hz. The numbers listed in the legend correspond to the test ID number.

FIG. 97C is a magnitude squared coherence plot for various mixtures of nitrogen and helium (with trace amounts of water) showing the experimental results from the version 3.2 instrument as a function of frequency in Hz. The numbers listed in the legend correspond to the test ID number.

FIG. 98A is a magnitude plot for various mixtures of nitrogen and helium (with trace amounts of water) showing the results from the version 3.2 instrument as a function of wavelength in m. Sound speed estimation using values derived from the slope of the linear phase fit (FIG. 75 allowed the results presented in FIGS. 97A-97C to be converted into a function of wavelength. The resonant structures visible in the magnitude plot arise from the geometry of the device. Because the geometry is constant between these tests, the supported resonant modes all have the same wavelengths, which is why the resonant structures now align between tests with different sound speeds. The numbers listed in the legend correspond to the test ID number. The amplitude in FIG. 98A is in arbitrary units.

FIG. 98B is a phase plot for various mixtures of nitrogen and helium (with trace amounts of water) showing the results from the version 3.2 instrument as a function of wavelength in m. Sound speed estimation using values derived from the slope of the linear phase fit (FIG. 75 allowed the results presented in FIGS. 97A-97C to be converted into a function of wavelength. The resonant structures visible in the magnitude plot arise from the geometry of the device. Because the geometry is constant between these tests, the supported resonant modes all have the same wavelengths, which is why the resonant structures now align between tests with different sound speeds. The numbers listed in the legend correspond to the test ID number. The amplitude in FIG. 98A is in arbitrary units.

FIG. 98C is a magnitude squared coherence plot for various mixtures of nitrogen and helium (with trace amounts of water) showing the results from the version 3.2 instrument as a function of wavelength in m. Sound speed estimation using values derived from the slope of the linear phase fit (FIG. 75 allowed the results presented in FIGS. 97A-97C to be converted into a function of wavelength. The resonant structures visible in the magnitude plot arise from the geometry of the device. Because the geometry is constant between these tests, the supported resonant modes all have the same wavelengths, which is why the resonant structures now align between tests with different sound speeds. The numbers listed in the legend correspond to the test ID number. The amplitude in FIG. 98A is in arbitrary units.

FIG. 99A is a normalized magnitude plot for various mixtures of nitrogen and helium (with trace amounts of water) showing the results from the version 3.2 instrument as a function of frequency in Hz. Normalization of the magnitude was completed against a pure nitrogen standard (in this case, ID number 168) as a function of wavelength (as shown in FIGS. 89A-89C). The results were then converted back to a function of frequency using sound speed estimation using values derived from the slope of the linear phase fit (FIG. 73). Instead of normalizing the pure nitrogen standard (168) against itself, a second set of results for pure nitrogen was normalized with trace amounts of water (ID number 169) against the nitrogen standard (168). As expected, this normalization leads to unity magnitude across the range with good magnitude squared coherence. The fluctuations present give an indication of the measurement stability between tests conducted approximately within 2 min of each other. Periodic oscillations present in the other normalized magnitude results are due to slight misalignments as a function of wavelength with the normalization standard. The numbers listed in the legend correspond to the test ID number.

FIG. 99B is a phase plot for various mixtures of nitrogen and helium (with trace amounts of water) showing the results from the version 3.2 instrument as a function of frequency in Hz. Normalization of the magnitude was completed against a pure nitrogen standard (in this case, ID number 168) as a function of wavelength (as shown in FIGS. 89A-89C). The results were then converted back to a function of frequency using sound speed estimation using values derived from the slope of the linear phase fit (FIG. 73). Instead of normalizing the pure nitrogen standard (168) against itself, a second set of results for pure nitrogen was normalized with trace amounts of water (ID number 169) against the nitrogen standard (168). As expected, this normalization leads to unity magnitude across the range with good magnitude squared coherence. The fluctuations present give an indication of the measurement stability between tests conducted approximately within 2 min of each other. Periodic oscillations present in the other normalized magnitude results are due to slight misalignments as a function of wavelength with the normalization standard. The numbers listed in the legend correspond to the test ID number.

FIG. 99C is a magnitude squared coherence plot for various mixtures of nitrogen and helium (with trace amounts of water) showing the results from the version 3.2 instrument as a function of frequency in Hz. Normalization of the magnitude was completed against a pure nitrogen standard (in this case, ID number 168) as a function of wavelength (as shown in FIGS. 89A-89C). The results were then converted back to a function of frequency using sound speed estimation using values derived from the slope of the linear phase fit (FIG. 73). Instead of normalizing the pure nitrogen standard (168) against itself, a second set of results for pure nitrogen was normalized with trace amounts of water (ID number 169) against the nitrogen standard (168). As expected, this normalization leads to unity magnitude across the range with good magnitude squared coherence. The fluctuations present give an indication of the measurement stability between tests conducted approximately within 2 min of each other. Periodic oscillations present in the other normalized magnitude results are due to slight misalignments as a function of wavelength with the normalization standard. The numbers listed in the legend correspond to the test ID number.

FIG. 100A is a normalized magnitude plot for various mixtures of nitrogen and helium (with trace amounts of water) showing the results from the version 3.2 instrument as a function of frequency in Hz, plotted in thin lines (also shown in FIGS. 99A-99C), and attenuation results as predicted by classical and nonclassical theory for each mixture makeup, plotted in thick lines (also shown in FIG. 96). The theory accurately predicts the measured attenuation and shows good discriminatory potential. The numbers listed in the legend correspond to the test ID number.

FIG. 100B is a phase plot showing the results from the version 3.2 instrument as a function of frequency in Hz, plotted in thin lines (also shown in FIGS. 99A-99C), and attenuation results as predicted by classical and nonclassical theory for each mixture makeup, plotted in thick lines (also shown in FIG. 96). The theory accurately predicts the measured attenuation and shows good discriminatory potential. The numbers listed in the legend correspond to the test ID number.

FIG. 100C is a magnitude squared coherence plot showing the results from the version 3.2 instrument as a function of frequency in Hz, plotted in thin lines (also shown in FIGS. 99A-99C), and attenuation results as predicted by classical and nonclassical theory for each mixture makeup, plotted in thick lines (also shown in FIG. 96). The theory accurately predicts the measured attenuation and shows good discriminatory potential. The numbers listed in the legend correspond to the test ID number.

FIG. 101 is a plot for pure nitrogen and sulfur hexafluoride (with trace amounts of water), this plot shows the predicted attenuation for a transmission length of 1.0348 m and a tube diameter of 9.525 mm [⅜] with circular cross section. The numbers listed in the legend correspond to the test ID number for which the simulated sample matched.

FIG. 102 is a plot for various mixtures of nitrogen and sulfur hexafluoride (with trace amounts of water), this plot shows the predicted attenuation plotted as a function of wavelength for a transmission length of 1.0348 m and a tube diameter of 9.525 mm [⅜] with circular cross section. These curves were created by combining the simulations in FIG. 101 with the adiabatic sound speed of the mixture. The numbers listed in the legend correspond to the test ID number for which the simulated mixture matched.

FIG. 103 is a plot for various mixtures of nitrogen and sulfur hexafluoride (with trace amounts of water), this plot shows the predicted normalized attenuation (normalized with respect to the pure nitrogen standard (in this case, ID number 241 having trace amounts of water)) plotted as a function of wavelength for a transmission length of 1.0348 m and a tube diameter of 9.525 mm [⅜] with circular cross section. These plots were created using the results shown in FIG. 102. The numbers listed in the legend correspond to the test ID number for which the simulated mixture matched.

FIG. 104 is a plot for various mixtures of nitrogen and sulfur hexafluoride (with trace amounts of water), this plot shows the predicted normalized attenuation (taking the normalized curves from FIG. 103 and, using the adiabatic sound speed, recasting as a function of frequency) for a transmission length of 1.0348 m and a tube diameter of 9.525 mm [⅜] with circular cross section. The numbers listed in the legend correspond to the test ID number for which the simulated mixture matched.

FIGS. 105A is a magnitude plot for pure samples of nitrogen and sulfur hexafluoride (with trace amounts of water) showing the experimental results from the version 3.2 instrument as a function of frequency in Hz. The results of three experiments on nitrogen are plotted in different shades of black, and the results of three experiments on sulfur hexafluoride are plotted in different shades of black. The numbers listed in the legend correspond to the test ID number. The amplitude in FIG. 105A is in arbitrary units.

FIG. 105B is a phase plot for pure samples of nitrogen and sulfur hexafluoride (with trace amounts of water) showing the experimental results from the version 3.2 instrument as a function of frequency in Hz. The results of three experiments on nitrogen are plotted in different shades of black, and the results of three experiments on sulfur hexafluoride are plotted in different shades of black. The numbers listed in the legend correspond to the test ID number.

FIG. 105C is a magnitude squared coherence plot for pure samples of nitrogen and sulfur hexafluoride (with trace amounts of water) showing the experimental results from the version 3.2 instrument as a function of frequency in Hz. The results of three experiments on nitrogen are plotted in different shades of black, and the results of three experiments on sulfur hexafluoride are plotted in different shades of black. The numbers listed in the legend correspond to the test ID number.

FIG. 106A is a magnitude plot for pure samples of nitrogen and sulfur hexafluoride (with trace amounts of water) showing the results from the version 3.2 instrument as a function of wavelength in m. The results of three experiments on nitrogen are plotted in different shades of black, and the results of three experiments on sulfur hexafluoride are plotted in different shades of black. Sound speed estimation using values derived from the slope of the linear phase fit allowed the results presented in FIGS. 105A-105C to be converted into a function of wavelength. As stated previously, the resonant structures visible in the magnitude plot arise from the geometry of the device. Because the geometry is constant between these tests, the supported resonant modes all have the same wavelengths, which is why the resonant structures now align between tests with different sound speeds. The numbers listed in the legend correspond to the test ID number. Amplitude in FIG. 106A is in arbitrary units.

FIG. 106B is a phase plot for pure samples of nitrogen and sulfur hexafluoride (with trace amounts of water) showing the results from the version 3.2 instrument as a function of wavelength in m. The results of three experiments on nitrogen are plotted in different shades of black, and the results of three experiments on sulfur hexafluoride are plotted in different shades of black. Sound speed estimation using values derived from the slope of the linear phase fit allowed the results presented in FIGS. 105A-105C to be converted into a function of wavelength. As stated previously, the resonant structures visible in the magnitude plot arise from the geometry of the device. Because the geometry is constant between these tests, the supported resonant modes all have the same wavelengths, which is why the resonant structures now align between tests with different sound speeds. The numbers listed in the legend correspond to the test ID number.

FIG. 106C is a magnitude squared coherence plot for pure samples of nitrogen and sulfur hexafluoride (with trace amounts of water) showing the results from the version 3.2 instrument as a function of wavelength in m. The results of three experiments on nitrogen are plotted in different shades of black, and the results of three experiments on sulfur hexafluoride are plotted in different shades of black. Sound speed estimation using values derived from the slope of the linear phase fit allowed the results presented in FIGS. 105A-105C to be converted into a function of wavelength. As stated previously, the resonant structures visible in the magnitude plot arise from the geometry of the device. Because the geometry is constant between these tests, the supported resonant modes all have the same wavelengths, which is why the resonant structures now align between tests with different sound speeds. The numbers listed in the legend correspond to the test ID number.

FIG. 107A is a normalized magnitude plot for pure samples of nitrogen and sulfur hexafluoride (with trace amounts of water) showing the results from the version 3.2 instrument as a function of frequency in Hz. The results of three experiments on nitrogen are plotted in different shades of black, and the results of three experiments on sulfur hexafluoride are plotted in different shades of black. Normalization of the magnitude was completed against a pure nitrogen standard (in this case, ID number 241) as a function of wavelength (as shown in FIGS. 89A-89C). The results were then converted back to a function of frequency using sound speed estimation using values derived from the slope of the linear phase fit. As expected, the nitrogen magnitude measurements normalized against the nitrogen standard are unity in magnitude across the range with good magnitude squared coherence. The fluctuations present give an indication of the measurement stability between tests conducted approximately within 10 min of one another. Periodic oscillations present in the other normalized magnitude results are due to misalignments as a function of wavelength with the normalization standard. The numbers listed in the legend correspond to the test ID number.

FIG. 107B is a phase plot for pure samples of nitrogen and sulfur hexafluoride (with trace amounts of water) showing the results from the version 3.2 instrument as a function of frequency in Hz. The results of three experiments on nitrogen are plotted in different shades of black, and the results of three experiments on sulfur hexafluoride are plotted in different shades of black. Normalization of the magnitude was completed against a pure nitrogen standard (in this case, ID number 241) as a function of wavelength (as shown in FIGS. 89A-89C). The results were then converted back to a function of frequency using sound speed estimation using values derived from the slope of the linear phase fit. As expected, the nitrogen magnitude measurements normalized against the nitrogen standard are unity in magnitude across the range with good magnitude squared coherence. The fluctuations present give an indication of the measurement stability between tests conducted approximately within 10 min of one another. Periodic oscillations present in the other normalized magnitude results are due to misalignments as a function of wavelength with the normalization standard. The numbers listed in the legend correspond to the test ID number.

FIG. 107C is a magnitude squared coherence plot for pure samples of nitrogen and sulfur hexafluoride (with trace amounts of water) showing the results from the version 3.2 instrument as a function of frequency in Hz. The results of three experiments on nitrogen are plotted in different shades of black, and the results of three experiments on sulfur hexafluoride are plotted in different shades of black. Normalization of the magnitude was completed against a pure nitrogen standard (in this case, ID number 241) as a function of wavelength (as shown in FIGS. 89A-89C). The results were then converted back to a function of frequency using sound speed estimation using values derived from the slope of the linear phase fit. As expected, the nitrogen magnitude measurements normalized against the nitrogen standard are unity in magnitude across the range with good magnitude squared coherence. The fluctuations present give an indication of the measurement stability between tests conducted approximately within 10 min of one another. Periodic oscillations present in the other normalized magnitude results are due to misalignments as a function of wavelength with the normalization standard. The numbers listed in the legend correspond to the test ID number.

FIG. 108A is a normalized magnitude plot for pure samples of nitrogen and sulfur hexafluoride (with trace amounts of water) showing the results from the version 3.2 instrument as a function of frequency in Hz, plotted in thin lines (also shown in FIGS. 107A-107C), and attenuation results as predicted by classical and nonclassical theory for each mixture makeup, plotted in thick lines. The results of three experiments on nitrogen are plotted in different shades of black, and the results of three experiments on sulfur hexafluoride are plotted in different shades of black. In this case, the theory predicts attenuation when none is present. This is likely due to the fact that molecular properties of SF6 are poorly documented. The numbers listed in the legend correspond to the test ID number.

FIG. 108B is a phase plot for pure samples of nitrogen and sulfur hexafluoride (with trace amounts of water) showing the results from the version 3.2 instrument as a function of frequency in Hz, plotted in thin lines (also shown in FIGS. 107A-107C), and attenuation results as predicted by classical and nonclassical theory for each mixture makeup, plotted in thick lines. The results of three experiments on nitrogen are plotted in different shades of black, and the results of three experiments on sulfur hexafluoride are plotted in different shades of black. In this case, the theory predicts attenuation when none is present. This is likely due to the fact that molecular properties of SF6 are poorly documented. The numbers listed in the legend correspond to the test ID number.

FIG. 108C is a magnitude squared coherence for pure samples of nitrogen and sulfur hexafluoride (with trace amounts of water) showing the results from the version 3.2 instrument as a function of frequency in Hz, plotted in thin lines (also shown in FIGS. 107A-107C), and attenuation results as predicted by classical and nonclassical theory for each mixture makeup, plotted in thick lines. The results of three experiments on nitrogen are plotted in different shades of black, and the results of three experiments on sulfur hexafluoride are plotted in different shades of black. In this case, the theory predicts attenuation when none is present. This is likely due to the fact that molecular properties of SF6 are poorly documented. The numbers listed in the legend correspond to the test ID number.

FIG. 109 is a plot for mixtures of nitrogen and methane, this plot shows the predicted attenuation for a transmission length of 1.0348 m and a tube diameter of 9.525 mm [⅜ inch] with circular cross section. For these simulations, P=101.325 kPa and T=298.15 K.

FIG. 110 is a plot for mixtures of nitrogen and methane, this plot shows the predicted normalized attenuation (normalized with respect to the pure nitrogen when plotted as a function of wavelength) for a transmission length of 1.0348 m and a tube diameter of 9.525 mm [⅜] with circular cross section. For these simulations, P=101.325 kPa and T=298.15 K. Based on the results shown, the ability to differentiate between different mixtures of nitrogen and methane is readily possible within the range of audible frequencies.

FIG. 111 is a plot showing measured impulse responses for a range of mixtures given a transmission length of 1.0348 m. The numbers listed in the legend correspond to the test ID number.

FIG. 112 is a plot showing measured impulse responses for test ID number 168. Overlaid under the x-axis is a measure of distance traveled. This corresponds to the delay given the speed of sound of the gas (which is noted in the axis title for distance).

FIG. 113 is a plot showing measured impulse responses for test ID number 168. Overlaid under the x-axis is a measure of distance traveled. This corresponds to the delay given the speed of sound of the gas (which is noted in the axis title for distance). This is a zoomed-in version of FIG. 112.

FIG. 114 is a plot showing a commercially available kit (PAS-01K by Images SI, Inc.) and a custom spark gap speaker fitted with an automotive spark plug (9619 Double Iridium Spark Plug by Bosch) are shown. Detail insets of the spark gap and arc are also presented.

FIG. 115 is a plot showing a multilayer sandwich PCB, exploded for clarity. Solder could attach the wide traces with the plated slot, and a speaker and microphone could be integrated into the terminal voids. Gold plating could provide a robust absorption barrier and prevent corrosion.

FIG. 116 is a plot showing a schematic detailing a configuration with two actuators, the device having several beneficial properties. These benefits are afforded due to the device's symmetry.

### DETAILED DESCRIPTION

Embodiments of the present technology include systems, apparatuses, and methods encompassing a sensor useful for determining a characteristic response of different materials, including gases. A miniature, multi-analyte, sensitive, and inexpensive acoustic spectrometer leveraging material-specific acoustic phenomena disclosed herein has the potential to have significant impact on many activities. As an example, the monitoring of oil and gas production and transport infrastructure, in particular in the air around hydraulically fractured wells and pipelines, would protect nearby communities from dangerous leaks and maximize the amount of extracted material that was converted into usable fuel. As another example, such an acoustic spectrometer sensitive to inhaled oxygen and exhaled carbon dioxide would provide physicians and patients with a powerful tool for metabolism monitoring. Such acoustic spectrometers also could find use in the classroom, giving students the ability to measure gases in the world around them. These examples are a small sampling of the opportunities present in transportation, healthcare, food storage and production, industry, environmental monitoring, education and others.

Embodiments disclosed herein can perform a suite of measurements to characterize the response of a sample. This can be accomplished by quantify attenuation effects arising from classical sources (viscosity and thermal conductivity, among others) and non-classical sources (energy storage in polyatomic molecular vibrations). Embodiments disclosed herein are also capable of measuring the speed of sound in materials. For gases that experience non-classical attenuation, non-classical effects will change the speed of sound at certain frequencies, which are detectable by the embodiments disclosed herein. Any nonlinear effects that may be present can also be quantified.

### Spectrometer Design

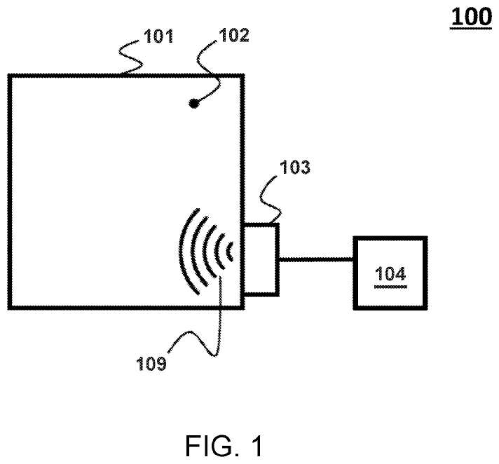

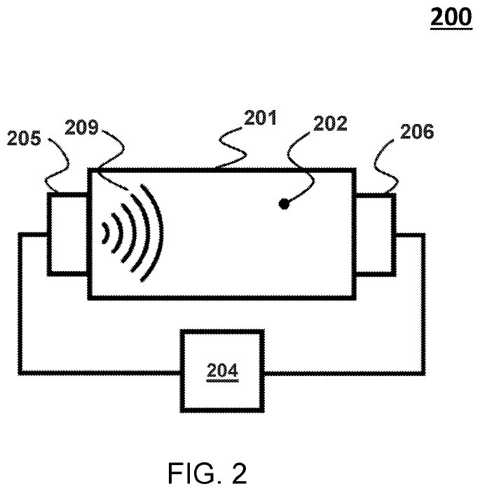

FIG. 1 illustrates an example acoustic spectrometer 100 with a transducer 103 that both emits and senses vibrations 109 in the material 102 that is contained or present within the cavity/chamber 101 to receive the material 102. A controller 104 drives the transducer 103 with an input signal, measures an output signal from the transducer, and performs signal analysis. These measurements may be transmitted from the controller 104 to another device for (but not limited to) viewing, data storage, and/or further analysis. Each of these components are described herein in more detail with respect to FIG. 1, though it is understood that similarly named and/or referenced components in FIGS. 2-6 (e.g., the controllers 104, 204, 304, etc.) may be structurally and/or functionally similar unless expressly noted otherwise.

The chamber 101 to receive the material 102 may be rigid, flexible, or actuated, such that the total volume may change. Properties such as the pressure or temperature within the chamber 101 to receive the material 102 may be held constant or perturbed in a controlled fashion. The chamber 101 can include an opening or be a sealed vessel with a sealable opening to permit introduction of the material 102. The chamber 101 can be optional, i.e., the transducer 103 can interact with ambient air, or air in a desired area of operation, such as in an open field, that may include the material 102. The chamber 101 can be made of any suitable solid material, such as polyethylene, other polymers, metallic, a ceramic, combinations thereof, and/or the like. Further, the chamber 101 may be designed to reduce or eliminate the possibility of exciting its structural modes, such as, for example, by having a minimum thickness that can vary by material. Alternatively, the chamber 101 can have at least one resonant mode with a frequency that falls within a range of frequencies contained in the input signal. The chamber material and/or dimensions can be selected to achieve a desired acoustic impedance mismatch between the material 102 inside the chamber 101 and the chamber material, to increase the amount of reflected acoustic energy within the chamber and to minimize its dissipation.

The material 102 can include a fluid, e.g., a gas. Example gases that can be characterized by the spectrometer 100 can include, but are not limited to, various monoatomic, diatomic, triatomic, and other gases as generally described in Example 1. In some cases, the gas can be methane (e.g., in an open field) or sulphur hexafluoride (e.g., in measurements in switchgear). As noted herein, the material 102 can be an undesirable component that is present in ambient air and can be detected by the spectrometer.

The transducer 103 can include any suitable component such as, for example, a microphone, a voice coil, a piezoelectric transducer, a magnetostrictive actuator, a plasma arc actuator, a ribbon speaker, a ribbon microphone, an optical microphone, a MEMS (micro-electromechanical system) microphone, and/or the like. The transducer 103 can include a separate emitter and receiver, and can encompass multiple transducers, or multiple emitters and/or multiple receivers. The transducer(s). emitter(s) and/or receiver(s) can be independently disposed throughout the chamber 101 as appropriate to characterize the material 102.

The controller 104 can be any suitable processing device configured to run and/or execute a set of instructions or code associated with the spectrometer 100. The controller 104 can be, for example, a general purpose processor, a Field Programmable Gate Array (FPGA), an Application Specific Integrated Circuit (ASIC), a Digital Signal Processor (DSP), and/or the like. Further, the spectrometer 100 can also include a memory and/or a database. The database and the memory can be a common data store. The database may include a set of databases, and at least one database can be external to the spectrometer 100. The memory and/or the database can each be, for example, a random access memory (RAM), a memory buffer, a hard drive, a database, an erasable programmable read-only memory (EPROM), an electrically erasable read-only memory (EEPROM), a read-only memory (ROM), Flash memory, and/or so forth. The memory and/or the database can store instructions to cause the controller 104 to execute processes and/or functions associated with the controller 104 such as, for example, to conduct signal analysis.

The spectrometer 100 can also include one or more input/output (I/O) interfaces (not shown), implemented in software and/or hardware, for other components external to the spectrometer 100 to interact with it. For example, the spectrometer 100 can communicate with other devices via one or more networks, such as a local area network (LAN), a wide area network (WAN), a virtual network, a telecommunications network, and/or the Internet, implemented as a wired network and/or a wireless network. Any or all communications can be secured (e.g., encrypted) or unsecured, as is known in the art. In this manner, especially during field use, the spectrometer 100 can transmit the results of its signal analysis, such as to a user's smartphone or to a remote device.

Referring again to the controller 104, the input signal generated by the controller 104 can include multiple frequencies, including frequencies up to about 20 kHz, greater than 20 kHz (e.g., for detecting methane leaks), and/or up to about 100 kHz. The input signal can be a stochastic signal, i.e., the frequency components of the input signal can be randomly determined by the controller 104. The input signal can be characterized by a Gaussian amplitude probability density function. In some cases, the input signal can be generated by, for example, taking a purely random sequence of values (i.e., white noise with all frequency components being of equal power), passing this scaled random signal through a bandpass filter with the desired frequency cutoffs, and scaling the resulting signal to match the desired voltage output level for the transducer. One or more parameters (e.g., voltage) of the input signal can be selected to prevent or minimize any potential acoustic distortion from the transducer itself, which in turn can affect the frequency components in the output signal. In response, the transducer generates acoustic energy that the material 102 is exposed to and generates an output signal based on the response of the material to the acoustic energy. Generally, the output signal can be characteristic of both the stochastic input signal as well as the dynamic response of the spectrometer 100, which in turn can be affected by acoustic attenuation, sound speed in the chamber 101, and/or supported resonant modes of the chamber 101. The controller 104 them performs signal analysis on the output signal as described in more detail herein.

As an example design and operation, an acoustic spectrometer as described herein can employ a slender cavity/chamber measuring approximately 9.5 mm in diameter and 1 m in length. The walls of the cavity can be made of polyethylene at a thickness of 1.6 mm. This wall thickness may eliminate the possibility of exciting structural modes of the enclosure leading to unwanted energy dissipation. One or more high performance miniaturized voice coils, such as those typically designed for smart phones, can be leveraged as transducers to both acoustically perturb and measure the system. During use, the cavity is filled with a variety of pure gases (including pure nitrogen, carbon dioxide, and oxygen) and then acoustically perturbed with a stochastic signal as an input signal to the transducer, which in turn generates the acoustic energy. The stochastic signal can contain frequencies between 1 kHz and 20 kHz, including all values and sub-ranges in between. The sensor may perturb the gases at other frequency ranges, including but not limited to 20 Hz to 20 kHz, and/or 18 kHz to 100 kHz, including all values and sub-ranges in between.

FIG. 2 illustrates another example acoustic spectrometer 200 with an emitter 205 that releases vibrations 209 into the material 202 that is contained within the cavity/chamber 201 to receive the material 202. A receiver 206 senses vibrations in the material 202. A controller 204 drives the emitter 205 with an input signal, measures an output signal from the receiver 206, and performs signal analysis. Any of these measurements (output signal, results of the signal analysis, etc.) may be transmitted from the controller 204 to another device for (but not limited to) viewing, data storage, and/or further analysis. The emitter 205 and receiver 206 may each, or collectively, be a transducer capable of acting both as emitter and receiver.

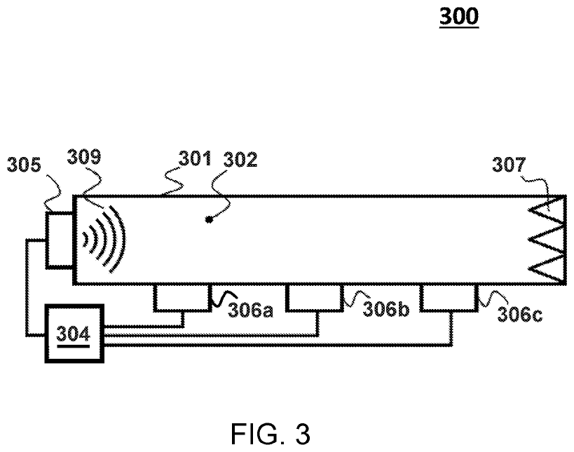

FIG. 3 illustrates yet another example acoustic spectrometer 300 with one emitter 305 that releases acoustic energy/vibrations 309 into the material 302 that is contained within the cavity/chamber 301 to receive the material 302. Multiple receivers 306a, 306b, 306c, placed at different distances (e.g., linear, non-linear, or random) from the emitter 305, can sense vibrations in the material 302. While up to three receivers are shown, here, any suitable number of receivers can be employed. In this manner, the number and positioning of receivers can be selected as long as at least one of the receivers can detect the perturbation from the emitter. For free space measurements, the maximum distance at which a receiver may be placed from the emitter 305 can be based on the acoustic power emitted by the source, the distance between the source and the receiver, the attenuating properties of the medium (e.g., of the material 302), and/or the sensitivity of that receiver. Another consideration for the number of receivers can be having a receiver at each optimal transmission distance from the emitter 305 as the number of gases of interest for detection, since the displacement that is ideal for detecting one gas may be different from that for detecting a second gas.

Based on the characteristics of the material 302, the appropriate receiver may be selected by the controller 304. For example, a transmission length that is optimal for sensing a lightly attenuating gas may be quite long (e.g., 1 meter or more). However, a long transmission length may be inappropriate for sensing a strongly attenuating gas. Multiple test lengths built into a single spectrometer allow for a wider range of properties to be measured. As an example of receiver selection, the receiver with the strongest output signal for a particular change in the material 302, such as a change in its composition, can be selected. As another example, the output signals of multiple receivers can be accounted for, such as by using a weighting algorithm that gives higher weight to a receiver with a stronger output signal indicating the change than one with a weaker signal, or one that does not indicate a change.

Absorbing material 307, such as foam, vinyl, rubber, a muffler-type design, etc. may be positioned in the cavity 301 to receive the material 302 to absorb unwanted vibrations, such as those that are reflected from the walls of the cavity/chamber 301. Such absorbing materials may be placed in more than one location as illustrated and may be employed with any of the example spectrometers illustrated in FIGS. 1-6.

Further, still referring to FIG. 3, the measurement of the output signal at one or more of the receivers 306a, 306b, 306c can be employed as the input signal for signal analysis. For example, the output signal at the receiver 306a can be employed as an input signal due to its proximity to the emitter 305, and the more distant (from the emitter 305) receivers 306b, 306c can be employed for their output signal. Since acoustic attenuation is frequency dependent, it is possible that some frequency components of the acoustic perturbation will drop below the detectable noise limit over some distance, but that other frequency components will not have been as attenuated over this same distance. For these less attenuated frequencies, a longer transmission length, and receivers such as the receivers 306b, 306c that are placed further away from the emitter 305, can provide a more sensitive measure.

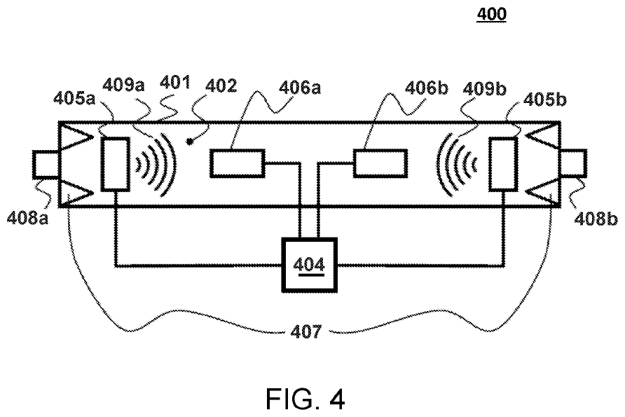

FIG. 4 illustrates yet another example acoustic spectrometer 400 with emitters 405a, 405b that can independently (e.g., simultaneously, in an overlapping manner, in a non-overlapping manner, or individually/one at a time) produce acoustic energy/vibrations 409a, 409b into the material 402 that is contained within the cavity/chamber 401 to receive the material 402. Multiple receivers 406a, 406b sense vibrations in the material 402. These receivers 406a, 406b may be positioned such that they are equidistant or at unequal distances from a midpoint between the two emitters 405a, 405b. These receivers 406a, 406b also may be positioned in a (equally or unequally) spaced apart manner from any other point that is not the midpoint between the two emitters 405a, 405b. Unequal spacing can be useful when, for example, evaluating a particular gas mixture. Further, the receivers 406a, 406b may independently be fixed or movable, as may any of the transducers, emitters, and receivers disclosed in FIGS. 1-6. Referring again to FIG. 4, absorbing material 407 may be positioned in the cavity 401 to receive the material 402 to absorb unwanted vibrations, such as those that are reflected.

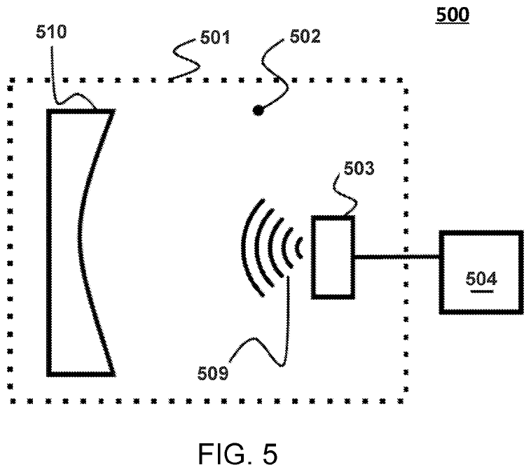

FIG. 5 illustrates yet another example acoustic spectrometer 500 with one transducer 503 that both produces and senses vibrations 509 in the material 502 that is contained within the cavity/chamber 501 to receive the material 502. Here, the cavity/chamber 501 to receive the material 502 is not defined by a physical boundary and rather is a volume defined in free space (as indicated here with dotted lines). In this manner, the spectrometer 500 can be useful for open-air/free-space measurements.

A reflector 510 redirects vibrations emitted from the transducer 503 back towards the transducer 503 for sensing. The reflector 510 may be composed of any suitable reflecting solid material such as concrete, a polymeric material, a metal, a ceramic, combinations thereof, or a liquid reflecting material, such as a water body (e.g., a pond). The reflector 510 may be shaped (e.g., concave, as illustrated in FIG. 5) to focus the reflected acoustics onto the transducer 503. Any number of reflectors, and in any desirable arrangement, may be employed in any of the acoustic spectrometers of FIGS. 1-6. Referring again to FIG. 5, a controller 504 drives the transducer 503 with an input signal, measures an output signal from the transducer 503, and performs signal analysis. These measurements may be transmitted from the controller 504 to another device for (but not limited to) viewing, data storage, and/or further analysis.

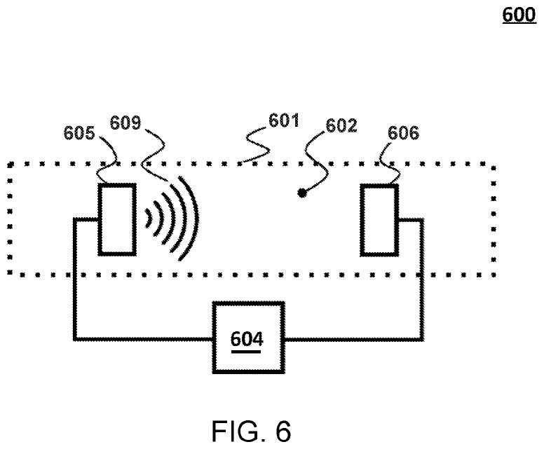

FIG. 6 illustrates yet another example acoustic spectrometer 600 with an emitter 605 that produces vibrations 609 into the material 602 that is contained within the cavity/chamber 601 to receive the material 602. Here, the cavity 601 to receive the material 602 is not defined by a physical boundary and rather is a volume defined in free space (as indicated here with dotted lines). A receiver 606 senses vibrations in the material 602. A controller 604 drives the emitter 605 with an input signal, measures an output signal from the receiver 606, and/or performs signal analysis. These measurements may be transmitted from the controller 604 to another device for (but not limited to) viewing, data storage, and/or further analysis.

As readily appreciated by those of skill in the art, an acoustic spectrometer can be designed or modified to suit a particular application and/or to provide desired performance. Possible modifications include, but are not limited to: chamber sizes (including microscale chambers) in addition to variable chamber geometries (e.g., pistons or bellows); temperature and pressure effect on the spectral response for different pure gases and mixtures; acoustic drivers (voice coil, piezoelectric, magnetostriction, ribbon); acoustic sensors (fiber optic, MEMS, piezoelectric); and optimal perturbations, including associated linear and non-linear system identification techniques, to improve response time and measurement reliability even in measurements with poor signal-to-noise ratio.

### Modeled Physics

Aspects of the systems, apparatuses, and method disclosed herein, generally directed to design and use of an acoustic spectrometer, can leverage a variety of physical phenomena that affect the characteristic acoustic response of a sample/material.

Both the attenuation and transmission speed of an acoustic wave are affected by a variety of factors. Attenuation can be caused by both classical and non-classical sources. Classical attenuation effects in pure gases are found in straight tubes and free space are well. Classical losses due to tube curvature are also know, as are diffusion loses arising in gas mixtures.

Several existing models are useful for approximating non-classical attenuation in multi-component mixtures. Without being limited by theory, non-classical attenuation can arise from thermal relaxation (between internal and external degrees of freedom) involving molecular vibration and rotation modes. Upon the passage of a sound wave, excited molecules do not exchange vibrational or rotational energies infinitely fast with the translational degrees of freedom associated with the temperature fluctuations. This short delay causes energy in the wave to be redistributed, leading to attenuation on the macro scale.

These non-classical interactions can also lead to deviations at some frequencies from the adiabatic sound speed, which is modeled for gases by:

$$a = \sqrt{\frac{γ R T}{M}}$$

where a is the adiabatic speed of sound, y is the specific heat ratio, R is the ideal gas constant, T is the temperature, and M is the molar mass. In addition, other aspects of the characteristic response may have discriminatory potential. Such aspects may include species-specific nonlinear behavior that can also be quantified using the techniques disclosed herein.

Signal Analysis of Raw Spectra Measured with the Acoustic Spectrometer—Example of a Characteristic Response Determination

Multiple methods exist to experimentally derive the acoustic response for a gas sample in an acoustic spectrometer as disclosed herein from knowledge of the input and output measurements. When using linear signal analysis techniques, a frequency domain approach can be used for computing the gas sample's acoustic resonant cavity transfer function.

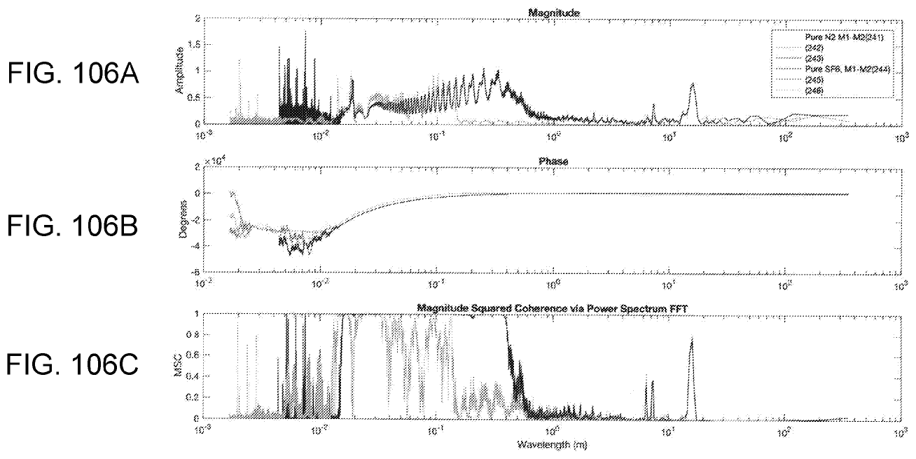

The frequency domain approach for linear signal analysis can involve manipulating power spectral calculations of the input and output. In this example, the input signal (which is directed into the transducer/emitter by a controller, as generally disclosed for FIGS. 1-6) can be a stochastic signal with non-trivial frequency components between 1 kHz to 20 kHz and a Gaussian amplitude probability density function. The output signal is the measurement from the acoustic transducer/receiver. The signal analysis approach can be carried out as follows, such as by a controller as generally disclosed in FIGS. 106. First, an impulse response length “N” (this also specifies frequency resolution, which is Sample Rate/N) is specified. N can be selected to provide a desired frequency resolution. For example, at sample rate of 160 kHz, a length N of 160,000 provides a frequency resolution of 1 Hz.

Second, the input signal (e.g., the input to the emitter or the signal measured at a receiver proximal to the emitter, as described for FIG. 3) and output signal (e.g., a selected output signal or a combination of multiple output signals, when multiple output signals are obtained from multiple receivers) are split into “N”-length input and output segments. These segments are windowed using a Hanning window and can overlap by less than 50%, about 50%, or 50% and more. Third, an input power auto spectrum (“Sxx”), output power auto spectrum (“Syy”), and input output power cross spectrum (“Sxy”) are calculated on each segment, and the results for all segments are averaged. These spectra can be calculated in the MATLAB computing environment developed by MathWorks. An example syntax used to compute the individual power spectra is:
Sxx=abs(fft(Input Segment)).\hat{ }2
Syy=abs(fft(Output Segment)).\hat{ }2
Sxy=conj(fft(Input Segment)).*fft(Output Segment);

The standard FFT (Fast Fourier Transform) algorithm can handle power-2 length signals, and as a result the impulse response length “N” must also be of power-2 length. In some embodiments, other algorithms, that can to handle non-power-2 length signals, including prime factorization algorithms and the CZT (Chirp-Z Transform) algorithm, can be employed.

Then, the Sxx, Syy, and Sxy calculated for each “N”-length segment can be averaged, and the following can be calculated with the power spectra according to the following simplified syntax:

| | |
|---|---|
| H = Sxymean./Sxxmean | %frequency response function |
| Gain = abs(H) | %transfer function gain |
| Phase = unwrap(angle(H) | %transfer function phase |

MSC = abs(Sxymean.*conj(Sxymean)./(Sxxmean.*Syymean)).\hat{ }2
%Magnitude Squared Coherence
h = ifft(H) %time domain impulse response

This division of the input output cross power spectrum by the input auto power spectrum is the frequency-domain equivalent of deconvolving the input auto-correlation function from the input output cross-correlation function (e.g., via Toeplitz matrix inversion) in the time (or lag) domain. A frequency-domain analysis approach can be made to operate within the memory constraints of a typical personal computer, and within that of a controller as described herein for

FIGS. 1-6, relatively more easily than a time-domain analysis approach for the “N” needed or desired for this application, though either approach may be employed, depending on the computational power at hand.

Additionally, the transfer function gain and phase represent system dynamics. Determining such linear dynamic components, and non-linear components such as the MSC, is one example approach to modeling the characteristic response of the material. Other approaches that can use the various system information provided by the acoustic spectrometers as described in FIGS. 1-6 can include modeling the system behavior and/or the characteristic response as a Volterra series and determining one or more Volterra kernels (e.g., a first Volterra kernel and one or more higher order Volterra kernels). Still other approaches for analyzing such dynamic, non-linear systems can be employed, such as parallel cascades, NARMAX (nonlinear autoregressive moving average model with exogenous inputs) representation/methods, a Wiener series and Wiener kernel(s), and/or the like.

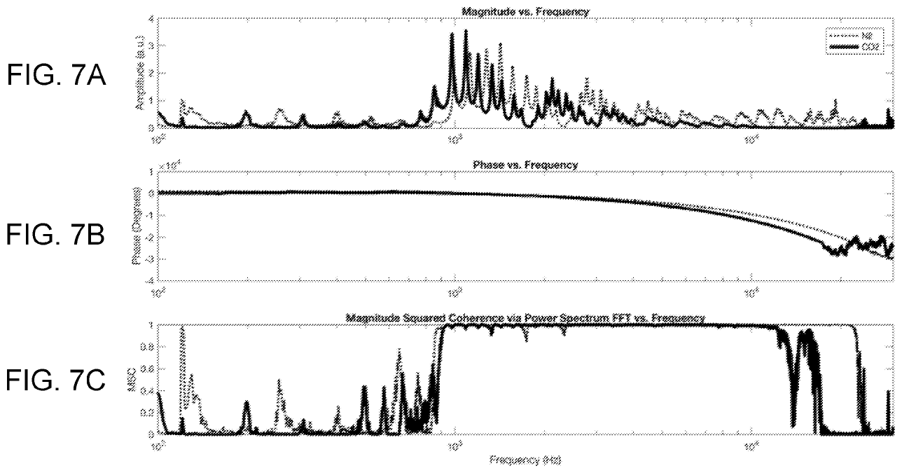

FIGS. 7A-7C is a plot of an example acoustic spectra for dry nitrogen and dry carbon dioxide. The acoustic spectrometer 300 illustrated in FIG. 3 is employed to measure this spectra, where the spectra is calculated between the receivers 306a and 306b, i.e., the measurement at one of these (e.g., the receiver 306a, being closer to the emitter 305) is employed as the input signal, and the other is employed as the output signal. The input used to elicit these responses is a 30 second long stochastic signal containing frequencies between 1 kHz and 20 kHz. The sample rate is 160 kHz. Plotted here is the amplitude (in arbitrary units) vs. frequency (FIG. 7A), the phase (in degrees) vs. frequency (FIG. 7B), and the magnitude squared coherence (MSC) vs. frequency (FIG. 7C).

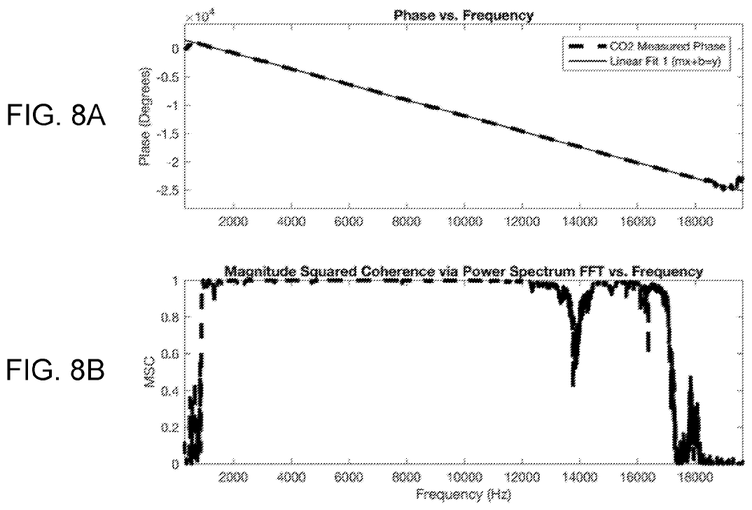

FIGS. 8A-8B are plots of the phase (FIG. 8A) and magnitude squared coherence (FIG. 8B) for the dry carbon dioxide described for FIGS. 7A-7C. This plot, as opposed to phase plot in FIG. 7, shows the phase on a linear-linear plot. In this view, a linear relationship is seen between phase and frequency. This linear relationship can be fit to a line (y=mx+b) where the slope m is used for calculating the speed of sound. The delay in seconds “D” is given by D=(−(m)/360). The speed of sound “v” can be determined by v=(transducer separation distance)/D.

### Sound Speed Quantification

The method to determine the speed of sound in the target material can include (e.g., by a controller as described herein for FIGS. 1-6) estimating the sound delay from the measured transfer function phase using weighted least squares fitting which adopts the transfer function coherence squared as the weights, as described in more detail in Example 1. This can allow for direct comparison of resonant features for different gases tested within the same cavity.

Other methods to determine the speed of sound exist and can be employed, such as (e.g., by a controller as described herein for FIGS. 1-6) finding the maximum from a cross-correlation calculation, computed between a part of a response derived from unknown constituents (and therefore an unknown speed of sound) and a comparison part of a response derived from a spectrum with known constituents (and therefore a known speed of sound). The part of the spectrum over which the cross correlation is calculated may be (but is not limited to) the amplitude, phase, magnitude squared coherence; any portion of the amplitude, phase, or magnitude squared coherence; any derivative of amplitude, phase, or magnitude squared coherence; or any combination thereof.

### Applications

Embodiments of the present technology include a multi-analyte, low cost, resilient, and readily deployable acoustic spectrometer that can detect a variety of gases. Some embodiments can operate with good measurement specificity for a number of gases. For example, by using a combination of spectrometer measurements (including classical attenuation, nonclassical attenuation, and/or speed of sound) it is possible to distinguish between three or more gaseous analytes and determine their ratio in a gas mixture. There are many possible applications sectors for these devices, including but not limited to transportation, healthcare, food storage and production, industrial, environmental monitoring, and education. These applications can include (but aren't limited to):

### Transportation

Monitor intake/output gases from internal combustion engine (ex. determine if engine is functioning properly)
Monitor air quality in vehicle cabin (ex. for people, animals, plants or goods in various land, sea, air and space applications)
Monitor outdoor air quality (ex. automatically determine if cabin air should recirculate in automobile)

### Healthcare

Measure constituents of inhaled/exhaled breath (ex. for metabolic rate calculations, for disease detection)
Monitor anesthesia mixtures
Monitor personnel safety (ex. artificial “canary” for toxic gases or oxygen depletion, or monitor for explosive gases)
Monitor air quality in various locations (homes, offices, car parks, laboratories, sewage treatment plants, tank farms, construction sites)

### Food Storage and Production

Monitor air properties in food storage/production facilities (i.e. fruit storage, beer fermentation, animal husbandry)

### Industry

Monitor pressure and gas makeup in gas-filled switchgear for electrical energy transmission
   The unique dielectric and arc quenching properties of sulfur hexafluoride (SF₆) make it an important gas in the operation of high- and medium-voltage switchgear. While infrequent, the failure of a switchgear enclosure seal can lead to a catastrophic failure of the unit, causing service outages and damage to other parts of the distribution network. Additionally, SF₆ is a tremendously potent greenhouse gas with a warming potential over 20,000× worse than carbon dioxide. From both an operations and environmental standpoint, ensuring the stability and purity of SF₆ in switchgear is of great interest. Current methods to monitor SF₆ and other gases rely on complicated sensing paradigms and bespoke components. This can cause costs to skyrocket. For example, a single gas density sensor on the market today can easily exceed $1,000 USD. This high cost places constraints on the industry's ability to monitor switchgear equipment. Methods to drastically reduce SF₆ monitoring costs and expand the scope of SF6 monitoring capabilities would allow the electrical power industry to operate in a more reliable and responsible manner.
   Aspects disclosed herein, including nonlinear system identification techniques, miniaturized sensors, miniaturized speakers, microphones, pressure and temperature sensors, and/or the like, can be used to develop an acoustic spectrometer for detecting SF6 leakage by measuring composition change. In some embodiments, a composition change of as little as 1% can be detectable. Specifically, aspects disclosed herein can be useful for monitoring for depressurization events in switchgear. Some SF6 switchgear have a nominal operating pressure of 0.5 MPa, with an alarm condition at 0.45 MPa and a lockout condition at 0.4 MPa. Preliminary simulations indicate that monitoring the classical attenuation will provide a good indicator between these pressure conditions. While a passive pressure monitor could be implemented, a measurement approach that perturbs the system and measures a response is far more robust, particularly in systems that are remote and unattended like gas-filled switchgear.
Monitor manufacturing processes (e.g., welding environments, metallurgy processing)
Monitor fuel production (e.g., petroleum production, biogas)
Monitor for stowaways (e.g., elevated CO₂ for presence of human or animal in confined space)
Monitor mine conditions
Monitor H₂ production from lead acid battery charging

### Environmental Monitoring

Greenhouse emissions from natural and man-made sources (e.g. transient emissions of methane from vent chimneys)
Volatiles monitoring
Flammables monitoring

### Education

Teaching experiments (e.g., monitoring CO₂ and/or O₂ from plants)

Aspects of the systems, apparatuses, and method disclosed herein overcome limitations of known approaches and systems via the following, non-limiting features:
Measuring across a wide spectrum. Generally, there are no limits on the range of frequencies that the emitter can project/emit. This spectrum may excite resonant modes in the test chamber but also probes frequencies that are not resonant. In fact, no resonant modes would be excitable in a free-space measurement where the “test chamber” is not defined by a rigid boundary. Additionally, contrary to some existing approaches, some embodiments disclosed herein do not require two distinct chambers separated by a diaphragm that is instrumented to detect deflection.
Contrary to some existing approaches, in some embodiments, no reference chamber having a reference material (e.g., a reference gas) is required, and there may accordingly be no requirement to communicating pressure changes between such a reference chamber and a sample chamber, such as across a common wall. In some embodiments, a reference chamber may be employed.
Contrary to some existing approaches, in some embodiments and as disclosed herein, sample properties beyond acoustic velocity are measured, such as material-specific attenuation for material identification.
Contrary to some existing approaches, in some embodiments where a reference gas/chamber may be employed, there may be no requirement for the selective transmission of the gaseous substance to be monitored into the reference chamber. Contrary to some existing approaches, in some embodiments, there is no requirement for the sample fluid to move/flow.
Contrary to some existing approaches, in some embodiments as disclosed herein, the frequency response is measured across a range of frequencies, and nonlinear effects are also discoverable.
Contrary to some existing approaches, in some embodiments as disclosed herein, free-space measurements are possible, as are measurements in any suitable cavity form, including spherical and non-spherical cavities.
Contrary to some existing approaches, in some embodiments, system identification techniques as disclosed herein are much more robust for signals with poor signal-to-noise ratio.
Contrary to some existing approaches, in some embodiments as disclosed herein, attenuation measurements arising from both classical and non-classical sources can be employed to determine the composition of the gas.
Contrary to some existing approaches, any perturbation signal could be deployed and for sample identification and/or analysis.

### EXAMPLE 1

### A Miniature, Broadband Acoustic Spectrometer: Design of a Unified Attenuation Model, Device Development, and Experimental Performance

The attenuation of sound occurs in polyatomic gases due to both classical and nonclassical physics. Classical attenuation is dominated by viscous dissipation and irreversible heat conduction. Nonclassical attenuation arises from the thermal relaxation between internal and external degrees of freedom for each constituent molecule. Existing methods to detect gas composition using nonclassical attenuation are bulky, heavy, and slow at resolving measurements, as the instruments utilize highly resonant, single frequency transducers mounted within rigid containment vessels that are pressurized sequentially over a wide range of pressures.

Imagine a gas with the following properties: zero viscosity; zero heat conductivity or perfectly adiabatic (no heat enters or leaves an element of fluid during its alternate cooling and warming due to the sound wave rarefactions and compressions); and the gas is ideal (the state of an element can be described by only two independent local thermodynamic parameters such as pressure and temperature, pressure and density, etc.).

Such a gas would allow for reversible changes in pressure and density and allow for plane wave propagation with undiminished intensity over an infinite length. Of course, behavior like this is not realistic as real gases stray from all of the properties listed above. Therefore, attenuation and dispersion affect waves propagating through any real gas. Attenuation is the reduction in pressure amplitude as a wavefront propagates, whereas dispersion is the spreading of the signal in time resulting from the different speeds of different frequencies. It has been shown that these two effects are related—this relationship is most commonly known as the Kramers-Kronig relation. In other words, if appreciable attenuation or dispersion is detected, the other is also present. While the methods described herein are also readily capable of measuring both attenuation and dispersion, the focus is on the detection of attenuation.

The total attenuation broadly includes two categories, which include classical and nonclassical effects. While others have looked at the relationship between classical and nonclassical effects, these analyses have been relegated to the free-field as mentioned above. This work is likely the first to consider both confined classical effects (which is critical to understand to optimize a miniaturized instrument) and free-field classical and nonclassical effects. This unified approach is particularly well suited to the optimization and miniaturization of an instrument.

### System Identification

System identification (or System ID) is a technique for estimating the parameters of a given model structure for a dynamic system by analyzing the system's input (which is a perturbation delivered to the system) and output (which is the response to that perturbation). As opposed to experimental techniques based on observation (which can be easily fooled by noise and nonlinearities), system ID is one of the most ideal embodiments of the scientific method, in that causation between the perturbation of an input and the response of an output can be readily established and quantified. The work herein focuses on estimating parameters for a linear, time invariant system model. A linear system must have two properties—homogeneity and additivity which together are often referred to as the principle of superposition. For a system to exhibit homogeneity, any perturbation in the input signal amplitude must result in a change in the signal's output amplitude. Additivity is exhibited when the sum of any two input signals results in an output that is the sum of the individual outputs elicited by each of the individual input signals. Finally, while not necessarily a strict requirement for linearity, time or shift invariance is also an assumption made for the following analysis techniques to provide accurate representations of system behavior. Time invariance is the ability for a system to produce an identical output for a given input regardless of when the input is delivered.

### Stochastic Methods for Linear, Time Invariant Systems

Stochastic signals are well suited as inputs for system identification techniques.

They can be tailored to contain a myriad of frequencies and leveraged to measure the response of the system over these frequencies simultaneously. The input power of a stochastic signal can be quite high compared to techniques that ensemble averages of the response of an impulse (which often require a period of calm for the dynamics to die out). For stochastic signals, one can compute the response for moving windows of any width, opening the door to continuous measurements. Finally, in cases where noise in a system is uncorrelated with the input perturbation, the effect of noise on the calculated response is averaged out. This work deploys stochastic signals and a frequency domain approach for calculating the system response.

The frequency domain approach for analyzing linear, time invariant systems involves manipulating power spectral calculations of the input and output signals. For the present work (unless otherwise noted), the input is a stochastic signal with non-trivial frequency components between 1 kHz to 20 kHz and a Gaussian amplitude probability density function. The output is the downstream measurement following the propagation of the sound wave through the gas of interest. The approach is described as follows:

1. An impulse response length N (this also specifies frequency resolution, which is (Sample Rate)/N) is specified.

2. The input and output signal are split into N-length input and output segments. These segments are windowed using a Hanning window and overlap by 50%.

3. An input power auto spectrum (Sxx), output power auto spectrum (Syy), and input-output power cross spectrum (Sxy) are calculated on each segment. These spectra can be calculated in the MATLAB computing environment developed by MathWorks. Syntax used to compute the individual power spectra is:
Sxx=abs(fft(Input Segment)).\hat{ }2%input power auto spectrum
Syy=abs(fft(Output Segment)).\hat{ }2%output power auto spectrum
Sxy=conj(fft(Input Segment)).*fft(Output Segment); %input-output power cross spectrum

The standard FFT (Fast Fourier Transform) algorithm in most computer languages can handle power-2 length signals, and as a result the impulse response length N must also be of power-2 length. In other computer languages, other algorithms that can to handle non-power-2 length signals, including prime factorization algorithms and the CZT (Chirp-Z Transform) algorithm, are employed, which loosen the restrictions on the signal length.

MATLAB's built-in FFT function (fft( ) which is used in the syntax above) runs the FFTW (Fastest Fourier Transform in the West) package. FFTW chooses the algorithm 4 it estimates or measures to be preferable in the particular circumstances.

4. Then, the Sxx, Syy, and Sxy calculated for each N length segment can be averaged, and the following can be calculated with the mean power spectra according to the following syntax:
H=Sxymean./Sxxmean %frequency response transfer function
Gain=abs(H) %transfer function gain
Phase=unwrap(angle(H) %transfer function phase
MSC=abs(Sxymean.*conj(Sxymean)./(Sxxmean.*Syymean)).\hat{ }2%Magnitude Squared Coherence

h=ifft(H) %time domain impulse response

This division of the input-output cross power spectrum by the input auto power spectrum is the frequency-domain equivalent of deconvolving the input auto-correlation function from the input-output cross-correlation function (e.g., via Toeplitz matrix inversion) in the time (or lag) domain. A frequency-domain analysis approach (requiring vectors of length N) can be made to operate within the memory constraints of a personal computer much more readily than a time-domain analysis approach (requiring arrays of size N²) given the N desired for this case (160,000 lags, for a frequency resolution of 1 Hz given a sample rate of 160 kHz), but both approaches are valid.

In addition to gain and phase (which are commonly shown in a Bode plot) magnitude square coherence is also calculated, which is an important measure for evaluating the validity of the gain and phase estimates. The estimates reported by a transfer function's gain and phase should represent real system dynamics (and not simply noise or nonlinear effects in the measurements). The square of the coherence function is used as a measure of the output variance accounted for (VAF) by the estimate at each frequency. The coherence can range from between 0 and 1. When the coherence is near 1, the system is linear and the noise in the measurement is small. However, when the coherence is near 0, there is nonlinear behavior present and/or noise overpowers the measurements. Whereas VAF typically gives a single number to represent the quantitative measure of the success of the model, the coherence squared function is, in a sense, the breakdown of the VAF as a function of frequency.

In an ideal gas, pressure, temperature and volume are related by, PV=nRT. In this equation, P is the pressure in Pa (Nm⁻²), V is the volume in m⁻³, n is the number of moles, R which is the ideal gas constant (8.314 J mol⁻¹ K⁻¹), and T is the absolute temperature in K. The ideal gas model assumes that there are no forces between non-contacting molecules, collisions are completely elastic, and the volume of each molecule is negligible. Helium at high temperature and low pressure most closely behaves like an ideal gas.

While the ideal gas assumptions do not predict attenuation (which is observed in real gases) the ideal gas law does form the basis for more advanced models as described herein.

### Gas Mixture Property Calculations

Unless the analysis is constrained to only pure gas samples, all relevant properties for various mixtures of gases should be determined. The values of relevant physical constants must first be specified:
kB (Boltzmann Constant)=1.380 648 52×10-23 JK-1
NA (Avogadro Constant)=6.022 140 857→|1023 molecule/mol
R (Ideal Gas Constant)=kB|←NA in JK-1 mol-1

Next, all of the following classical properties for each mixture can be known:
constituent i.
αᵢ, molar fraction of species i in moles of constituent per moles of mixture [unitless]
Mᵢ, molar mass in kg mol-1
c_{p,i}, specific heat at constant pressure in Jkmol-1 K-1
γᵢ, ratio of specific heats (c_{p,i}/c_{v,i}) which is unitless. Note that c_{v,i} is the specific heat at constant volume in Jkmol-1 K-1
Ci, Sutherland constant for species i in K
μ_{ref,i}, dynamic (absolute) viscosity reference in Pas at a reference temperature T_{μ,i}
κ_{ref,i,} thermal conductivity reference in Wm-1 K-1 at a reference temperature T_{κ,i}
σᵢ, collision diameter for species i in m as defined by the Lennard-Jones potential

### Mixture Molar Mass, Molecular Weight and Mass Fraction

The molar mass of the mixture is defined as,

$${M}_{mix} = {\sum }_{i = 1}^{n} {α}_{i} {M}_{i} , \qquad ( 2.2 )$$

where Mₘᵢₓ as the molar mass of the mixture with the definition of σi and Mi above. Next, ωᵢ, the mass fraction for each species i, is computed as,

$${w}_{i} = \frac{{α}_{i} {M}_{i}}{{\sum }_{j = 1}^{n} {α}_{j} {M}_{j}} = \frac{{α}_{i} {M}_{i}}{{M}_{mix}} . \qquad ( 2.3 )$$

Relative molar mass (also known as molecular weight) Mi for species i is a dimensionless quantity and is equal to the molar mass divided by the product of Avogadro's number and the mass in kg of 1 amu (1.6605×10-27 kg/amu). Alternatively, Mi is equivalent to the molar mass divided by the molar mass constant Mu (Mu is equal to 1 gmol-1).

### Specific Heat at Constant Pressure

The c_{p,i} for the given temperature T can be determined using a polynomial model as per Eqn. 2.4 with tabulated parameters c_{p,i,p1} to c_{p,i,p5} or a hyperbolic trigonometric model as per Eqn. 2.5 with tabulated parameters c_{p,i,h1} to c_{p,i,h5}.

$$\begin{matrix}{c}_{p , i} = {c}_{p , i , p 1} + {c}_{p , i , p 2} T + {c}_{p , i , p 3} {T}^{2} + {c}_{p , i , p 4} {T}^{3} + {c}_{p , i , p 5} {T}^{4} , & ( 2.4 ) \\ {c}_{p , i} = {c}_{p , i , h 1} + {{c}_{p , i , h 2} ( \frac{\frac{{c}_{p , i , h 3}}{T}}{sinh ( \frac{{c}_{p , i , h 3}}{T} )} )}^{2} + {{c}_{p , i , h 4} ( \frac{\frac{{c}_{p , i , h 3}}{T}}{sinh ( \frac{{c}_{p , i , h 3}}{T} )} )}^{2} . & ( 2.5 )\end{matrix}$$

With c_{p,i} for all the species i in a mixture, the c_{p,mix} (the specific heat at constant pressure for the mixture) can be calculated as,

$${c}_{p , mix} = {\sum }_{i = 1}^{n} {α}_{i} {c}_{p , i} . \qquad ( 2.6 )$$

However, the units of c_{p,i} should be on a per kilogram basis as opposed to a per kilomole basis for use in the equations presented in the classical attenuation model. Therefore, to convert the values of c_{p,i} Eqn. 2.7 which gives c_{p(kg),i} in units of J kg⁻¹ K ⁻¹ can be used.

$${c}_{p ( kg ) , i} = \frac{1}{1000 {M}_{i}} {c}_{p , i} ; \qquad ( 2.7 )$$

Now with the specific heat at constant pressure on a per kilogram basis, Eqn. 2.8, which combines c_{p(kg),i} in proportion to wᵢ to determine c_{p(kg),mix}, or the specific heat at constant pressure on a per kilogram basis for the gas mixture can be used.

$${c}_{p ( kg ) , mix} = {\sum }_{i = 1}^{n} {w}_{i} {c}_{p ( kg ) , i} . \qquad ( 2.8 )$$

To determine 1ₘᵢₓ, or the ratio of specific heats for the gas mixture, Mayer's relation in Eqn. 2.9 where cᵥ=cₚ−R for an ideal gas can be used.

$${γ}_{mix} = \frac{{c}_{p , mix}}{{c}_{v , mix}} = \frac{{c}_{p , mix}}{{c}_{p , mix} - R} . \qquad ( 2.9 )$$

### Specific Heat at Constant Volume

c_{v,i}, the specific heat at constant volume in J kmol-1 K-1 at a given temperature T_{cv,i} and c_{v(kg),i}, the specific heat at constant volume in J kg⁻¹ K⁻¹ at a given temperature T_{c} for each gas i can simply be calculated by Eqn. 2.10 and Eqn. 2.11.

$$\begin{matrix}{C}_{v , i} = \frac{{c}_{p , i}}{R} , & ( 2.10 ) \\ {c}_{v ( kg ) , i} = \frac{1}{1000 {M}_{i}} {c}_{v , i} . & ( 2.11 )\end{matrix}$$

With these measures, the c_{v,mix} (on a per kmol basis) and cv(kg),i (on a per kg basis) can be calculated for each gas i as per Eqn. 2.12 and Eqn. 2.13.

$$\begin{matrix}{c}_{v , mix} = {\sum }_{i = 1}^{n} {α}_{i} {c}_{v , i} , & ( 2.12 ) \\ {c}_{v ( kg ) , i} = {\sum }_{i = 1}^{n} {w}_{i} {c}_{v ( kg ) , i} . & ( 2.13 )\end{matrix}$$

### Sound Speed

With 1ₘᵢₓ and Mₘᵢₓ (in addition to T and R), the adiabatic speed of sound in the gas mixture can be calculated. Recall that adiabatic means that compressions of the sound wave do not transfer heat in or out of a volume element of air. This is a reasonable, first-order approximation. The formulation for aₘᵢₓ, or the speed of sound in the mixture, is given as,

$${a}_{mix} = \frac{{γ}_{mix} RT}{{M}_{mix}} . \qquad ( 2.14 )$$

### Density and Number Density

With the molecular mass of the mixture Mₘᵢₓ, the mixture density mix can be formulated as shown in Eqn. 2.15, which is derived from the ideal gas law and written as,

$${ρ}_{mix} = \frac{{PM}_{mix}}{RT} . \qquad ( 2.15 )$$

The number density for the mixture is calculated by,

ρₙ=P/(k_{B}*T). (2.16)

The number density of each gas i can be formulated as,

ρ_{n,i}=αᵢρₙ. (2.17)

### Viscosity and Heat Conductivity

The dynamic viscosity μ_{ref,i} which is given for T_{μ,i} is dependent on the given temperature T and therefore must be adjusted using Sutherland's formula, much like how the thermal conductivity _{ref,i} which is given for T,ᵢ. Eqn. 2.18 and Eqn. 2.19 give the properties for each gas i at the given temperature T.

$$\begin{matrix}{μ}_{i} ( T ) = {μ}_{ref , i} \frac{{T}_{μ , i} + {C}_{i}}{T + {C}_{i}} \frac{{T}^{3 / 2}}{{T}_{μ , i}} & ( 2.18 ) \\ {κ}_{i} ( T ) = {κ}_{ref , i} \frac{{T}_{μ , i} + {C}_{i}}{T + {C}_{i}} \frac{{T}^{3 / 2}}{{T}_{μ , i}} & ( 2.19 )\end{matrix}$$

With the dynamic viscosity and thermal conductivity for each gas determined for temperature T, those same properties must now be determined for a mixture of gases. Eqn. 2.20, 2.21, 2.22, and 2.23 describe a model for the viscosity of gas mixtures used in the field where 2 the dynamic viscosity of the mixture, μₘᵢₓ, is defined as

$${μ}_{mix} = {\sum }_{i = 1}^{n} \frac{{α}_{i} {μ}_{i}}{{α}_{i} + {\sum }_{j = 1 , j \neq 1}^{n} {ϕ}_{ij} {α}_{j}} . \qquad ( 2.20 )$$

The cpᵢⱼ is defined as the mixture parameter for species i and j, which formulated as

$${ϕ}_{i , j} = {𝒜}_{i , j} [ 1 + \frac{{ℳ}_{i} - {ℳ}_{j} \sqrt{\frac{{𝒜}_{j , i}}{{𝒜}_{i , j}}}}{\frac{3 {A}_{i , j}^{*} ( {ℳ}_{i} + {ℳ}_{j} )}{5 - 3 {A}_{i , j}^{*}} + \frac{\sqrt{{𝒜}_{i , j}} + \sqrt{{𝒜}_{j , i}}}{1 + \sqrt{{𝒜}_{i , j} {𝒜}_{j , i}}} + {ℳ}_{j} \sqrt{{𝒜}_{i , j}}} ] . \qquad ( 2.21 )$$

Finally, Aᵢⱼ is defined as the viscosity mixture coefficient for species i and j, and formulate it as,

$${𝒜}_{ij} = {( \frac{2 {ℳ}_{j}}{{ℳ}_{i} + {ℳ}_{j}} )}^{\frac{1}{2}} ( \frac{{σ}_{i j}^{2}}{{σ}_{i} {σ}_{j}} ) \frac{{σ}_{j}}{{σ}_{i}} = ( \frac{{σ}_{i j}^{2}}{{σ}_{i} {σ}_{j}} ) {( \frac{{ℳ}_{j}}{{ℳ}_{i}} )}^{\frac{1}{2}} {( \frac{{μ}_{i}}{{μ}_{j}} )}^{\frac{1}{2}} {( \frac{4 {M}_{i} {M}_{j}}{{( {M}_{i} + {M}_{J} )}^{2}} )}^{\frac{1}{4}} , \qquad ( 2.22 )$$

with respect to a, (the collision diameter for species i), aⱼ (the collision diameter for species j), and aᵢⱼ (the collision diameter for an interaction between species i and j), which is defined as,

$${σ}_{i j} = \frac{{σ}_{i} + {σ}_{j}}{2} . \qquad ( 2.23 )$$

A*i,j=10/9 for realistic intermolecular potentials. Note that this formulation for the dynamic viscosity of the mixture corrects for a maximum error of approximately 10% which one would encounter with a purely radiometric approach.

Now, transitioning to the thermal conductivity for a particular gas mixture, κₘᵢₓ, is described by Eqn. 2.24 and Eqn. 2.25 models the thermal conductivity of the mixture as

$${κ}_{mix} = {\sum }_{i = 1}^{n} \frac{{α}_{i} {κ}_{i}}{{α}_{i} + {\sum }_{j = 1 , j \neq 1}^{n} {K}_{ij} {α}_{j}} , \qquad ( 2.24 )$$

where K_{i,j} is defined as the thermal conductivity mixture coefficient for species i and j, and it is formulated as,

$${K}_{i , j} = \frac{1}{4} {\{ 1 + {[ \frac{{μ}_{j}}{{μ}_{i}} {( \frac{2 {ℳ}_{j}}{{ℳ}_{i}} )}^{3 / 4} \frac{1 + \frac{{C}_{i}}{T}}{1 + \frac{{C}_{j}}{T}} ]}^{1 / 2} \}}^{2} \frac{1 + \frac{{C}_{i , j}}{T}}{1 + \frac{{C}_{j}}{T}} , \qquad ( 2.25 )$$

where C_{i,j} is the unlike Sutherland constant and is addressed in the following section. All other variables have been previously addressed. Note that this formulation for the mixture thermal conductivity (like the formulation for mixture dynamic viscosity) corrects for a maximum error of approximately 10% which one would encounter with a purely radiometric approach.

### Unlike Sutherland Constant

A critical component of Eqn. 2.25 is the Sutherland constant for unlike species i and j. C_{i,j}, is specified for interactions between two polar molecules or two nonpolar molecules in Eqn. 2.26. Eqn. 2.27 specifies C_{i,j} for interactions between one polar and one nonpolar molecule.

C_{i,j}=\sqrt{CᵢCⱼ} (2.26)

c_{i,j}=0.733\sqrt{CᵢCⱼ} (2.27)

### Resulting Mixture Parameters

With Eqn. 2.2 -2.27, the following properties of the mixture at a given temperature T can be determined, which are necessary for determining classical attenuation:
Mₘᵢₓ, molar mass in kg mol⁻¹
c_{p,mix}, specific heat at constant pressure in Jkmo1⁻¹K⁻¹
c_{p(kg),mix}, specific heat at constant pressure in J kg⁻¹ K⁻¹
c_{v,mix}, specific heat at constant volume in J kmol⁻¹K⁻¹
c_{v(kg),mix}, specific heat at constant volume in Jkg⁻¹K⁻¹
γₘᵢₓ, ratio of specific heats (c_{p,mix}/c_{v,mix}) which is unitless
aₘᵢₓ, adiabatic sounds speed in m s⁻¹
ρₘᵢₓ, density in kg/m³
μₘᵢₓ, dynamic (absolute) viscosity in Pas
κₘᵢₓ, thermal conductivity in W m⁻¹ K⁻¹
   in addition to the following properties for the gas constituents i of the mixture:
ρ_{n,i} number density in molecules/m³

These parameters, in addition to information on the fundamental vibration modes of the polyatomic molecules in a mixture, are used herein to estimate classical and nonclassical attenuation.

### Addressing Relative Humidity and Water Vapor Partial Pressure

Water vapor is present in any real gas mixture. Therefore, its quantification as a partial pressure (from readily available relative humidity measurements) must be addressed.

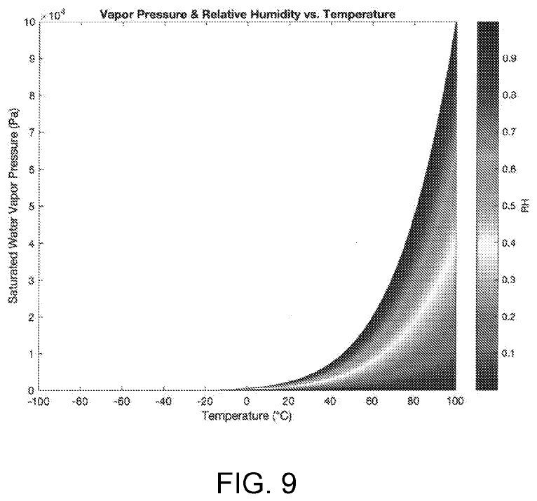

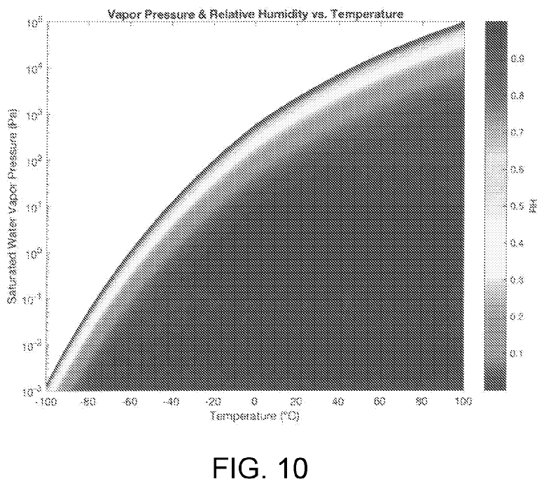

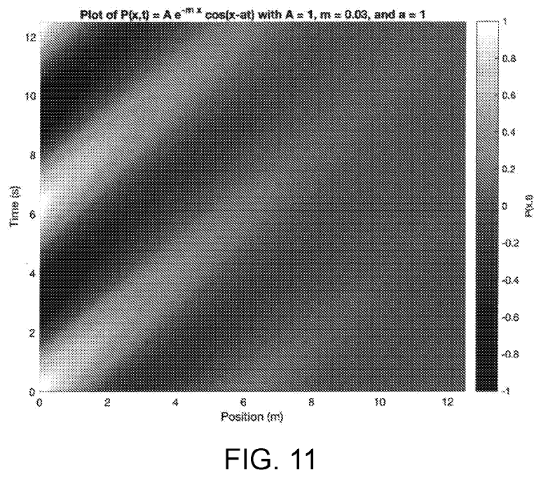

Models have been presented in the literature to calculate the partial pressure of water vapor from a relative humidity and temperature measurement. The relationship between relative humidity and partial pressure using this model for a range of temperatures is shown in FIG. 9 and FIG. 10.

### Nonzero Viscosity and Thermal Conductivity Effects

Because the pressure-density cycle of a real, monatomic gas is irreversible (due to nonzero viscosity and heat conductivity), each pressure cycle results in the transfer of some energy to random thermal energy. This leads to attenuation and dispersion. Generally, the effects of viscosity and heat conductivity the strongest contributors to attenuation, both in the free-field and in confined straight tubes. Furthermore, viscosity and thermal conductivity losses in confined tubes are substantially greater than losses in the free-field for certain tube diameters and frequencies.

To model attenuation, Pₑ¹ at position x was defined in the following way, which can be converted into the sinusoidal form using the identity presented Eqn. 1.7,

Pₑ(x,t)=P_{e,0}*e^{i(kx-wt)-m}^{ₜₒₜₐₗ}^{x}=P_{e,0}*e^{m}^{ₜₒₜₐₗ}^{x}(cos(kx−wt)+i sin(kx−wt)). (3.1)

Here, mₜₒₜₐₗ is introduced as the total amplitude attenuation coefficient. This can further be defined as the sum of all attenuation components (including all classical and nonclassical effects, given the components are additive) as,

$${m}_{total} = {\sum }_{i = 1}^{n} {m}_{i} . \qquad ( 3.2 )$$

The representation presented in Eqn. 3.1 includes an exponential decay term with respect to position. This is different from Eqn. 1.6 presented previously. The inclusion of this exponential decay term means that Eqn. 3.1 is not a solution to the wave equation in Eqn. 1.5. This is indeed expected though, as Eqn. 1.5 does not describe any dampening behavior.

The design space was constrained for a miniaturized device to include tube radii ranging from 1 mm 20 mm and frequencies ranging from 100 Hz to 1 MHz. this design space is nicely situated within the “wide” regime (with, perhaps, some corrections for “narrow” and “very wide”). Weston describes the classical attenuation as,

$$\begin{matrix}{m}_{wide} = ( \frac{{γ}^{′}}{{ar}_{e}} ) \sqrt{π f} + \frac{2 {( π f )}^{2}}{{a}^{3}} [ ( \frac{4}{3} ) \frac{μ}{ρ} + ( \frac{γ - 1}{γ} ) \frac{κ}{ρ {c}_{v}} ] + \frac{{( π f )}^{2} {γ}^{′2}}{{a}^{3}} + \frac{{γ}^{″}}{{ar}_{e}^{2}} + \frac{{γ}^{′′′}}{2 {ar}_{e}^{3} \sqrt{π f}} , \\ where , & ( 3.3 ) \\ {γ}^{′} = \sqrt{\frac{μ}{ρ}} + ( γ - 1 ) \sqrt{\frac{κ}{ρ {c}_{v} γ}} , & ( 3.4 ) \\ {γ}^{″} = \frac{μ}{ρ} + \frac{γ - 1}{\sqrt{γ}} \sqrt{\frac{μ}{ρ} \frac{κ}{{c}_{v} ρ}} - \frac{γ - 1}{2} \frac{κ}{{c}_{v} ρ} , \\ and , & ( 3.5 ) \\ {γ}^{′′′} = \frac{15}{8} {( \frac{μ}{ρ} )}^{3 / 2} + \frac{4 ( γ - 1 )}{\sqrt{γ}} \frac{μ}{ρ} \sqrt{\frac{κ}{{c}_{v} ρ}} + \frac{3 ( γ - 1 ) ( γ - 2 )}{2 γ} \sqrt{\frac{μ}{ρ}} \frac{κ}{{c}_{v} ρ} + \frac{( γ - 1 ) ( 4 {γ}^{2} - 12 γ + 7 )}{8 {γ}^{3 / 2}} {( \frac{κ}{{c}_{v} ρ} )}^{3 / 2} . & ( 3.6 )\end{matrix}$$

In Eqn. 3.3-3.6, rₑ is the effective radius in m defined as,

$${r}_{e} = \frac{2 S}{E} , \qquad ( 3.7 )$$

where E is the tube perimeter in m and S is the tube cross sectional area in m². Furthermore for the gas of interest, a is the speed of sound in m s⁻¹, f is the frequency in Hz,μ is the dynamic viscosity reference in Pa s, γ is the specific heat ratio (which is unitless), ρ is the density in kg/m³, κ is the Thermal conductivity in W m⁻¹, K⁻¹, and cᵥ is the specific heat constant volume in J kmol⁻¹ K⁻¹. Note that the gas parameters are defined for the sample, whether that be a pure gas or a mixture.

In Eqn. 3.3, the main “wide” tube confined term is

$${m}_{wide ( confined )} = ( \frac{{γ}^{′}}{{ar}_{e}} ) \sqrt{π f} . \qquad ( 3.8 )$$

“Very wide” tube corrections include a free-field attenuation term,

$${m}_{very \_ wide ( free \text{-} field )} = \frac{2 {( π f )}^{2}}{{a}^{3}} [ ( \frac{4}{3} ) \frac{μ}{ρ} + ( \frac{γ - 1}{γ} ) \frac{κ}{ρ {c}_{v}} ] , \qquad ( 3.9 )$$

and an energy distribution term,

$${m}_{very \_ wide ( energy \_ distribution )} = \frac{{( π f )}^{2} {γ}^{{′}^{2}}}{{a}^{3}} . \qquad ( 3.10 )$$

“Narrow” corrections include a corrective term specified as,

$${m}_{narrow ( correction )} = \frac{{γ}^{″}}{{ar}_{e}^{2}} + \frac{{γ}^{″′}}{2 {ar}_{e}^{3} \sqrt{π f}} . \qquad ( 3.11 )$$

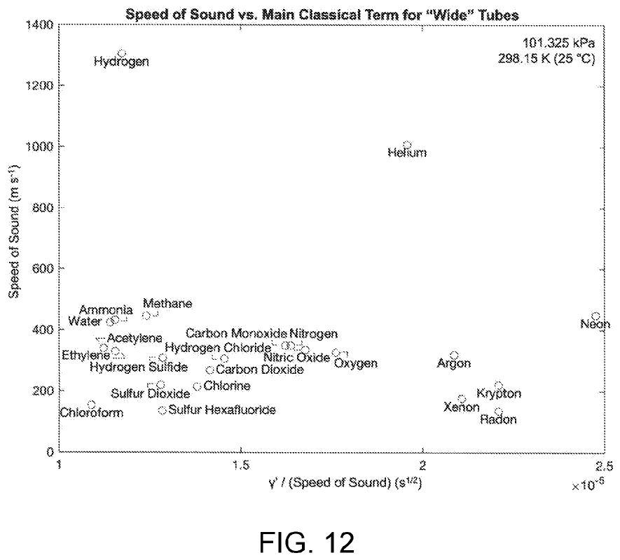

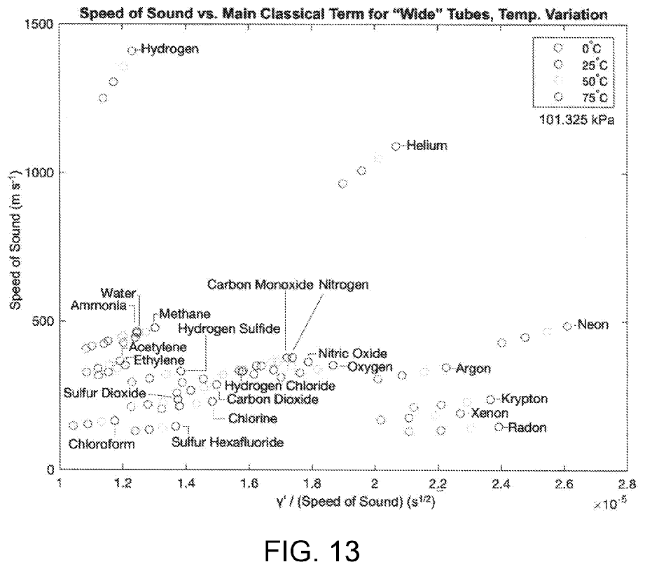

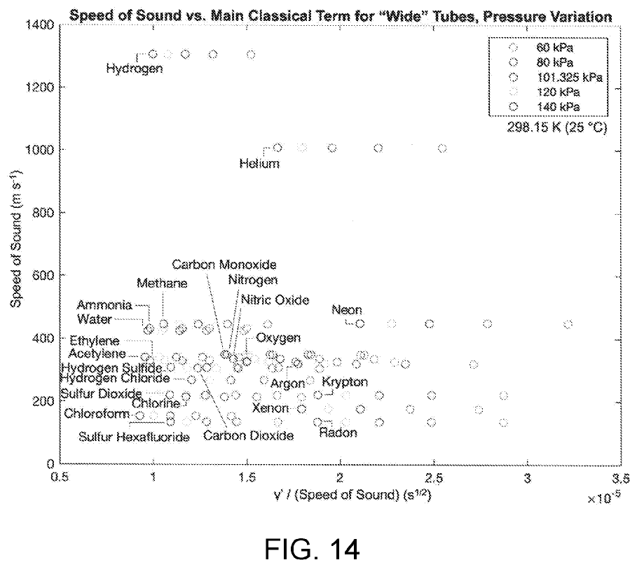

An interesting exercise is to plot the combination of material properties found in the main confined term in Eqn. 3.8. These combined materials properties are 1°/a, or 1° from Eqn. 3.4 divided by the sound speed a. FIGS. 12, 13, and 14 show the relationship between this combination of materials properties and sound speed at constant temperature and pressure, varying temperature and constant pressure, and constant temperature and varying pressure, respectively. Even without any nonclassical effects, the differences in 1°/a should give rise to differences in classical attenuation with discriminatory potential (in addition to differences in sound speed). This is investigated and shown with the functional version 3.2 prototype described in Simulations and Experimental Results for Helium and Nitrogen Mixtures herein.

### Diffusion Effect

Another source of attenuation that must be quantified arises in gas mixtures. The distribution of the particle speed v was defined using the Maxwell-Boltzmann distribution, formulated as:

$$f ( {v}_{i} ) = 4 * {π ( \frac{{M}_{i}}{2 π RT} )}^{\frac{3}{2}} {v}^{2} {e}^{\frac{- {M}_{i} {v}_{i}^{2}}{2 RT}} . \qquad ( 3.12 )$$

Furthermore, it can be shown that the most probable velocity v_{p,i}, the average velocity v ᵢ, and the root-mean-squared (rms) velocity v_{rms,i} take the forms:

$$\begin{matrix}{v}_{p , i} = \sqrt{\frac{2 RT}{{M}_{i}}} , & ( 3.13 ) \\ {\overline{v}}_{i} = \sqrt{\frac{8 RT}{π {M}_{i}} ,} & ( 3.14 ) \\ and {v}_{rms , i} = \sqrt{\frac{3 RT}{{M}_{i}}} . & ( 3.15 )\end{matrix}$$

It is readily apparent from these equations that the velocity measures are dependent only upon the molar mass of species i, Mᵢ, and temperature T. Heavier molecules (with a higher molar mass) will have lower speeds relative to lighter molecules for a given temperature. When a local pressure or temperature gradient arises, less massive molecules (with their higher velocities) move towards equilibrium more rapidly than heavier molecules. The diffusion due to the pressure gradient is accompanied by a preferential diffusion of the lighter molecules due to the thermal gradient. The attenuation can be formed as Eqn. 3.16:

$${m}_{diffusion} = \frac{2 {π}^{2} {γ}_{mix} {α}_{1} {α}_{2} {D}_{12}}{{a}_{mix}^{3}} {{f}^{2} ( \frac{{ℳ}_{2} - {ℳ}_{1}}{ℳ} + \frac{( γ - 1 ) {k}_{T}}{{γα}_{1} {α}_{2}} )}^{2} . \qquad ( 3.16 )$$

In Eqn. 3.16, γmix is the ratio of specific heats (cp,mix/cv,mix) which is unitless, α₁ and α₂ are the molar fraction of species 1 and 2 (respectively) in moles of constituent per moles of mixture [unitless], aₘᵢₓ is the adiabatic sounds speed for the mixture in m s-1, f is the frequency in Hz, M1 and M2 which are the relative molar masses (molecular weights) for species 1 and 2 (respectively), and Mₘᵢₓ is the relative molar mass of the mixture, which can be defined as,

$${ℳ}_{mix} = {\sum }_{i = 1}^{n} {α}_{i} {ℳ}_{i} , \qquad ( 3.17 )$$

where k_{T} is the thermal diffusion ratio. However, to produce physically realistic results, it is critical that k_{T} is related to the molar fractions such that m_{diffusion} does not shoot to infinity if one of the molar fractions is near-zero. A well behaved formulation for k_{T} is represented below.

k_{T} is specified as,

$${k}_{T} = \frac{{D}_{T}}{{D}_{12}} = 5 ( C - 1 ) \frac{{s}_{1} \frac{{α}_{1}}{α1 + α2} - {s}_{2} \frac{{α}_{2}}{α1 + α2}}{{Q}_{1} \frac{{α}_{1}}{α2} + {Q}_{2} \frac{{α}_{2}}{α1} + {Q}_{12}} , \qquad ( 3.18 )$$

where α₁ and α₂ are the molar fraction of species 1 and 2 (respectively) in moles of constituent per moles of mixture [unitless]. D₁₂ is the concentration (or mutual) diffusion coefficient, which is unitless, and D_{T} is the thermal diffusion coefficient in units of m²/s and is formed as,

$${D}_{T} = \frac{{k}_{mix}}{{ρ}_{mix} {γ}_{mix} {C}_{v ( kg ) , mix}} , \qquad ( 3.19 )$$

where κₘᵢₓ is the thermal conductivity of the mixture in W m⁻¹ K⁻¹, ρₘᵢₓ is the density of the mixture in kg/m³, γₘᵢₓ is the ratio of specific heats (c_{p,mix}/c_{v,mix}) which is unitless, and c_{v(kg),mix} is the specific heat at constant volume in J kg⁻¹ K⁻¹. Furthermore, s₁ and s₂ are defined as,

s₁=M₁²E₁−3M₂(M₂−M₁)+4M₁M₂A, (3.20)

and,

s₂=M₂²E₂−3M₁(M₁−M₂)+4M₂M₁A. (3.21)

Q₁, Q₂, and Q₁₂ are defined as,

Q₁=(M₁/(M₁+M₂)) E₁(6M₂²+(5−4B)M₁²+8M₁M₂A), O(3.22)

Q₂=(M₂/(M₂+M₁)) E₂(6M₁²+(5−4B)M₂²+8M₂M₁A), (3.23)

and,

Q₁₂=3(M₁²+M₂²)+4M₁M₂A(11−4B)+2M₁M₂E₁E₂. (3.24)

M₁ and M₂ are the molecular masses of constituents 1 and 2. E₁ and E₂ are defined as,

$$\begin{matrix}{E}_{1} = \frac{2}{( 5 {M}_{1}} \sqrt{\frac{2}{{M}_{2}}} {( {M}_{1} + {M}_{2} )}^{\frac{3}{2}} \frac{{σ}_{1}^{2}}{{σ}_{12}^{2}} , \\ and , & ( 3.25 ) \\ {E}_{2} = \frac{2}{( 5 {M}_{2}} \sqrt{\frac{2}{{M}_{1}}} ( {M}_{2} + {M}_{1}^{\frac{3}{2}} \frac{{σ}_{2}^{2}}{{σ}_{12}^{2}} , & ( 3.26 )\end{matrix}$$

where a₁ and a₂ are the collision diameters for species 1 and 2 (respectively) in m as defined by the Lennard-Jones potential. a₁₂ is the effective collision diameter between species 1 and 2, which is defined as,

σ₁₂=σ₁+σ₂/2. (3.27)

Finally, A=2/5, B=3/5, and C=6/5 for a gas of elastic spheres.

### Curvature Effect

Curved, sound-carrying tubes are commonly found in musical instruments, which forms an interesting basis for theoretical study (particularly given the rich plethora of implementations developed by craftspeople). Fortunately, the same efforts that developed the mathematical underpinnings for understanding the behavior of sound in musical instruments are just as relevant to understanding the behavior of an acoustic attenuation sensor. A formulation for the attenuation coefficient for viscous losses in curved ducts is as follows,

m_{curve}=ρ/λ aR₀²/1 \sqrt{(a_{c}−1)³(a_{c}+1)⁵/2a_{c}⁴/n(a_{c})³}, (3.28)

where m_{curve} is the attenuation coefficient for a curved tube section (in m⁻¹), μ is the dynamic viscosity reference in Pa·s, p is the density in kg/m³, a is the sound speed in m s⁻¹, R₀ is the midline radius of curvature, and a_{c} is the curvature parameter, which is defined as a_{c}=R₂/R₁, R₁ and R₂.

One can see from this formulation that the bulk losses for a propagating wave in a curved duct can be orders of magnitude larger than the bulk losses in a straight duct, particularly for small R₀. Therefore, the ability to quantify this effect is of great interest if the sensor design includes a coiled transmission path, which is imminently important given the desire to develop a miniaturized device package.

Furthermore, it is possible that the transmission length may include a straight portion of tubing attached to a curved portion, or that multiple curvatures are used along the total length. Assuming that the principle of superposition holds, an attenuation coefficient for the total system was formulated as,

$${m}_{curve , total} = {\sum }_{k = 1}^{n} {m}_{curve , k} \frac{{l}_{k}}{L} , \qquad ( 3.29 )$$

where lₖ is the length of some section k (corresponding to the kth attenuation coefficient, m_{curve,k}), n is the total number of differently curved sections, L is the total length, and m_{curve,total} is the curvature attenuation coefficient for the total system. This m_{curve,total} can be readily compared to all other forms of attenuation for a device geometry that is not continuously curved at one midline radius of curvature R₀.

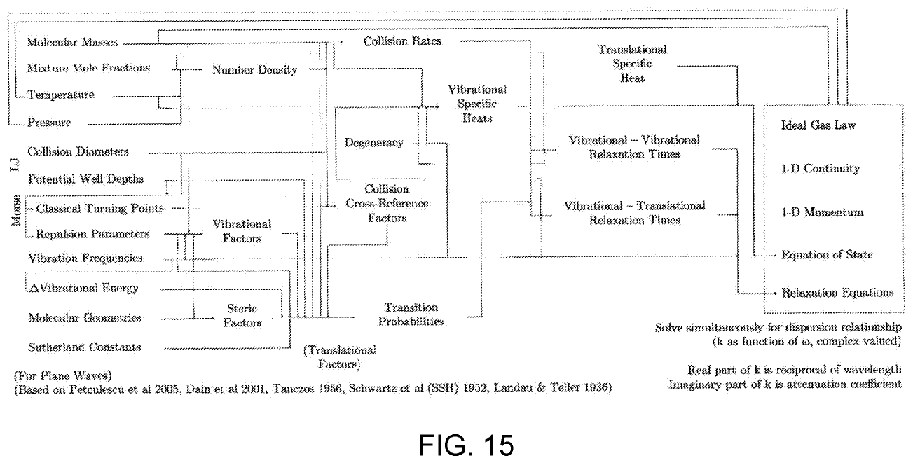

While this formulation is for ducts with rectangular cross section, the effective radius presented in FIG. 15 is presumed to be a valid stand-in for non-rectangular ducts. Finally, as long as the height H of the curved rectangular duct is sufficiently small (such that kH<1, where k is the wavenumber), then there is no appreciable acoustic motion in the vertical direction and the equation. The absolute maximum kH in the design space is expected to occur at a height H of 12.7 mm, frequency f of 20 kHz (angular frequency of 125.7 krad), and a sound speed a of 133 m s⁻¹ at 11° C. (for sulfur hexafluoride). The resulting kH is approximately 14. While this is significantly more than 1, two considerations must be made. First, in this estimate—the tube diameter used in the version 3.2 prototype was 9.52 mm, mostly testing gases with between 2 and 10 times the speed of sound of sulfur hexafluoride, at a range of frequencies between 1 kHz and 20 kHz, meaning the kH was mostly between approximately 0.05 and 4. Second, vertical acoustic motion in curved ducts is not taken into account for these results.

### Thermal Radiation Effect

Previous experimental evidence in the field indicates no attenuation is caused by thermal radiation in the acoustic vibration frequency range of 50 Hz to 100 MHz. Therefore, whatever minor attenuation that may be caused by thermal radiation and reabsorption is ignored.

### Nonclassical

For polyatomic fluids, the notion that the gas behaves ideally is no longer accurate. This is due to the fact that energy can be transferred between external degrees of freedom to internal degrees of freedom involving molecular vibration and rotation modes. Upon the passage of a sound wave, excited molecules do not exchange vibrational or rotational energies infinitely fast with the translational degrees of freedom associated with the temperature fluctuations. Therefore, the goal of this analysis is to calculate the relevant relaxation time for the transfer of energy from internal to external degrees of freedom. When solving this simultaneously with other constitutive relations for gases, it is possible to determine the expected attenuation. In this analysis, rotational relaxation is ignored as it occurs over 100 times faster than vibrational relaxation (except for hydrogen). Therefore, only the vibration-vibration and translation-vibration energy transfers need to be addressed.

The general structure of the nonclassical model is described by FIG. 15, an original schematic.

### Important Constants and Variables

To deploy this model, the following constants are specified:
c (Speed of Light in Free Space)=299 792 458 m s⁻¹
h (Plank Constant)=6.626 070 040→|10⁻³⁴J s;
ε₀(Vacuum Permittivity)=8.854 187 817→|10⁻¹²F m⁻¹

Furthermore, it is necessary determine the following bulk properties:
P, pressure in Pa
T, temperature in K

In addition, it is necessary to collect the following parameters for each mixture constituent i.
Mᵢ, molar mass in kg mol⁻¹
αi, molar fraction of species i in moles of constituent per moles of mixture [unitless]
σi, collision diameter for species i in m as defined by the Lennard-Jones potential
εi, potential well depth for species i in J as defined by the Lennard-Jones potential
Cᵢ, Sutherland constant for species i in K
if the molecule is non-polar, an, the polarizability of the non-polar molecule in m³
if the molecule is polar, μₚ, the dipole moment of the polar molecule in Cm. Note that debyes is the relevant cgs unit for dipole moment, which uses the depreciated unit statcoulomb.

Finally, information about each vibrational mode a for each species i is required and includes:
v_{i,a}, wavenumber in m
P_{0,i,a}, geometric steric factor [unitless]
g_{i,a}, degeneracy [unitless]
Ā²_{i,a} vibrational amplitude coefficient in kg⁻¹

### Intermolecular Potentials

To begin any discussion that involves interactions between molecules, specifying the nature of intermolecular potentials is of great importance. This can be defined as a function of r, the center-to-center distance. With mixtures of polar and non-polar molecules, three types of interactions are possible. These can be formulated according to Eqn. 3.30 describing non-polar- non-polar interactions and Eqn. 3.31 describing polar-non-polar interactions (The indices i and j have been replaced with n and p, indicating the non-polar and polar molecule respectively.), and Eqn. 3.32 describing polar-polar interactions. These are,

$$\begin{matrix}ϕ ( r ) = 4 {ϵ}_{i , j} ( {( \frac{{σ}_{i , j}}{r} )}^{12} - {( \frac{{σ}_{i , j}}{r} )}^{6} ) , & ( 3.30 ) \\ ϕ ( r ) = 4 {ϵ}_{n , p} ( {( \frac{{σ}_{n , p}}{r} )}^{12} - {( \frac{{σ}_{n , p}}{r} )}^{6} ) - \frac{1}{4 {πϵ}_{0}} \frac{{α}_{n} {μ}_{p}^{2}}{{r}^{6}} , & ( 3.31 )\end{matrix}$$

where αₙ, the polarizability of the non-polar molecule and λₚ is the dipole moment of the polar molecule, and

$$ϕ ( r ) = 4 {ϵ}_{i , j} ( {( \frac{{σ}_{i , j}}{r} )}^{12} - {( \frac{{σ}_{i , j}}{r} )}^{6} - {{δ}_{i , j}^{*} ( \frac{{σ}_{i , j}}{r} )}^{3} ) , \qquad ( 3.32 )$$

where δ*_{i,j} is the non-dimensional measure of dipole strength for species i and j, formulated as,

$${δ}_{i , j}^{*} = \frac{1}{4 {πϵ}_{0}} \frac{{μ}_{i} {μ}_{j}}{2 {ϵ}_{i , j} {σ}_{i , j}^{3}} . \qquad ( 3.33 )$$

σ_{i,j} (the collision diameter for an interaction between species i and j) is defined as per Eqn. 2.23 and ε_{i,j} (the pairwise potential depth for a collision between species i and j) as,

ε_{i,j}=\sqrt{εᵢεⱼ}. (3.34)

Note that εᵢ=ε_{i,i} for like molecules.

### The Exponential Intermolecular Potential

To solve for the transition probabilities between vibrational and translational degrees of freedom, an analytical solution to the Schrodinger equation for the motion of a free particle in a potential field must be determined. Such solutions are difficult to come by but do exist for an exponential repulsive potential. As such, these potentials are cast as exponential potentials. It may seem arbitrary to define an approximation of reality with Eqn. 3.30, 3.31, and 3.32 and then immediately require a different approximation in the form of an exponential repulsive potential. However, note that the former (Lennard-Jones or Lennard-Jones-like) are models for which parameters have been fit to viscosity or the second virial coefficient for the calculation of the equation of state properties for which tabulated values for many gases have been catalogued but for which an analytical solution is not available. In contrast, the latter (exponential) is easily solved analytically but for which no tabulated parameters readily exist. Therefore, the relevant parameters must be determined for the exponential model using the catalogued parameters for the models in Eqn. 3.30, 3.31, 3.32.

The exponential potential is characterized as,

ϕₑₓₚ(r)=(ε_{i,j}+E*_{i,j})e^{α*8}^{_{i,j}}^{(r}^{_{c(i,j)}}^{-r)}−ε_{i,j}. (3.35)

Here, ε_{i,j} is again the pairwise potential depth for a collision between species i and j in J, r_{c(i,j)} is the classical turning point for species i and j in m, α*_{i,j} is the repulsion parameter (that must be fit) in m⁻¹, and E*_{i,j} is the collision kinetic energy between species i and j in J, which is defined as,

$${E}_{i , j}^{*} = {μ}_{red ( i , j )} \frac{{v}_{0}^{{*}^{2}}}{2} , \qquad ( 3.36 )$$

where μ_{red(i,j)} is the reduced mass of the collision pair i and j, defined as,

$${μ}_{red ( i , j )} = \frac{{m}_{i} {m}_{j}}{{m}_{i} + {m}_{j}} , \qquad ( 3.37 )$$

with mi representing the molecular mass of molecule i with both and mᵢ and μ_{red(i,j)} in units of kg per molecule. v*₀ is the transition-favorable incident velocity, which is related to the energy stored in the internal degree of freedom, the repulsion parameter, and other parameters by the relation,

$$\frac{{μ}_{red ( i , j )} {v}_{0}^{{*}^{2}}}{2 {k}_{B} T} = {( \frac{2 {( Δ E )}^{2} {μ}_{red ( i , j )} {π}^{4}}{{α}_{i , j}^{{*}^{2}} {h}^{2} {k}_{B} T} )}^{\frac{1}{3}} , \qquad ( 3.38 )$$

The only new parameter here, ΔE, is the energy exchanged with translational degrees of freedom during a collision process, described by Eqn. 3.39 as,

ΔE=hc(\tilde{v}ₐ(iₐ−fₐ)+\tilde{v}_{b}(i_{b}−f_{b})), (3.39

where iₐ and i_{b} are the initial harmonic oscillator states and fₐ and f_{b} are the final harmonic oscillator states for molecules a and b respectively. This work only takes into account zero- and one-quantum jumps (|i−f|=1 or 0) but addressing two-quantum jumps are discussed elsewhere. As presented in later sections, the model (with this zero- and one-quantum jump assumption) appears to match literature values as well as experimental results, indicating that addressing two-quantum jumps is but a minor correctional term.

With relations between E*_{i,j} and α*_{i,j} specified, fitting the exponential potential to the relevant model (Eqn. 3.30, 3.31, 3.32) is of prime importance. Two options for fitting to the Lennard-Jones potential are presented in the literature. Both methods equate the potentials at the classical turning point (r_{c}). Method A makes the exponential curve tangential to the LJ potential at the classical turning point. Method B equates the potentials at a second point specified by the zero potential point (or hard-sphere collision diameter) for species i and j, a_{i,j}, notes that Method B is usually found to agree better with experiment, so this method is used herein.

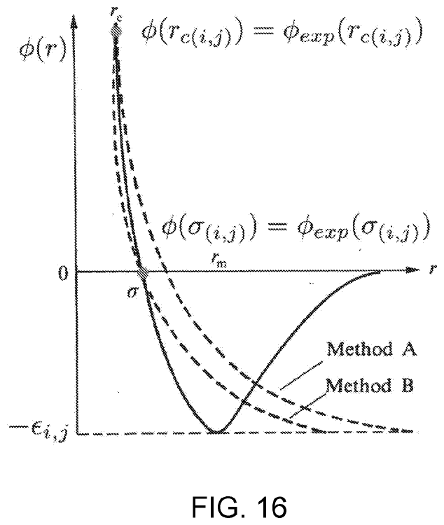

FIG. 16 shows an adapted version of a plot found in in the literature and sketches curves representing Method A and B fits to a Lennard-Jones potential. The two equations shown represent the constraints imposed by Method B. Discrepancy at large r is inconsequential since the collisions are assumed to be effective only at small separations in the vicinity of the classical turning point.

For non-polar-non-polar interactions, an approach to fit the exponential potential iteratively is used. A linear spaced vector was setup defining possible α*_{i,j} values (from 1×10⁹ m⁻¹ to 1×10¹² m⁻¹) and E*_{i,j} was calculated by rearranging Eqn. 3.36 and 3.38 as,

$${E}_{i , j}^{*} = {k}_{B} {T ( \frac{2 {( Δ E )}^{2} {μ}_{red ( i , j )} {π}^{4}}{{α}_{i , j}^{{*}^{2}} {h}^{2} {k}_{B} T} )}^{\frac{1}{3}} . \qquad ( 3.40 )$$

The two constraints imposed by Method B (ø_{LJ}(r_{c(i,j)}=øₑₓₚ(r_{c(i,j)}) and ø_{LJ}(a_{(i,j)})=øₑₓₚ(a_{(i,j)})) lead to the following equations, respectively,

$$\begin{matrix}4 {ϵ}_{i , j} ( {( \frac{{σ}_{i , j}}{{r}_{c ( i , j )}} )}^{12} - {( \frac{{σ}_{i , j}}{{r}_{c ( i , j )}} )}^{6} ) = {E}_{i , j}^{*} , \\ and , & ( 3.41 ) \\ 0 = ( {ϵ}_{i , j} + {E}_{i , j}^{*} ) {e}^{{α}_{i , j}^{*} ( {r}_{c ( i , j )} - {σ}_{i , j} )} - {ϵ}_{i , j} . & ( 3.42 )\end{matrix}$$

It's possible to solve Eqn. 3.41 for r_{c(i,j)} by recasting it as a quadratic equation and solving with the quadratic formula to determine a value for row. This results in the equation,

$${r}_{c ( i , j )} = \sqrt[6]{\frac{- {σ}_{i , j}^{6} + {σ}_{i , j}^{6} \sqrt{1 + \frac{{E}_{i , j}^{*}}{{ϵ}_{i , j}}}}{\frac{{E}_{i , j}^{*}}{2 {ϵ}_{i , j}}}} . \qquad ( 3.43 )$$

As a function of α*_{i,j}, the difference between the Lennard-Jones and exponential potential can be plotted at the two constraint positions r=r_{c(i,j)} and r=σ_{(i,j)}. Of course, at r=r_{c(i,j)}, Eqn. 3.43 ensures that the two potentials are coincident. Therefore, the α*_{i,j} at r=σ_{(i,j)} must be determined for which the difference between the two potentials equals zero, or ø_{LJ}(a_{(i,j)}−øₑₓₚ(a_{(i,j)})=0.

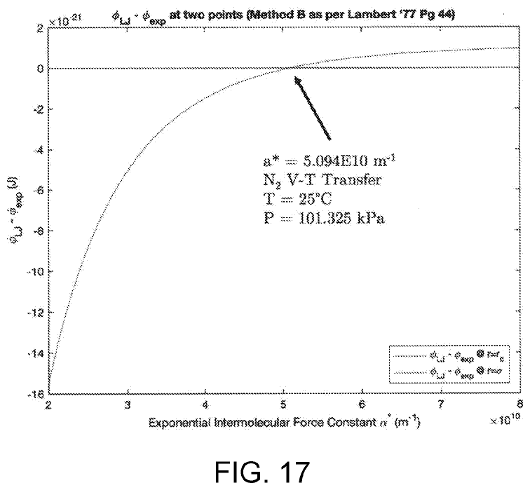

FIG. 17 shows the difference between the Lennard-Jones and exponential potential for a sample of pure nitrogen's vibration-to-translation transfer for T=25° C. and P=101.325 Pa for a range of α*_{i,j} values. Note that ø_{LJ}(r_{c(i,j)})−øₑₓₚ(r_{c(i,j)})=0 for all α*_{i,j} but at r=σ_{(i,j)}, there is only one α*_{i,j} for which the difference between the potentials is zero. This one α*_{i,j} represents the required α*_{i,j} for which the constraints on Method B are met.

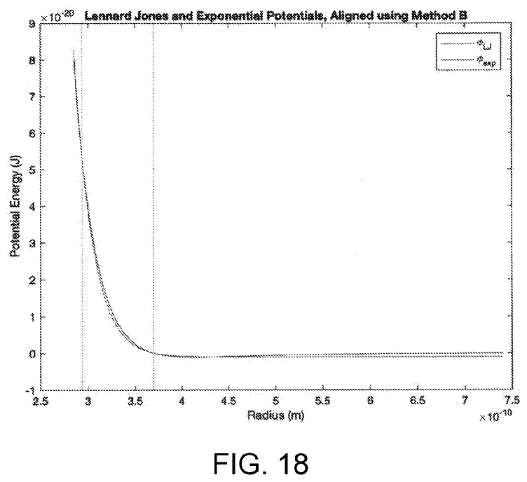

The value determined for α*_{i, j} then can be used to plot the exponential potential, which can be compared to the Lennard-Jones potential (see FIG. 18). Indeed, the Lennard-Jones potential for non-polar-non-polar interactions matches at the classical turning point r=r_{c(i,j)} (the vertical red line on the left) and the zero potential point r=σa_{(i,j)} (or hard-sphere collision diameter, indicated by the vertical red line on the right) for species i and j given a particular vibrational mode.

For polar-non-polar interactions, the same general process is undertaken. E*_{i,j} is defined as it is in Eqn. 3.40. Because both the Lennard-Jones potential (Eqn. 3.30) for non-polar-non-polar interactions and the Hirschfelder potential (Eqn. 3.31) for polar-non-polar interactions have only 12-6 terms, it is possible to recast the Lennard-Jones parameters with the induced dipole modification included (given the presence of the polar molecule) as follows:

σ_{n,p}¹=ξ^{-6/1} 2/σ_{n,n}+σ_{p,p}, (3.44)

and,

ε_{n,p}¹=ξ² \sqrt{ε_{n,n}ε_{p,p}}, (3.45)

where the correctional term ξ is defined as,

ξ=1+4σ_{n,n}^{3/α}ₙ 4πε₀/1 ε_{p,p}σ_{p,p}^{3/μ}ₚ² \sqrt{ε_{n,n}/ε_{p,p}}, (3.46)

with subscripts n and p referring to the non-polar and polar molecules respectively. With this formulation, r_{c(i,j)} is specified as in Eqn. 3.43 with σ_{n,p}′ and ε_{n,p}′ instead of σ_{i,j} and ε_{i,j} and α*_{i,j} can be solved for as with the non-polar-non-polar interaction.

Finally, for polar-polar interactions, first δ*_{i,j} must be computed as per Eqn. 3.33. Whereas Method B specifies r=r_{c(i,j)} and a_{(i j)} as the coincident points, a_{(i,j)} was chosen because the potential was zero. Therefore, Method B was modified when dealing with polar-polar interactions so that r=r_{c(i,j)} was one coincident point (same as Method B) but the second coincident point was chosen as the position where the Krieger potential was zero, which is labeled r=r_{0,i,j}. This approach keeps the spirit of Method B but adjusts the second coincident point away from r=σ_{(i,j)} (where the potential is nonzero) to r=r_{0,i,j} (where the potential is zero).

With this new fitting approach (Method C) the two constraints (øKrieger(rc(i,j))=øexp(rc(i,j)) and øKrieger(r0,i,j)=øexp(r0,i,j)) can again be imposed.

First, a value for r_{c(i,j)} must be determined. Whereas the non-polar-non-polar and polar-non-polar interactions could be recast as a quadratic equation and the quadratic formula could be used to determine a value for _{rc}(ᵢⱼ)_{,} that approach is not possible here. When r=r_{c(i,j)} is set, the coincidence of the Krieger potential and the exponential potential leads to the equation,

$$4 {ϵ}_{i , j} ( {( \frac{{σ}_{i , j}}{{r}_{c ( i , j )}} )}^{12} - {( \frac{{σ}_{i , j}}{{r}_{c ( i , j )}} )}^{6} - {{δ}_{i , j}^{*} ( \frac{{σ}_{i , j}}{{r}_{c ( i , j )}} )}^{3} ) = {E}_{i , j}^{*} . \qquad ( 3.47 )$$

This can be rearranged as,

$$0 = {σ}_{i , j}^{12} - {σ}_{i , j}^{6} {r}_{c ( i , j )}^{6} - {δ}_{i , j}^{*} {σ}_{i , j}^{3} {r}_{c ( i , j )}^{9} - \frac{{E}_{i , j}^{*}}{4 {ϵ}_{i , j}} {r}_{c ( i , j )}^{12} , \qquad ( 3.48 )$$

and the real, positive root is the desired value for r_{c(i,j)}. This is numerically solved using MATLAB's roots function. No issues with multiple real, positive roots or no real, positive roots were encountered (there was always only one real, positive root with the physical parameters of the gases analyzed).

Second, the value of r_{0,i,j} must be identified. By setting Eqn. 3.32 to zero, r_{0,i,j} is the real, positive root to the following equation:

0=−δ*_{i,j}σ_{i,j}³r_{0,i,j}⁹−σ_{i,j}⁶r_{0,i,j}⁶+σ_{i,j}¹2. (3.49)

This is solved numerically using MATLAB's roots function. Similarly, no issues with multiple real, positive roots or no real, positive roots (there was always only one real, positive root with the physical parameters of the gases analyzed) were encountered.

Now, with values for r_{c(i,j)} and r_{0,i,j} known, the same approach for determining α*_{i,j} as detailed above is followed for non-polar-non-polar interactions (setup linear spaced vector defining possible α*_{i,j} values, compute the difference between the Krieger potential and the exponential potential at r=r_{c(i,j)} and r=r_{0,i,j}, confirm the potential difference is zero for all α*_{i,j} at r=r_{c(i,j)}, find α*_{i,j} for which potential difference is zero at r=r_{0,ij}).

The above calculations determine α*_{i,j} and r_{c(i,j)} for interactions between polar and non-polar molecules. These can first be completed for the vibration-to-translation energy transfer case where i_{b} and f_{b} (in Eqn. 3.39) are zero. Secondly, the procedures described also can be completed for the vibration-to-vibration energy transfer case, where energy found in an internal degree of freedom in one molecule is transferred into the internal degree of freedom in a different molecule (with the addition or subtraction of kinetic energy making up any energy difference).

### Collision Rates

With an understanding of the potential fields modeled molecules obey (with respect to vibration-to-translation and vibration-to-vibration energy transfers), it is critical to move onto describing the rate at which molecular interactions occur. This involves calculating collision rates between a molecule of species i with species j, Z(i, j), in collisions per second. An equation for this measure is formulated as,

$$Z ( i , j ) = 2 {{ρ}_{n ( j )} ( \frac{{σ}_{i} + {σ}_{j}}{2} )}^{2} \sqrt{2 π {k}_{B} T \frac{{m}_{i} + {m}_{j}}{{m}_{i} {m}_{j}}} . \qquad ( 3.50 )$$

Here, ρₙ₍ⱼ₎ is the number density for species j in number of molecules per m³ and all other parameters have been identified above. Eqn. 3.50 can be derived.

### Unlike Sutherland Constant (Revisited)

This section restates the information from the Unlike Sutherland Constant section, which specified an unlike Sutherland constant for unlike gases. Here, the unlike Sutherland constant between unlike molecules (which is treated the same and simply included here for completeness) is addressed.

For collisions of unlike molecules, the next parameter necessary for modeling the interaction is the unlike Sutherland constant C_{i,j} between species i and j. The unlike Sutherland constant generally is,

C_{i,j}=\sqrt{CᵢCⱼ}, (3.51)

and if one of the molecules has a strong dipole, the unlike Sutherland constant is,

C_{i,j}=0.773\sqrt{CᵢCⱼ}. (3.52)

### Vibrational Factors

Next, the vibrational factors, [V i ,f ]² must be calculated. The literature states that for zero-quantum jumps, [V 0,0]²=1. For single-quantum jumps, the literature stipulates that the vibrational factors can be determined with the following equation,

$${[ {\overline{V}}_{0 , 1} ]}^{2} = {[ {\overline{V}}_{1 , 0} ]}^{2} = {α}_{i , j}^{{*}^{2}} ( {\overline{A}}_{i , a}^{2} ) \frac{h}{8 {π}^{2} {v}_{i , a} c} . \qquad ( 3.53 )$$

Here, α*_{i,j} is the repulsion parameter between two molecules of species i in m−1 (α*_{i,j} described above as part of the exponential potential), (Ā²_{i,a}) is the vibrational amplitude coefficient for particular vibration a of species i in kg⁻¹, and all other parameters and constants have been identified above.

(Ā²_{i,a}) is not a readily available parameter in standard chemistry lookup tables. It is important to note that this term ranges from 0 to 1, with a value at or near 1 for vibrations involving hydrogen atoms, approximately 0.5 for vibrations involving deuterium, and between 0.01 and 0.1 for all other vibrations (with most tabulated values between 0.05 and 1). Patterns can be gleaned for similar molecules (both in terms of constituent atoms and structure). For several of the gases, (Ā²_{i,a}) was approximated using a similar molecular structure for similar vibrational modes. While certainly not exact, this provides a first-order estimate for to proceed with the calculations.

### Transition Probabilities

The next step formulates the probability that a collision will result in the transfer of energy. The probability for a non-resonant exchange (where non-resonant is defined for ΔE≥3.97→|10⁻²¹ J (200 cm⁻¹) from molecule a to molecule b) is,

$$\begin{matrix}{P}_{k \to l ( b )}^{i \to j ( a )} = {P}_{0} ( a ) {P}_{0} ( b ) \frac{1.364}{1 + {C}_{a , b} \text{/} T} {{{( \frac{{r}_{c ( a , b )}}{{σ}_{a , b}} )}^{2} [ {\overline{V}}_{{i}_{a} , {f}_{a}} ]}^{2} [ {\overline{V}}_{{i}_{b} , {f}_{b}} ]}^{2} 8 {( \frac{π}{3} )}^{\frac{1}{2}} \times {[ \frac{8 {π}^{3} {μ}_{red ( a , b )} Δ E}{{α}_{a , b}^{{*}^{2}} {h}^{2}} ]}^{2} {ζ}^{\frac{1}{2}} exp [ - 3 Ϛ + \frac{Δ E}{2 {k}_{B} T} + \frac{{ϵ}_{a , b}}{{k}_{B} T} ] , \\ where , & ( 3.54 ) \\ Ϛ = {( \frac{2 {{π}^{4} ( Δ E )}^{2} {μ}_{red ( a , b )}}{{α}_{a , b}^{{*}^{2}} {h}^{2} {k}_{B} T} )}^{\frac{1}{3}} . & ( 3.55 )\end{matrix}$$

Most all interactions encountered in this work were non-resonant.

Here, i and j represent the initial and final quantum excitation level of mode a, and k and 1 represent the initial and final quantum excitation level of mode b. The first critical terms are P₀(a) and P₀(b) which is the steric factor of mode a and b respectively. When a vibrational-to-translational transfer occurs, only the steric factor of the molecule containing the vibrational energy is relevant (as the “steric factor” for the molecule gaining kinetic energy is 1. Note that P₀a) and P₀(b) are defined for each mode for each molecule (this is specified as P_{0,i,a} in the list of material parameters that are needed to model the nonclassical attenuation. However, P₀(a) is the notation from). Lambert explains that this factor is 1/3 for diatomic molecules and for longitudinal vibrations of linear polyatomic molecules. Lambert further explains this factor is 2/3 for nonlinear polyatomic molecules and bending modes of linear molecules. Inaccuracies may arise when modeling hydrogen and hydrides with a low moment of inertia or polar molecules at low temperatures with preferred collision orientations.

The next critical term is the collision cross-reference factor

$$\frac{1.364}{1 + {C}_{a , b} \text{/} T} {( \frac{{r}_{c ( a , b )}}{{σ}_{a , b}} )}^{2} .$$

This term takes into account the unlike Sutherland constant for an interaction between species a and b (C_{a,b} as per Eqn. 3.51 and 3.52) in units of K, absolute temperature (T) in K, the classical turning point for species a and b (r_{c(a,b)}) in m and the zero potential point for species a and b (a_{a,b}) in m. The next term is the vibrational factors [V i a,f a]² and [V i b,f b]², which are described in Eqn. 3.53.

Finally, the remaining terms represent the translational factors, with μ_{red(a,b)} as the reduced mass of collision pair for species a and b from Eqn. 3.37 in kg per molecule, ΔE is the vibrational energy transferred from Eqn. 3.39 in J, h is the Plank constant, α*_{i,j} is the repulsion parameter for species a and b in m⁻¹, and ε_{a,b} is the pairwise potential depth for species a and b from Eqn. 3.34 in J, with the remaining variables defined elsewhere. P_{k→l(b)}^{i→j(a)} is calculated for vibrational-to-translational and vibrational-to-vibrational interactions.

### Time Constants

The translational and vibrational relaxation time constants can now be calculated which quantify a characteristic length of time required for energy to equilibrate between degrees of freedom. The equation for translational relaxation time is formulated as,

$${( {τ}_{i , j}^{VT} )}^{- 1} = Z ( i , j ) {P}_{0 \to 0}^{1 \to 0} ( i , j ) ( 1 - exp ( \frac{- {hcv}_{i}}{{k}_{b} T} ) ) , \qquad ( 3.56 )$$

where [symbol] _{i,j}^{VT} is the vibrational-to-translational relaxation time from mode i to species j in s, Z(i, j) is described in Eqn. 3.50,

$${P}_{0 \to 0}^{1 \to 0} ( i , j ) ( 1 - exp ( \frac{- {hcv}_{i}}{{k}_{b} T} ) )$$

includes the transitional probability described in Eqn. 3.60. vᵢ is the wavenumber for a particular vibration of species i in m⁻¹ and the remaining variables are defined elsewhere.

The equation for vibrational-to-vibrational relaxation time can be formulated as,

( [symbol] _{j,k}^{VV})⁻¹=αₖgₖZ(j, k) P_{0→1} ^{1→0} (j, k), (3.57)

Where [symbol] _{j,k}^{VV} is the vibrational-to-vibrational relaxation time from mode j to mode k. αₖ is the molar fraction of species with mode k, gₖ is the degeneracy of mode k, Z(i, j) is described in Eqn. 3.50, and P_{0→1}^{1→0}(j, k) is described in Eqn. 3.60.

With [symbol] _{i,j}^{VT} and [symbol] _{j,k}^{VV} determined for each possible interaction, a combined time constant taking into account all possible energy transfers away from a particular excited internal degree of freedom can be formulated. The vibrational-to-translational relaxation time from mode I (Tⱼ^{VT}) is given as,

$$\frac{1}{{τ}_{j}^{VT}} = {\sum }_{i = 1}^{n} \frac{{α}_{i}}{{τ}_{j , i}^{VT}} , \qquad ( 3.58 )$$

where αᵢ is the molar fraction of species with mode i and [symbol] _{j,i}^{VT} is the vibrational-to-translational relaxation time from mode i to species j in s.

### Vibrational Specific Heats

Next the vibrational specific heat for vibrational mode i in some species cv^{vib} must be formulated as,

$${c}_{i}^{vib} = \frac{{g}_{i} R}{{M}_{i}} {( \frac{{hv}_{i} c}{{k}_{B} T} )}^{2} \frac{exp ( \frac{{hv}_{i} c}{{k}_{B} T} )}{{( exp ( \frac{{hv}_{i} c}{{k}_{B} T} ) - 1 )}^{2}} , \qquad ( 3.59 )$$

where v ᵢ is the wavenumber for a particular vibration of species i in m⁻¹ and the remaining variables are defined elsewhere.

### Internal Temperature Difference Equation

Finally, a difference equation for the vibrational internal temperature of species j, T^{vib} can be formulated as,

$$\frac{d ( δ {T}_{j}^{vib} )}{dt} = \frac{δ T - δ {T}_{j}^{vib}}{{τ}_{j}^{VT}} + ( {\sum }_{k = 1 , k \neq j}^{n} \frac{1}{{τ}_{j , k}^{VV}} \frac{1 - exp ( - \frac{h {\tilde{v}}_{j} c}{{k}_{B} T} )}{1 - exp ( - \frac{h {\tilde{v}}_{k} c}{{k}_{B} T} )} ) \times ( ( δ T - δ {T}_{j}^{vib} ) - \frac{{\tilde{v}}_{k}}{{\tilde{v}}_{j}} ( δ T - δ {T}_{k}^{vib} ) ) , j ∈ \{ 1 , … , n \} , \qquad ( 3.60 )$$

where δX is defined as a small fluctuation in property X and the remaining variables are defined elsewhere.

This can be rewritten in vector form as,

$$\begin{matrix}\frac{d ( δ {T}^{vib} )}{dt} = - A ( δ {T}^{vib} ) + q ( δ T ) , & ( 3.61 ) \\ where , & \\ {A}_{j , j} = \frac{1}{{τ}_{j}^{VT}} + {\sum }_{k = 1 , k \neq j}^{n} \frac{1}{{τ}_{j , k}^{VV}} \frac{1 - exp ( - \frac{hc \tilde{{v}_{j}}}{{k}_{B} T} )}{1 - exp ( - \frac{hc \tilde{{v}_{k}}}{{k}_{B} T} )} , & ( 3.62 ) \\ {A}_{j , k} = - \frac{1}{{τ}_{j , k}^{VV}} \frac{1 - exp ( - \frac{hc \tilde{{v}_{j}}}{{k}_{B} T} )}{1 - exp ( - \frac{hc \tilde{{v}_{k}}}{{k}_{B} T} )} \frac{\tilde{{v}_{k}}}{\tilde{{v}_{j}}} , & ( 3.63 ) \\ and , & \\ {q}_{j} = \frac{1}{{τ}_{j}^{VT}} + {\sum }_{k = 1 , k \neq j}^{n} \frac{1}{{τ}_{j , k}^{VV}} \frac{1 - exp ( - \frac{hc \tilde{{v}_{j}}}{{k}_{B} T} )}{1 - exp ( - \frac{hc \tilde{{v}_{k}}}{{k}_{B} T} )} [ 1 - \frac{\tilde{{v}_{k}}}{\tilde{{v}_{j}}} ] . & ( 3.64 )\end{matrix}$$

### Nonclassical Euler Gas Equations

The constitutive equations that dictate the acoustic system behavior in the presence of sound waves can now be defined. The theory is based on the Euler gas equations as the model of a continuous medium for a polyatomic gas mixture accompanied by nonlinear semi-macroscopic population equations for the number of molecules in a given energy state. Assuming no diffusion of gas components, the acoustic equations for a gas mixture (which includes the internal temperatures of molecular vibrational modes) can be written as,

$$\frac{δ P}{{P}_{0}} = \frac{δρ}{{ρ}_{0}} + \frac{δ T}{{T}_{0}} , \qquad ( 3.65 )$$

where Eqn. 3.65 is derived from the ideal gas law,

$$\frac{\partial ( δρ )}{\partial t} + {ρ}_{0} \frac{\partial ( δ u )}{\partial x} = 0 , \qquad ( 3.66 )$$

where Eqn. 3.66 17 is derived from conservation of mass,

$$\frac{\partial ( δ u )}{\partial t} + \frac{1}{{ρ}_{0}} \frac{\partial ( δ P )}{\partial x} = 0 \qquad ( 3.67 )$$

where Eqn. 3.67 is derived from conservation of momentum, and

$$\frac{\partial ( δϵ )}{\partial t} + \frac{{P}_{0}}{{ρ}_{0}^{2}} \frac{\partial ( δρ )}{\partial t} = 0 \qquad ( 3.68 )$$

where Eqn. 3.68 is derived from conservation of energy. Specific energy δε can finally be formulated as,

$$δϵ = {c}_{v} δ T + {\sum }_{k = 1}^{n} {α}_{k} {c}_{k}^{vib} ( δ {T}_{k}^{vib} - δ T ) , \qquad ( 3.69 )$$

where it is related to the specific heat at constant volume (cᵥ) in J kg⁻¹ K⁻¹, the molar fraction of species with vibration k (σₖ) which is unitless, vibrational specific heat of species with vibration k (c^{vib}ₖ) in J kg⁻¹ K⁻¹, and the vibrational temperature of species with vibration k (δT^{vib}ₖ) in K with ε for energy in J and T for absolute temperature in K (where δX is defined as a small fluctuation in property X).

### Plane Wave Formulation

In building on the plane wave formulation the system of equations detailed above for harmonic plane waves will be solved such that all quantities take the plane wave form,

δf=f̅e^{-i(wt-kx)}, f ε {P, ρ, u, ε, T, Tⱼ^{vib}}. (3.70)

In Eqn. 3.70, c5f is the perturbation of the quantity f about the equilibrium value f₀ and f⁻ is the amplitude of the perturbation about equilibrium of the quantity f. Otherwise, the variables that can be substituted into f (shown in Eqn. 3.70) are defined elsewhere.

By substituting this form into Eqn. 3.65, 3.66, 3.67, 3.68, and 3.69 and using the notation f⁻ to define the amplitude of the perturbation about equilibrium of the quantity f,

$$\begin{matrix}\frac{\overline{P}}{{P}_{0}} = \frac{\overline{ρ}}{{ρ}_{0}} + \frac{\overline{T}}{{T}_{0}} , & ( 3.71 ) \\ \frac{\partial ( \overline{ρ} ( {e}^{- i ( ω t - kx )} ) )}{\partial t} + {ρ}_{0} \frac{\partial ( \overline{u} ( {e}^{- i ( ω t - kx )} ) )}{\partial x} = 0 \to - ω \overline{ρ} + {ρ}_{0} k \overline{u} = 0 , & ( 3.72 ) \\ \frac{\partial ( \overline{u} ( {e}^{- i ( ω t - kx )} ) )}{\partial t} + \frac{1}{{ρ}_{0}} \frac{\partial ( \overline{P} ( {e}^{- i ( ω t - kx )} ) )}{\partial x} = 0 \to - ω \overline{u} + \frac{k \overline{P}}{{ρ}_{0}} = 0 , & ( 3.73 ) \\ \frac{\partial ( \overline{ϵ} ( {e}^{- i ( ω t - kx )} ) )}{\partial t} + \frac{{P}_{0}}{{ρ}_{0}^{2}} \frac{\partial ( \overline{ρ} ( {e}^{- i ( ω t - kx )} ) )}{\partial t} = 0 \to \overline{ϵ} + \frac{{P}_{0} \overline{ρ}}{{ρ}_{0}^{2}} = 0 , & ( 3.74 ) \\ and , & \\ \overline{ϵ} = {c}_{v} \overline{T} + {\sum }_{k = 1}^{n} {α}_{k} {c}_{k}^{vib} ( \overline{{T}_{k}^{vib}} - \overline{T} ) . & ( 3.75 )\end{matrix}$$

Furthermore, Eqn. 3.74 and 3.75 can be combined and rearranged as,

$$( {c}_{v} - {\sum }_{k = 1}^{n} {α}_{k} {c}_{k}^{vib} ) \overline{T} + {\sum }_{k = 1}^{n} {α}_{k} {c}_{k}^{vib} \overline{{T}_{k}^{vib}} + \frac{{P}_{0} \overline{ρ}}{{ρ}_{0}^{2}} = 0. \qquad ( 3.76 )$$

Likewise, the substitution of Eqn. 3.70 into Eqn. 3.61 results in (with some rearrangement),

(A−iωI)T̅^̅{̅v̅i̅b̅}̅−qT̅=0. (3.77)

### System of Equations in Matrix Form and Solution Approach

Eqn. 3.71, 3.72, 3.73, 3.76, and 3.77 can be combined into matrix form as By=0, which can be represented as shown in Eqn. 3.78. Setting the determinant of matrix B equal to zero is necessary and sufficient for the system of equations to have non-trivial solutions and provides a dispersion relation, which is solved numerically. Because the only pieces that can freely covary in the matrix are k and ω, the wavenumber k can be determined as a function of ω. This wavenumber is complex and takes the form k=k_{R}+im_{NC}, with the real portion is proportional to the wavelength (k_{R}=2π/λ) in units of m⁻¹. The real portion can be used to determine the nonclassical sound speed a_{NC}(f)=2πf/k_{R}. m_{NC} in m⁻is the nonclassical attenuation coefficient and can be superimposed on classical sources of attenuation. While the nonclassical attenuation coefficient can be non-dimensionalized by multiplying by λ (making the attenuation measurement per wavelength), this non-dimensionalization technique is confusing, especially when plotted as a function of frequency. Simulation results shown later in this work use both dimensioned and dimensionless representations of the nonclassical attenuation coefficient, but the dimensioned approach (straight m_{NC}) is preferred as it is readily comparable to classical attenuation.

$$[ \begin{matrix}\frac{1}{{ρ}_{0}} & 0 & - \frac{1}{{ρ}_{0}} & \frac{1}{{T}_{0}} & 0 & 0 & … & 0 \\ - ω & {ρ}_{0} k & 0 & 0 & 0 & 0 & … & 0 \\ 0 & - ω & \frac{k}{{ρ}_{0}} & 0 & 0 & 0 & … & 0 \\ - \frac{{P}_{0}}{{ρ}_{0}^{2}} & 0 & 0 & {c}_{v} - {\sum }_{k = 1}^{n} {α}_{k} {c}_{k}^{vib} & {α}_{1} {c}_{1}^{vib} & {α}_{2} {c}_{2}^{vib} & … & {α}_{n} {c}_{n}^{vib} \\ 0 & 0 & 0 & - {q}_{1} & {A}_{1 , 1} - i ω & {A}_{1 , 2} & … & {A}_{1 , n} \\ 0 & 0 & 0 & - {q}_{2} & {A}_{2 , 1} & {A}_{2 , 2} - i ω & … & {A}_{2 , n} \\ ⋮ & ⋮ & ⋮ & ⋮ & ⋮ & ⋮ & ⋱ & ⋮ \\ 0 & 0 & 0 & - {q}_{n} & {A}_{n , 1} & {A}_{n , 2} & … & {A}_{n , n} - i ω\end{matrix} ] [ \begin{matrix}\overline{ρ} \\ \overline{u} \\ \overline{P} \\ \overline{T} \\ \overline{{T}_{1}^{vib}} \\ \overline{{T}_{2}^{vib}} \\ ⋮ \\ \overline{{T}_{n}^{vib}}\end{matrix} ] = 0 \qquad ( 3.78 )$$

Comparison with Measurements from Literature

With the model fully described in the previous sections it is now possible to compare values for nonclassical acoustic attenuation from literature to the output from the model. For the following simulations, atmospheric pressure of one standard atmosphere (101.325 Pa) was assumed if not explicitly stated in the source. Overall, the simulations provide very good estimates when compared to the experimental results from literature.

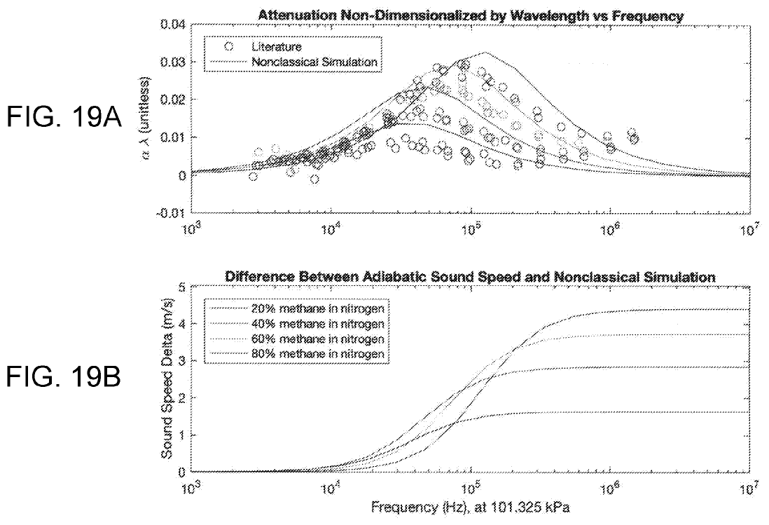

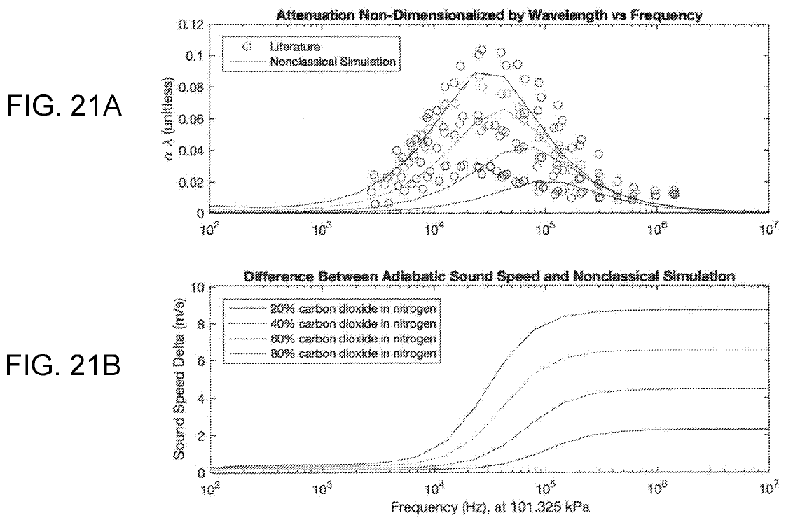

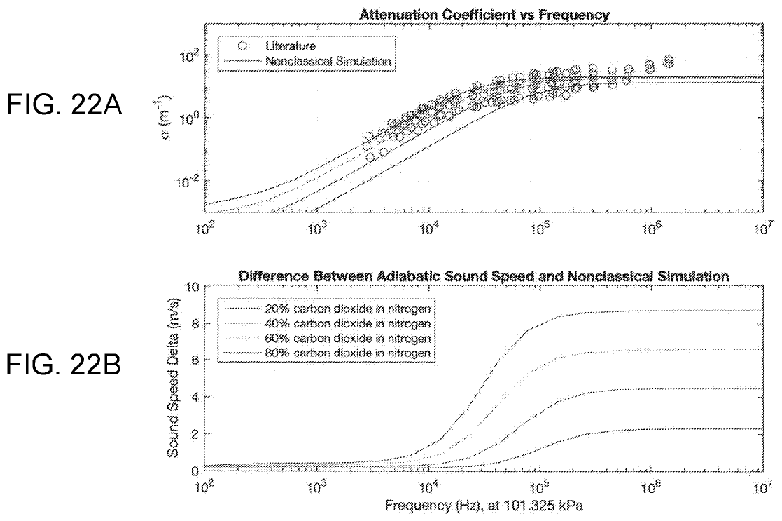

The simulations were compared against experimental work on mixtures of methane and nitrogen and carbon dioxide and nitrogen. The results are shown in FIGS. 19A-19B, 20A-20B and FIGS. 21A-21B and 22A-22B, respectively. It was assumed that the percentages reported were mole fractions. The simulations track well with the experimental results.

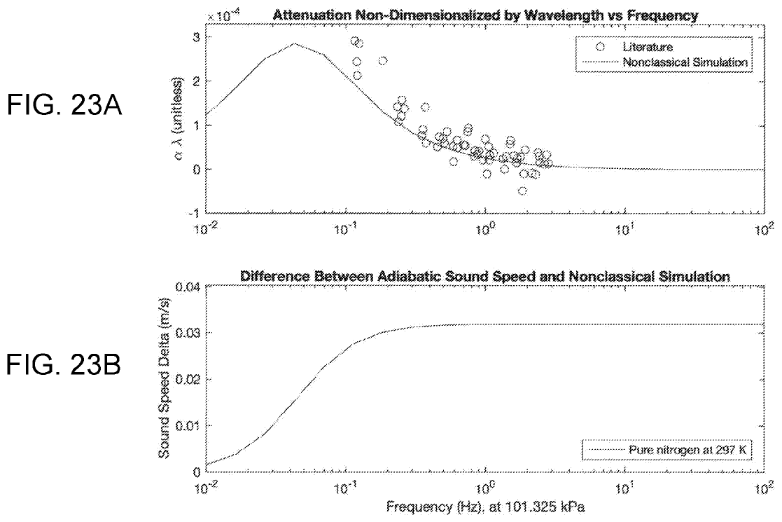

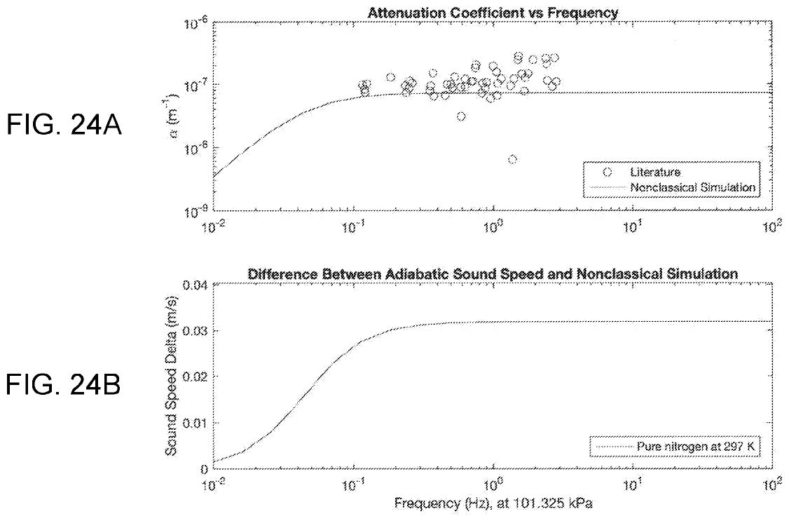

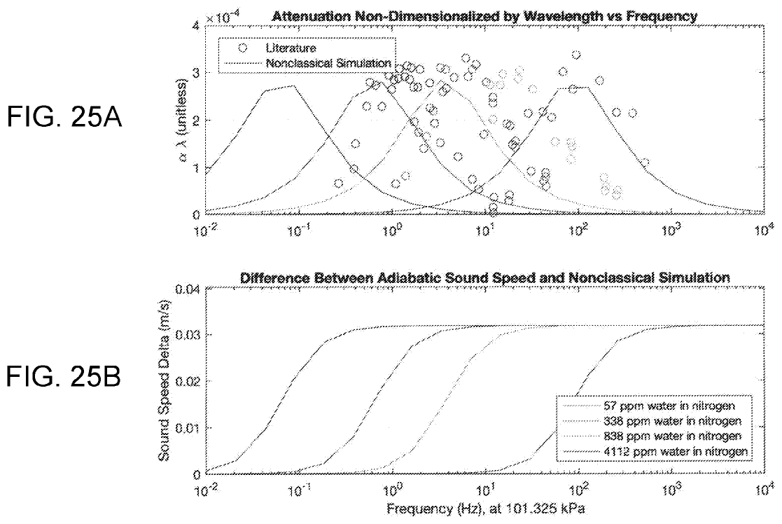

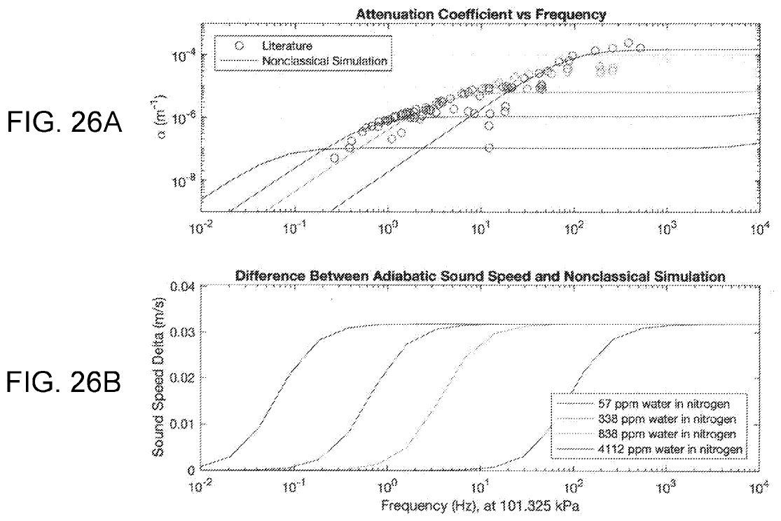

Next, experimental results for pure nitrogen were interrogated (shown in FIGS. 23A-23B and FIGS. 24A-24B) and mixtures of nitrogen with water vapor (shown in FIGS. 25A-25B and FIGS. 26A-26B). Agreement between the literature attenuation values and simulations is quite good in FIGS. 23A-23B and FIGS. 24A-24B. While the peak frequencies are off by up to two orders of magnitude in the simulations presented in FIGS. 25A-25B and FIGS. 26A-26B, realistically modeling the polarity of the water molecule is a potential limitation of this model. However, the general trends match—higher concentration of water vapor increases the peak in FIGS. 25A-25B, and the magnitudes are very similar.

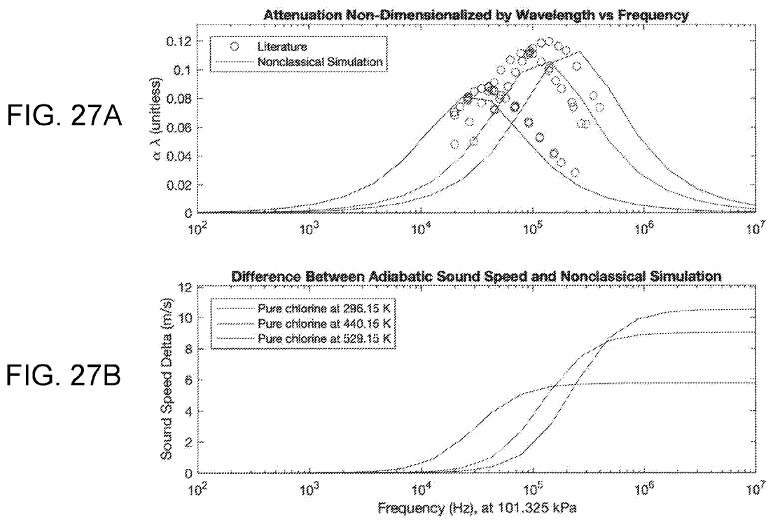

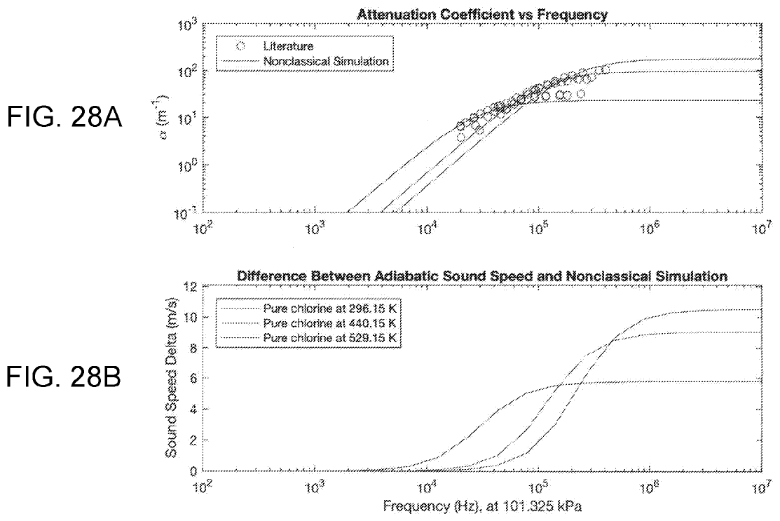

The non-classical attenuation of chlorine at several temperatures has previously been measured. The attenuation results were digitized for 23° C., 167° C., and 256° C. and simulated the non-classical attenuation, shown in FIGS. 27A-27B and FIGS. 28A-28B. Agreement between the literature and the simulation is very good.

### Device Development

Four generations of acoustic spectrometers were constructed. Version 1 and version 2 devices incorporated short aspect ratio cylindrical chambers (approximately 1.5:1 length:diameter). The goal of these versions was to excite resonant modes within the chambers (whereby the effective path length would several times the diameter or length of the chamber). Back of the envelope calculations using attenuation coefficients from the literature indicated substantial attenuation for relatively short effective path lengths (less than 1 m). The measured bode plot (which is defined as “spectra” moving forward) or impulse response (the Fourier transform pair of the Bode plot in the time domain) can be used as an indicator of gas composition and concentration. While preliminary analysis of the measured results indicated correlation between chemical composition and its measured spectrum, this effect was mainly driven by sound speed differences between samples. A change in sound speed caused the resonant modes supported in the fixed chamber to change frequency. These new resonant frequencies interacted with the transfer functions of the speaker and microphone to produce spectra with no ability to distinguish the chemical composition of two gases with the same speed of sound but different molecular makeup.

Version 3 was a reconfiguration that did not rely on acoustic reflections to achieve a long effective path length but rather a long aspect ratio chamber (approximately 100:1 length:diameter). This version had two distinct iterations, 3.1 and 3.2. Version 3.1 was a rough proof-of-concept that repackaged hardware from version 2. Version 3.2, the final (and functional) pre-commercial prototype, incorporated a thorough redesign of every component including a major reconfiguration of the system input and output signals to eliminate the effect of the speaker and microphone dynamics. This redesign was informed and optimized using acoustic attenuation modeling methods described herein. Version 3.2 allowed for the successful implementation of a robust sound speed estimation technique using phase measurements. This sound speed estimate allowed for the cancellation of resonant effects from the instrument's confined sensing volume. With this cancellation, attenuation across different gas mixtures could be readily compared.

This section details this development progression across these various configurations.

### Version 1 Design: Hardware and Software

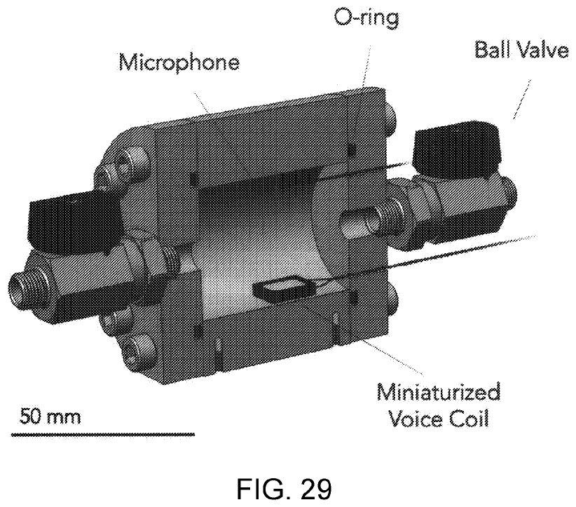

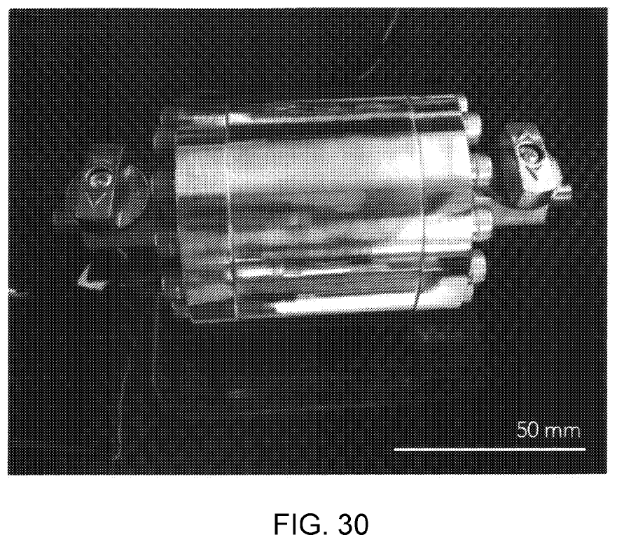

The first version of the acoustic spectrometer used a cylindrical cavity with diameter of 36 mm and length of 50 mm. The end caps and main cylinder were machined from 6061-T6 aluminum alloy. Ball valves mounted on the end caps (coaxial with the main cylinder) allowed for the chamber to be purged, filled, and sealed. O-rings were fitted into glands the end caps were machined into to seal the chamber from the environment. The end caps were mounted to the main cylinder with several M6→|1 cap head bolts. The design of this first version is shown in an illustrated cross section view in FIG. 29 and fully constructed in FIG. 30.

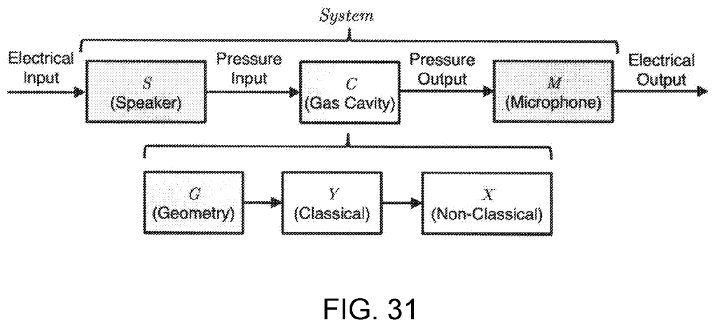

A block diagram outlining this version of the system is shown in FIG. 31. Note that this system structure persisted through Version 3.1.

A critical part of the dynamics of a gas cavity, in addition to any classical and nonclassical attenuation, is the geometry (as shown in FIG. 31). It is possible to predict the expected resonant peak frequency (for particular resonant modes) using methods presented in the literature. The fundamental resonant modes in a cylindrical cavity include longitudinal, azimuthal, and radial standing waves. Higher order modes are also possible. The frequency at which these standing waves occur has been described as,

$${f}_{SW} = \frac{a}{2} \sqrt{{( \frac{{B}_{m , n}}{R} )}^{2} + {( \frac{k}{L} )}^{2}} . \qquad ( 4.1 )$$

Here, fsw is the standing wave frequency in Hz, a is the sound speed in m s−1, B_{m,n} is the Bessel function coefficient which is unitless, R is the cylindrical cavity radius in m, L is the cylindrical cavity length in m, and k, m, and n define the longitudinal, azimuthal, and radial modes of the cavity which are unitless. It should be noted that the frequency at which the standing wave manifests for a given combination of k, m, and n is directly proportional to the sound speed.

A speaker (CDS15118BL100 by CUI Inc.) and microphone (ICS40618 by TDK InvenSense) were suspended on signal wires within the cavity. The electrical feedthroughs were sealed with candle wax. These components were not constrained and were free to move within the cavity (see FIG. 29).

The version 1 measurement system did not allow for control of the input signal from the computer. Instead, version 1 used a swept sine input from an external source (33220A by Agilent). This input signal, in addition to the measured signal from the microphone, was captured by a 9215 analog input module in a 9188 cDAQ chassis by National Instruments (100 kHz sample rate, 16-bit). The module was controlled by SignalExpress by LabVIEW. SignalExpress limited the recorded signal to 10 s when recording 2 channels at 100 kHz (on each channel).

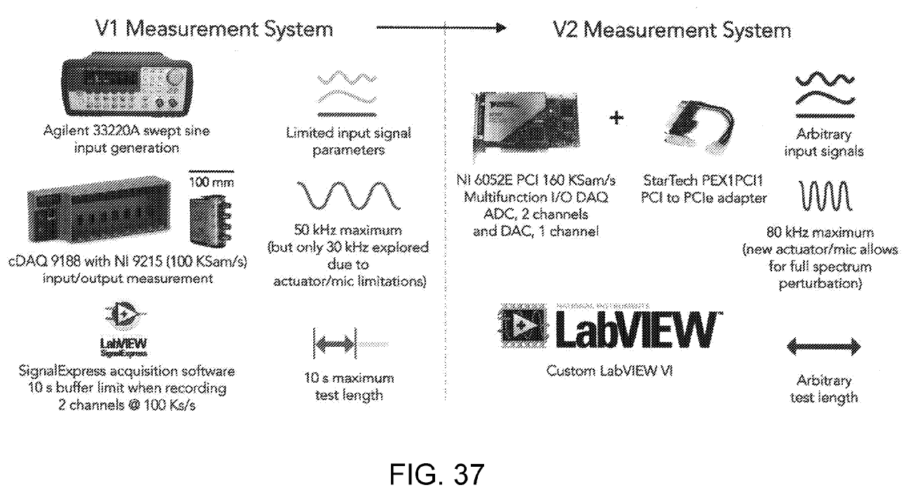

System identification techniques were deployed with a swept sine input, logarithmically scaled between 1-30 kHz over 9.5 s. Analysis was otherwise conducted as described in Stochastic Methods for Linear, Time Invariant Systems after signals were measured using the version 1 measurement system (detailed in FIG. 37) to produce measured spectra.

### Selected Measurement Results

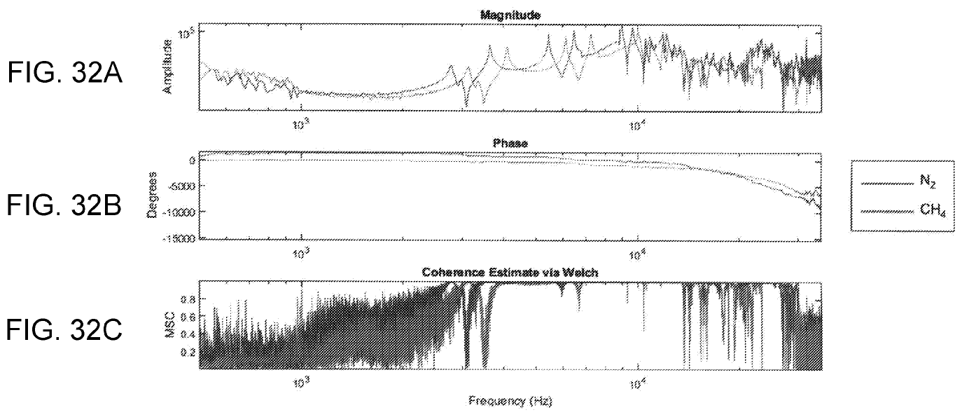

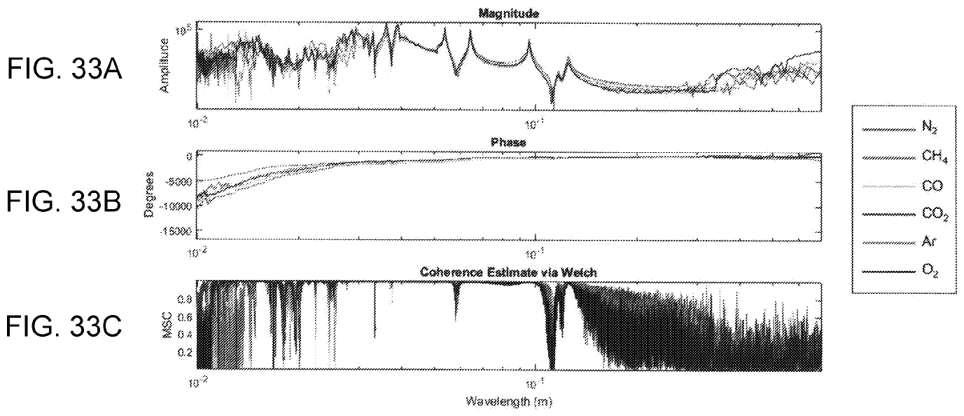

Results plotted as a function of frequency for pure nitrogen and pure methane are shown in FIGS. 32A-32C. Results as a function of wavelength for nitrogen, methane, carbon monoxide, carbon dioxide, argon and oxygen are shown in FIGS. 33A-33C. The wavelength is calculated using the expected sound speed for each gas from Eqn. 2.14 and the relationship between speed, wavelength, and frequency of a wave is given as,

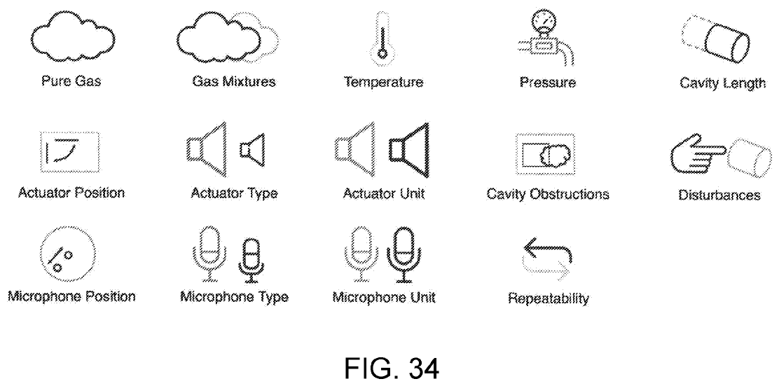

α=λf. (4.2)

where a is the sound speed in m s^{31 1}, λ is the wavelength in m, and f is the frequency in Hz. While unique spectra were measured for different gases with this rough prototype, a new design that constrained the positions of the microphone and speaker was necessary for more rigorous testing. Additionally, the effects of a host of parameters including temperature, geometry, and others was of interest (shown in FIG. 34) which first iteration was not suited to control for.

### Version 2 Design

With preliminary measurements from the first version suggesting that differences between gas species could be identified in the measurements, the first version of the design was improved by incorporating a number of changes that would allow the opportunity to test the parameters shown in FIG. 34.

### Hardware and Software

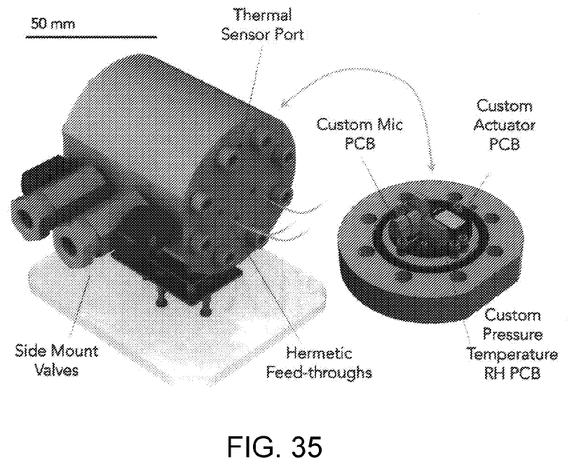

An illustrated view of the version 2 design is shown in FIG. 35. The first major difference between version 1 and version 2 was the side mounted ball valves. Aligned side mounting in version 2 was shown in COMSOL simulations to decrease the purge time by at least a factor of 5 (compared with coaxial mounting like in version 1). Purge time is the time necessary for a new gas introduced at the cavity inlet to flush 99% of any pre-existing gas from the cylinder. Specifically, whereas the purge time for version 1 with coaxial inlet and outlet was close to 50 s in COMSOL simulation, the purge time for version 2 was approximately 10 s. It is also curious to note that every inlet/outlet configuration tested performed better than the coaxial configuration used in version 1, with aligned side mounting (used in version 2) performing the best.

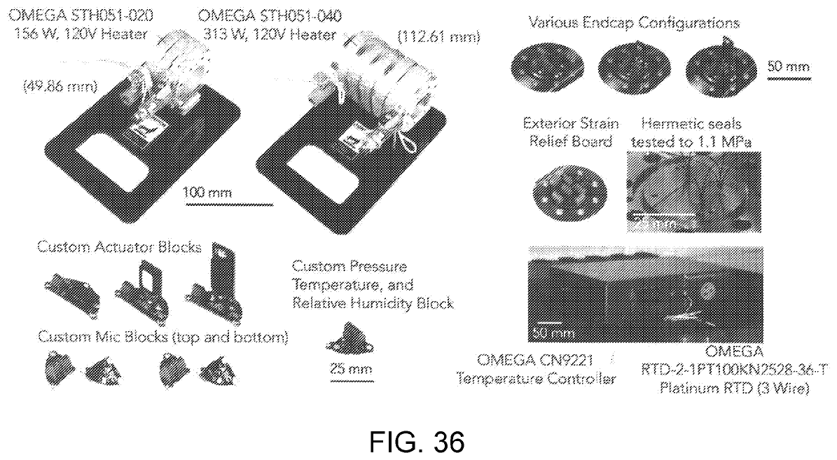

Three hermetically sealed electrical signal feed-throughs are integrated into one end cap. One was for the speaker input signal, one was for the microphone output signal, and one was for the I2C bus for communicating with the pressure, temperature, and relative humidity surface mount sensors in the cavity. These electrical components were mounted on custom printed circuit boards (PCBs). Like version 1, version 2 included O-rings fitted into glands the end caps were machined into to seal the chamber from the environment. The end caps and main cylinder were machined from 6061-T6 aluminum alloy. The number of M6→|1 cap head bolts were reduced from version 1 to version 2 given that the stress cones generated by the bolt pattern in version 2 was adequate to cover the O-ring. Finally, a thermal port was drilled through the end cap and approximately 30 mm into the main cylinder component to accept a platinum RTD probe (RTD-2-1PT100KN2528-36-T by OMEGA). This thermocouple closed a feedback loop with a heating element (STH051 (020 or 040) by OMEGA) not shown in FIG. 35 but shown in FIG. 36 in the top left) to provide temperature control for the cylinder. The fins mounted on the bottom of the device provided a tortuous conduction path for heat shielding between the chamber and the tabletop.

The fabricated components are shown FIG. 36. In the top left are shown the main cylinders (the first with a length of 49.86 mm and the second with a length of 112.61 mm. Multiple speakers and microphones in addition to pressure, temperature, and relative humidity sensors were mounted on custom PCBs, shown in the lower left of FIG. 36. The speaker configurations included a horizontally mounted CDS15118BL100 by CUI Inc., vertically mounted CDS15118BL100 by CUI Inc., and vertically mounted Batpure by Take T. The Microphones included center and edge mounted ICS40618 by TDK InvenSense and SPU0410LR5H by Knowles. A MS5837-30BA by TE Connectivity was used for measuring pressure and temperature and SHT-35-DIS-B by Sensirion for measuring relative humidity (and secondary temperature). In the upper right, various configurations are shown. Each of the speakers are mounted in the three views shown in the upper right. A strain relief board was mounted on the exterior of the end cap and connected to the actuation, sensing and environmental properties sensing boards through the hermetic seals, potted with epoxy (MP 54270BK by ASI) and shown in the middle right. At the lower right, a custom built enclosure for a closed-loop temperature controller (CN9221 by OMEGA) is shown with the platinum RTD probe.

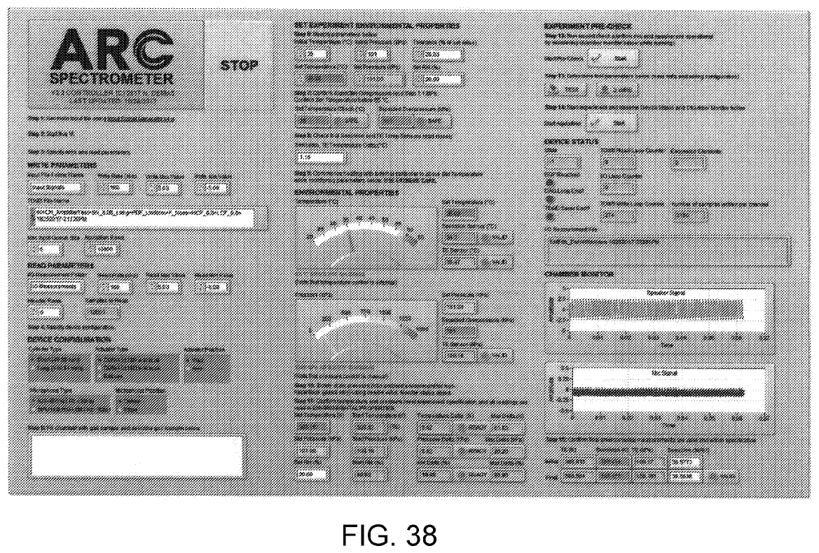

The data acquisition system capabilities from version 1 to version 2 were also updated, as shown in FIG. 36. Version 2′s data acquisition system allowed for arbitrary input signal to be generated by the PC through the digital to analog converter, increased the sample rate per channel on the ADC to 160 kHz, and allows any test length that did not exceed the memory capacity of the PC hard disk to be measured. To achieve these performance improvements, version 2 used a PCI DAQ card (6052E by National Instruments) and a custom LabVIEW VI (as shown in FIG. 38). Additionally, version 2 implemented a USB-8451 by National Instruments for I2C communications with the PC. Analysis of the measurements was conducted in MATLAB.

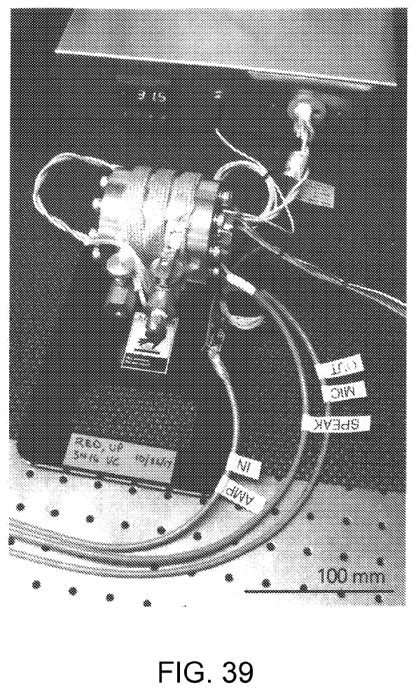

A view of the fully assembled version 2 device is shown in FIG. 39.

### Selected Measurement Results

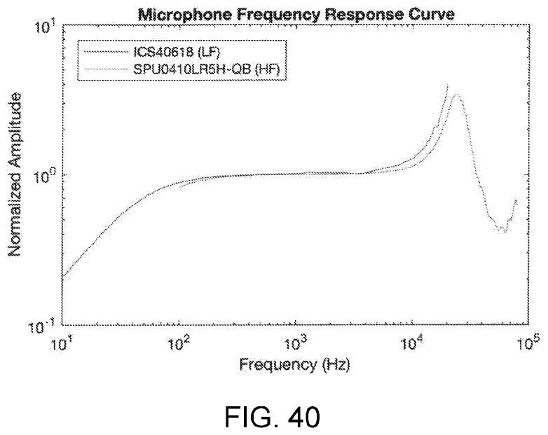

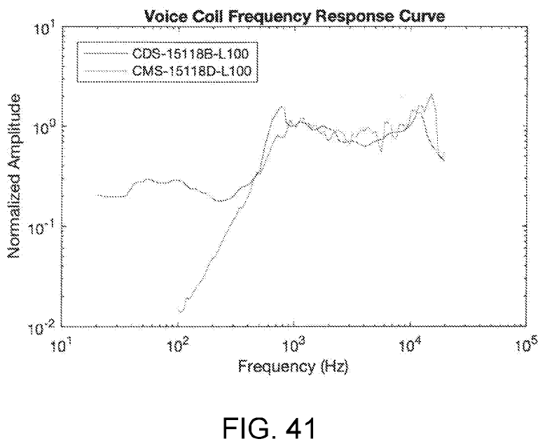

In the course of the experiments, it was realized that the dynamic behavior of the gas chamber was directly related to the sound speed, whereas the dynamics of the speaker and microphone were likely not related. Therefore, as the chemical composition was changed in a way that also changed sound speed, the resonant frequencies of the chamber would also change. Because the gain of the speaker and microphone was not unity across the frequency range tested (see FIG. 41 and FIG. 40 respectively for the speaker and microphone), these new resonant frequencies of the chamber would be amplified or attenuated by the transfer function of the speaker and microphone.

While the spectra for gases with different sound speeds had the amplitude effects of the speaker and microphone aligned (when plotted as a function of frequency), the resonant features of the chamber were offset. This offset was related to the sound speed. When the results were transformed into a function of wavelength using the speed of sound (FIGS. 33A-33C, Eqn. 4.2), the resonant amplitude features would align, but the transfer function of the speaker and microphone would be offset. Therefore, the results shown previously for version 1 in FIGS. 33A-33C were determined to be spurious.

With this known, of all the combinations of parameters that were investigated using the version 2 device, shown in FIG. 34 the fruitful results came from tests that maintained a constant sound speed but varied the chemical composition between pre-determined mixtures. This meant that the resonant modes of the chamber, when plotted as a function of frequency, would remain at fixed frequencies even while the chemistry changed. By dividing the amplitude measured for one chemistry from another at a particular frequency, the relative attenuation between the chemistries could be determined. A substantial, measurable difference between the amplitudes at each frequency was searched for.

Three mixtures were created. The first consisted of pure oxygen. The second consisted of 0.787 molar fraction nitrogen and 0.213 molar fraction carbon dioxide. The third consisted of 0.324 molar fraction helium and 0.676 molar fraction carbon dioxide. A simple approach for creating gas mixtures was devised and produced in the following way:

1. A pressure vessel (McMaster-Carr 4167K51) fitted with a needle valve and push-to-connect fittings is purged using a vacuum pump.

2. Tubing leading to a pure gas source is purged before connecting to the push- to-connect fitting on the pressure vessel.

3. The pressure vessel needle valve is opened, and pure gas is introduced to the pressure vessel to a pre-determined partial pressure for a desired mixture.

4. Repeat 2 and 3 until all pre-specified mixtures have been added, making sure not to exceed the maximum pressure of the pressure vessel.

5. Let rest (to equilibrate both in composition and temperature).

Since the mixture created by this process was at a higher pressure than atmospheric pressure, the pressure differential between the vessel and the atmosphere naturally drove the flow of mixed gas into the device.

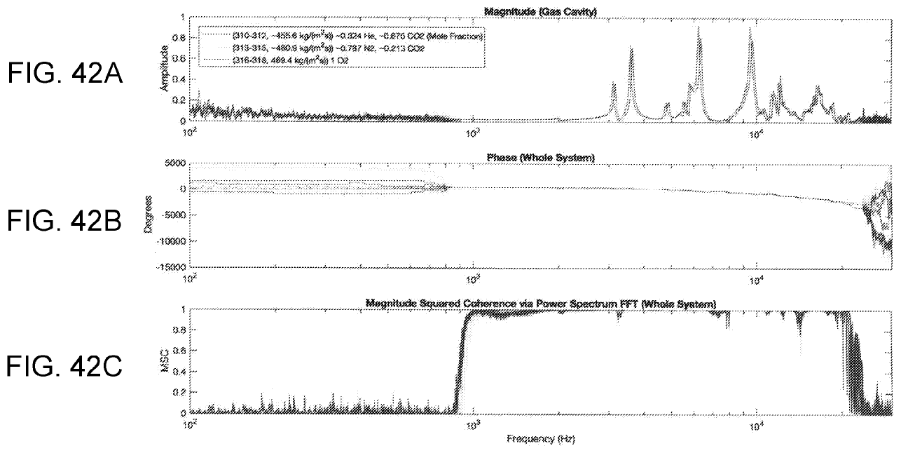

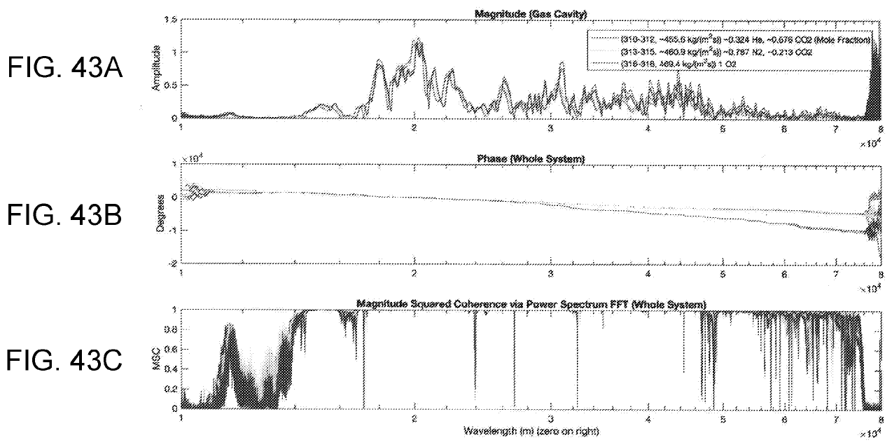

FIGS. 42A-42C show the low frequency response (measured using the CDS15118BL100 speaker by CUI Inc. and ICS40618 microphone by TDK InvenSense), with the relevant transfer function gain shown in FIG. 41 and FIG. 40 removed from the magnitude plots in FIGS. 42A-42C, but the phase and magnitude squared coherence plots for FIGS. 42A-42C is for the whole system given that FIG. 41 and FIG. 40 only report gain. FIGS. 43A-43C show the low frequency response (measured using the Batpure speaker by Take T and SPU0410LR5H microphone by Knowles whose gain is removed in the same way as the previous sentence describes). Neither the low frequency nor high frequency measurements indicate any attenuation on a by-frequency basis.

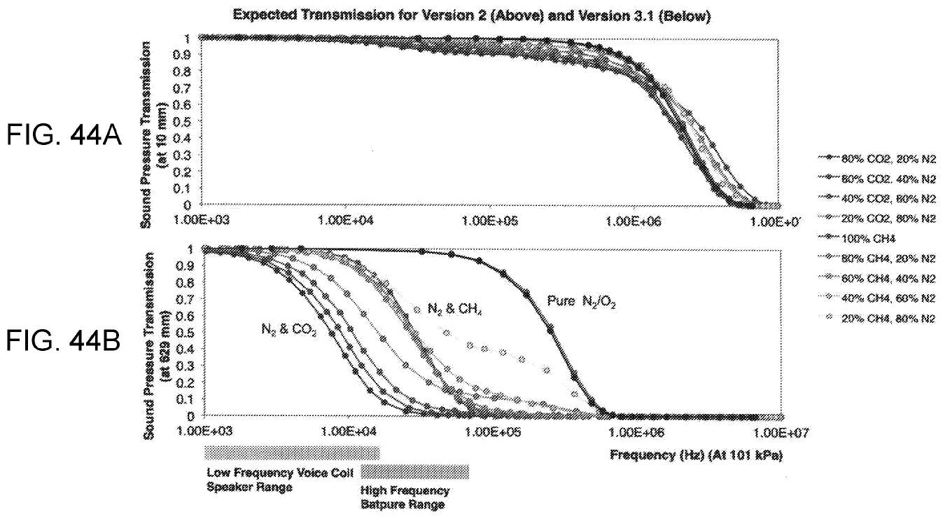

While differences were present between the attenuation coefficients between oxygen and mixtures containing carbon dioxide in the literature, the path length over which that attenuation can act is of equal importance. It was concluded, based on the results shown in FIGS. 42A-42C and FIGS. 43A-43C, that the effective path length must be quite short for attenuation effects to be minimal in the chamber. Expected transmission values, derived from the literature, are shown in FIGS. 44A-44B. For short transmission lengths, the differences in the transmission is minimal within the bandwidth of either actuator (and, for that matter, at any frequency). A longer transmission length makes the attenuation much stronger.

### Version 3.1 Design: Hardware and Software

Having learned that the effective transmission length in a resonant cavity is quite short, a new sensor was redesigned with an elongated chamber that had a long, fixed transmission length between the speaker actuator and the microphone sensor. The PCBs designed for version 2 were also reused.

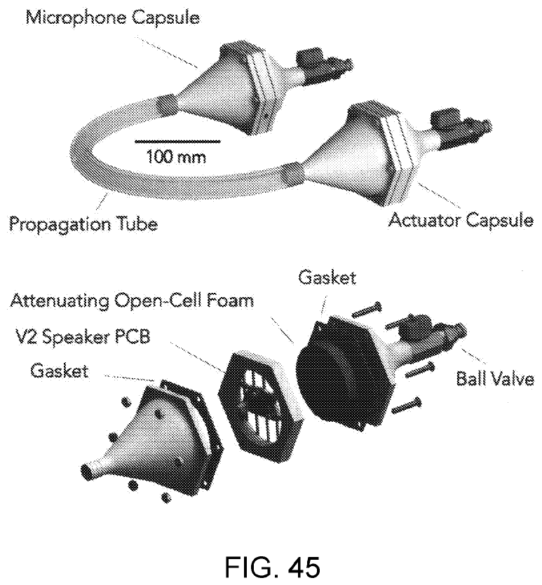

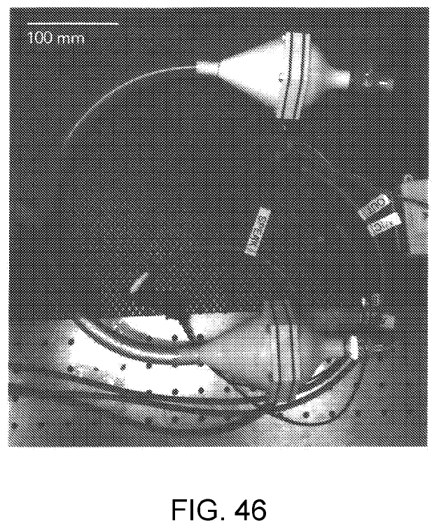

FIG. 45 shows an assembled and exploded illustrated view of version 3.1, and FIG. 46 shows the actual hardware. 3D printed capsules made from polylactide (PLA) were designed to interface with the PCBs. Care was taken to ensure that the center of the microphone and speaker were centered on the projected opening to the capsule. Ball valves allowed for the system to be purged and sealed, and laser cut rubber gaskets were added to seal the capsule from the environment. The stress cones on this design did not fully overlap the perimeter of the capsule. However, no pressurized testing (with respect to atmospheric pressure) was conducted with this design, so this seal only needed to keep the sample at atmospheric pressure separated from the environment. An open-cell foam piece was also cut with a laser cutter and mounted behind the speaker and microphone to reduce reflections. Electric feedthroughs were sealed with wax. Finally, the propagation tube internal diameter was 12.7 mm in diameter and the transmission length is 629 mm between the surface of the speaker and the surface of the microphone.

The same data acquisition system and experimental interface presented and described in version 2 was used for version 3.1

### Selected Measurement Results

After constructing this version, the same mixtures described in Selected Measurement Results of the version 2 design were introduced to the sensor. This was necessary because the speaker and microphone were still part of the dynamic system being analyzed. Had gases with different sound speeds been compared, spurious results like those shown in Selected Measurement Results of the version 1 design would have resulted.

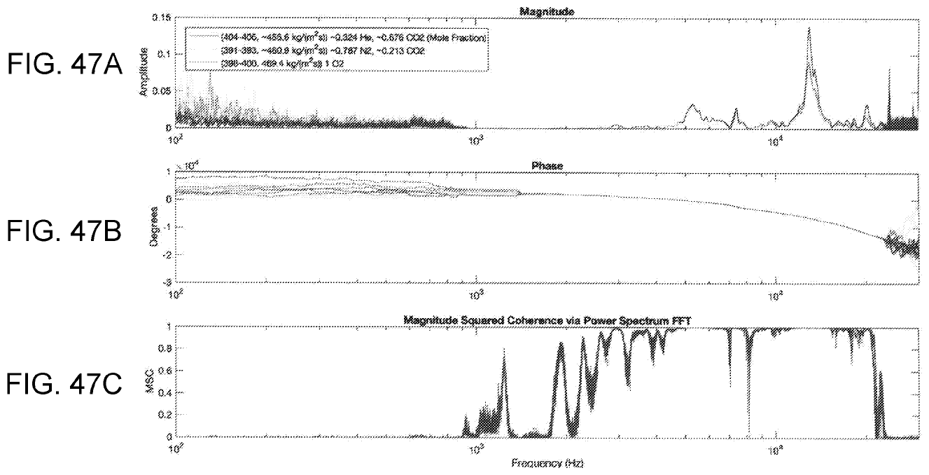

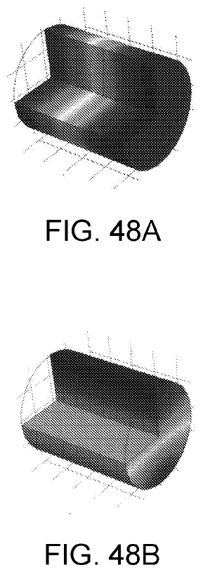

FIGS. 47A-47C show the low frequency response (measured using the CDS15118BL100 speaker by CUI Inc. and ICS40618 microphone by TDK InvenSense) shows attenuation on a by-frequency basis for carbon dioxide containing mixtures compared to pure oxygen. This was predicted in FIGS. 44A-44B using experimental results from the literature.

### Optimization

With attenuation observed, the design constraints and performance optimization opportunities for attenuation measurements needed to be understood prior to designing the next iteration of the device.

### Length

One can simplify a complex sensing optimization problem by analyzing two representative cases and looking for the set of configurations that maximize a difference between the cases. For the optimization problem at hand, the representative cases are two gas samples of interest. By taking Eqn. 3.70, the amplitude at some transmission length x amplitude was formulated as,

Pₘₐₓ(f, r, x)=P₀e^{-m}^{ₜₒₜₐₗ}^{(f,r)x}, (4.3)

where the pressure amplitude at frequency f, tube radius r, and transmission length x is defined as Pₘₐₓ(f, r, x), Po is the pressure amplitude at the source (x=0), and mₜₒₜₐₗ(f, r) is the sum of all attenuation components for a particular gas sample as defined in Eqn. 3.2, which is a function of frequency and radius. With this definition, Pₘₐₓ(f, r, x) for each representative case was computed and the difference as the optimization quantity that was being maximized was defined, this difference being formulated as,

ΔPₘₐₓ(f, r, x)=P₀(e^{<m}^{_{toal,1}}^{(f,r)x}−e^{-m}^{_{total,2}}^{(f,r)x}). (4.4)

The effect transmission length on this measured difference was next investigated. The optimal transmission length for a given frequency and radius is found at the global maximum of |ΔPₘₐₓ(f, r, x)|, which is found by taking the partial derivative of Eqn. 4.4 with respect to x and setting that equal to zero. This results in an optimal transmission length xₒₚₜᵢₘₐₗ of,

$${x}_{optimal} = \frac{ln ( {m}_{total , 1} ( f , r ) ) - ln ( {m}_{total , 2} ( f , r ) )}{{m}_{total , 1} ( f , r ) - {m}_{total , 2} ( f , r )} . \qquad ( 4.5 )$$

The first representative gas was dry air. The mixture of gases in Table 1 were used to represent dry air in simulations.

TABLE 1
Air components respective molar fractions.

| Constituent | Mole Fraction |
|---|---|
| Nitrogen | 7.808 148 8 [symbol] 10⁻¹ |
| Oxygen | 2.0947 [symbol] 10⁻¹ |
| Argon | 9.34 [symbol] 10⁻³ |
| Carbon Dioxide | 3.5 [symbol] 10⁻⁴ |
| Neon | 1.818 [symbol] 10⁻⁵ |
| Helium | 5.24 [symbol] 10⁻⁶ |
| Methane | 1.7 [symbol] 10⁻⁶ |

The following optimization results are between dry air, which serves as the first representative gas, and a second gas of interest.

Dry Air versus Helium Attenuation Results

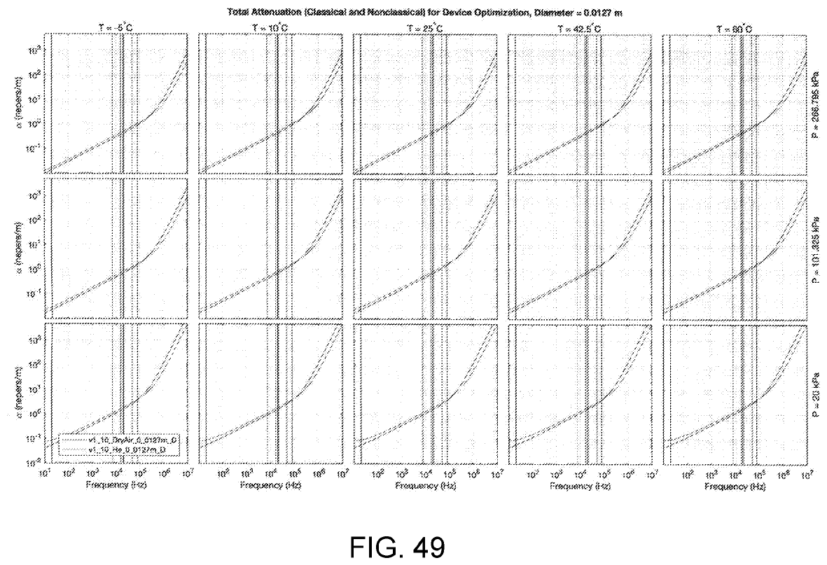

The first simulated comparison was between dry air (described in Table 1) and pure helium. FIG. 49 shows mₜₒₜₐₗ (labeled as α on the y-axis) for each gas as a function of frequency for a variety of pressures and temperatures. The expected frequency at which the first transverse sloshing mode may occur in a circular cross-section tube was plotted, which ranges from 1.64r>, λ>3.67 r as reported by the literature, where r is the radius, λ is the wavelength, and the frequency of the mode can be determined using the relationship in Eqn. 4.2. A representation of the pressure gradient for a well-behaved plane wave propagating in a circular cross-section tube is shown in FIG. 44A, whereas the first transverse sloshing mode pressure gradient would look like FIG. 44B.

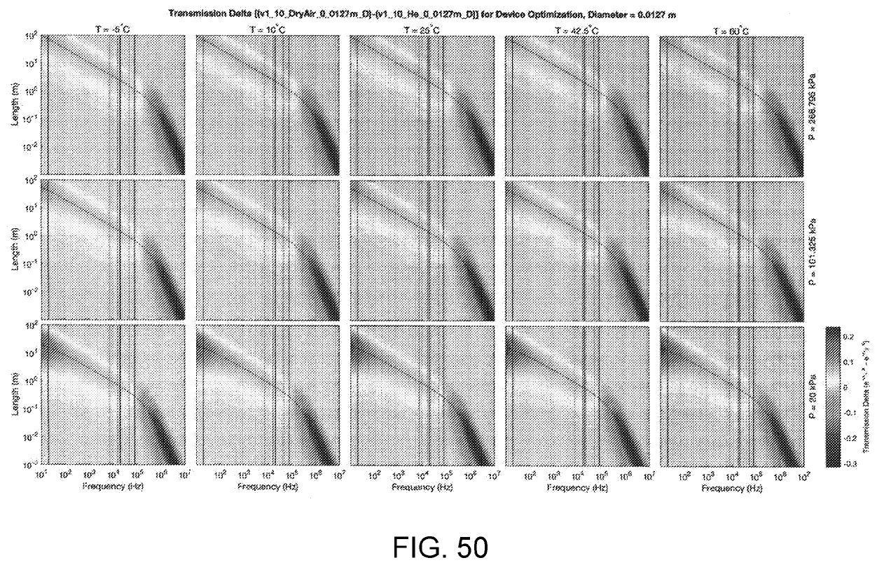

While the difference between the mₜₒₜₐₗ between these gases is small for all frequencies shown, FIG. 50 shows the expected ΔPₘₐₓ/P₀, which exceeds 30% difference in amplitude at some frequencies. This difference is driven by classical effects. Confined effects are evident for the lower frequencies (shallow slope) and free-field effects are evident at higher frequencies (steep slope). For room temperature (25° C.) and atmospheric pressure (101.325 kPa), simulations results for a transmission length of 1 m indicated that a measurable attenuation difference between dry air and helium could be expected within the acoustic range audible to humans.

Dry Air versus Carbon Dioxide Attenuation Results

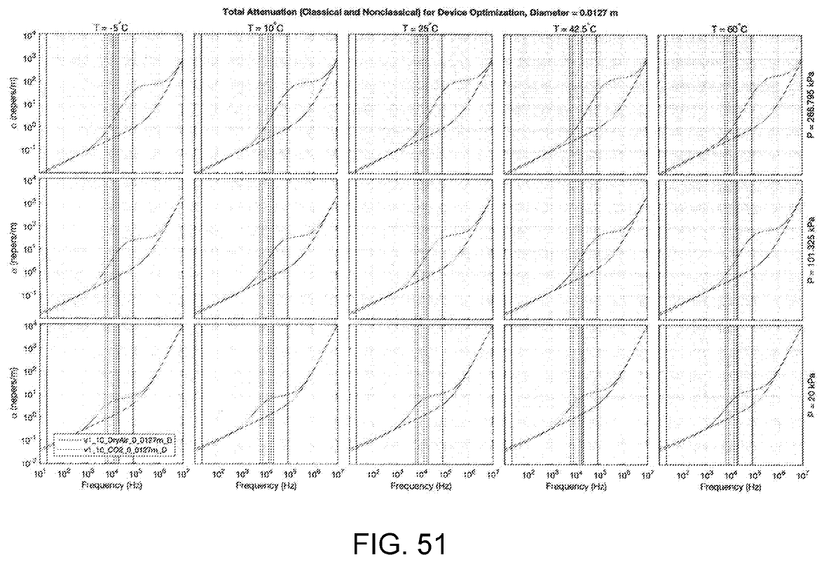

The second simulated comparison was between dry air (described in Table 1) and pure carbon dioxide. FIG. 51 shows mₜₒₜₐₗ (labeled as α on the y-axis) for each gas as a function of frequency for a variety of pressures and temperatures. As described previously, green and red lines indicating which frequencies could excite transverse modes are shown.

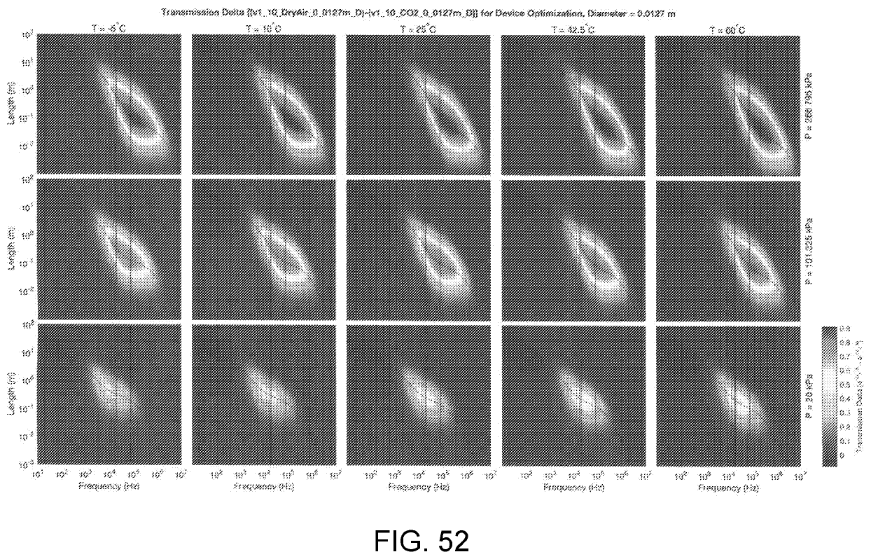

Very strong nonclassical attenuation is present in the carbon dioxide simulation between 10 kHz to 1 MHz, which pulls that attenuation curve several orders of magnitude above the dry air attenuation curve. Consequently, FIG. 52 shows the expected ΔPₘₐₓ/P₀, which approaches 90% difference in amplitude at some frequencies. This difference is driven by nonclassical effects in the carbon dioxide sample. For room temperature (25° C.) and atmospheric pressure (101.325 kPa), simulations results for a transmission length of 1 m indicated that a measurable (and in this case, extremely strong) attenuation difference between dry air and carbon dioxide could be expected within the acoustic range audible to humans.

Dry Air versus Sulfur Hexafluoride Attenuation Results

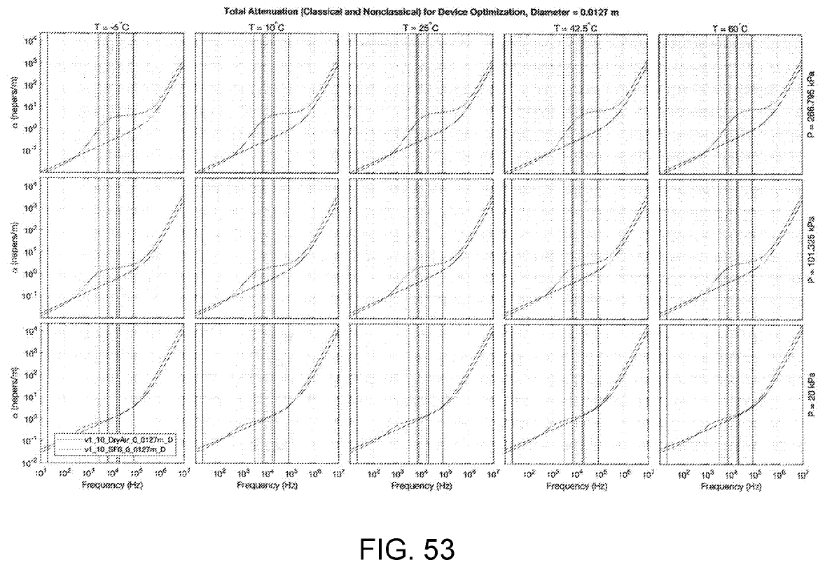

The third simulated comparison was between dry air (described in Table 1) and pure sulfur hexafluoride. FIG. 53 shows mₜₒₜₐₗ (labeled as α on the y-axis) for each gas as a function of frequency for a variety of pressures and temperatures. As described previously, green and red lines indicating which frequencies could excite transverse modes are shown.

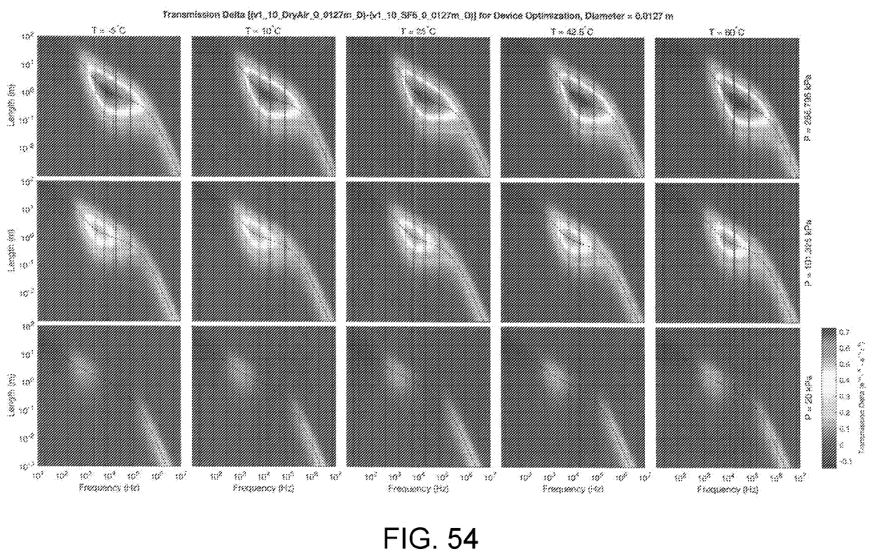

Strong nonclassical attenuation is also expected in the sulfur hexafluoride simulation between 1 kHz to 100 kHz, which pulls that attenuation curve a few orders of magnitude above the dry air attenuation curve. Consequently, FIG. 54 shows the expected ΔPₘₐₓ/P₀, which approaches 70% difference in amplitude at some frequencies. This difference is again driven by nonclassical effects in the carbon dioxide sample. For room temperature (25° C.) and atmospheric pressure (101.325 kPa), simulations results for a transmission length of 1 m indicated that a measurable (and in this case, moderately strong) attenuation difference between dry air and sulfur hexafluoride could be expected within the acoustic range audible to humans.

### Diameter

Another parameter that needed to be optimized was the tube diameter. As one can see from inspecting the models presented herein, classical attenuation generally increases with decreasing radius, whereas nonclassical attenuation, as modeled, is not affected by tube radius. Therefore, it would be possible for gases contained in small tubes to be completely dominated by classical attenuation, even if nonclassical effects were present.

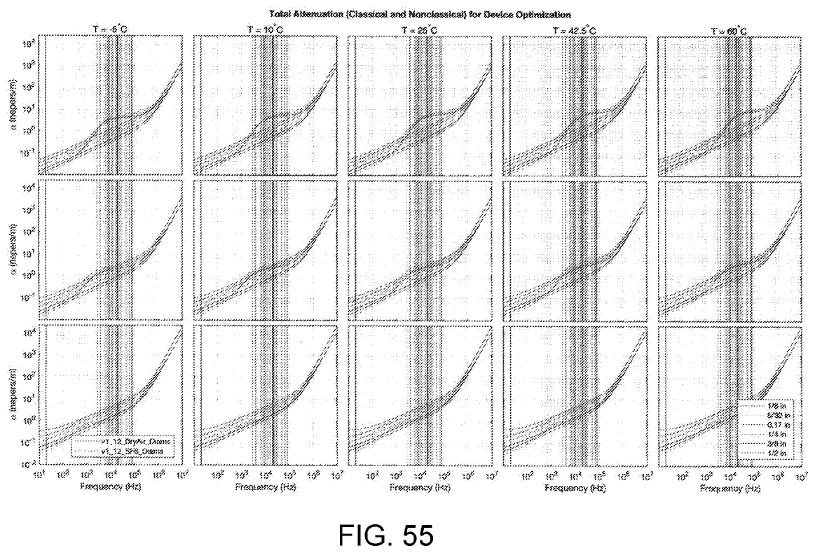

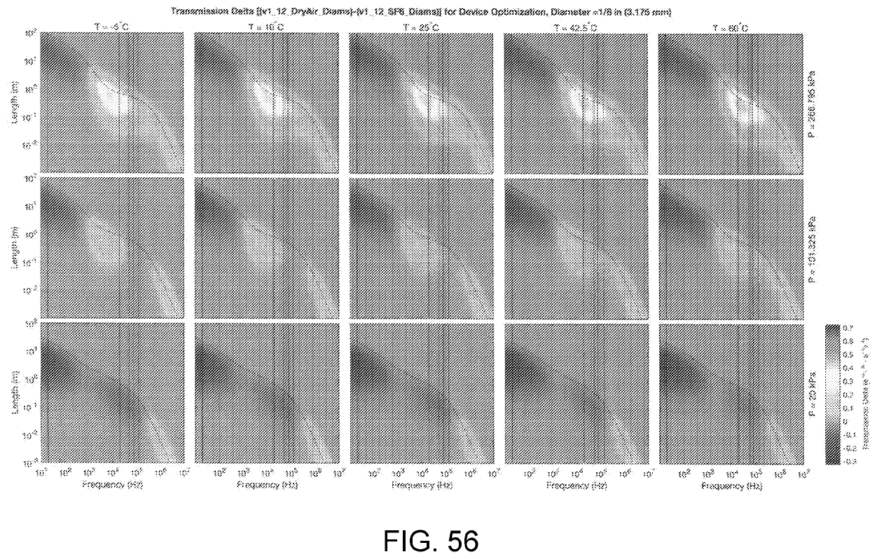

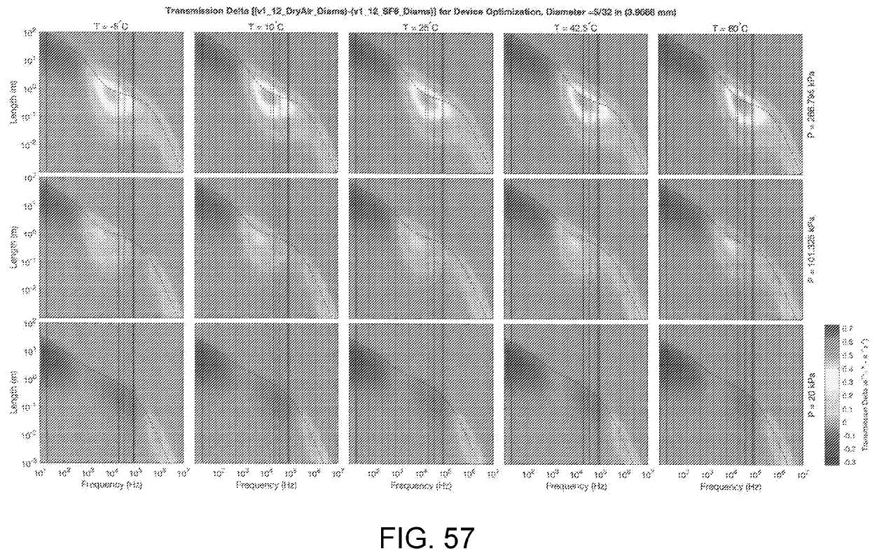

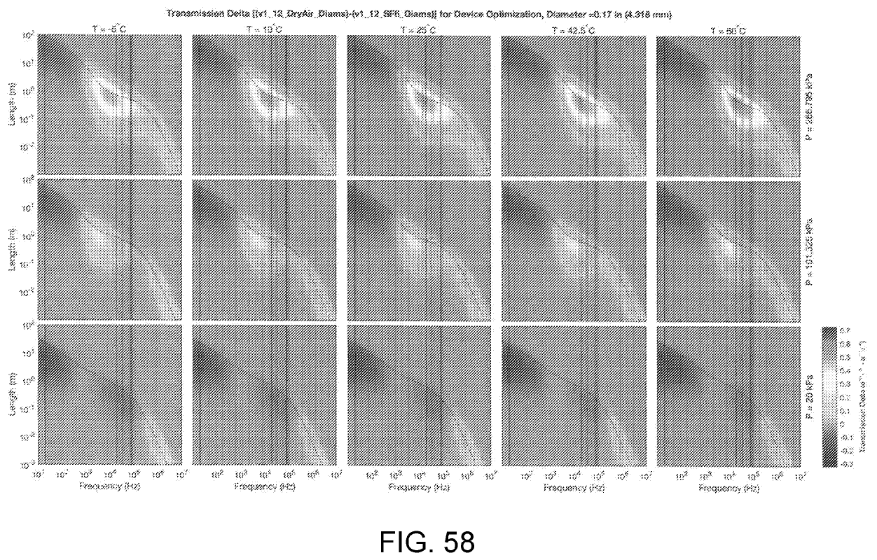

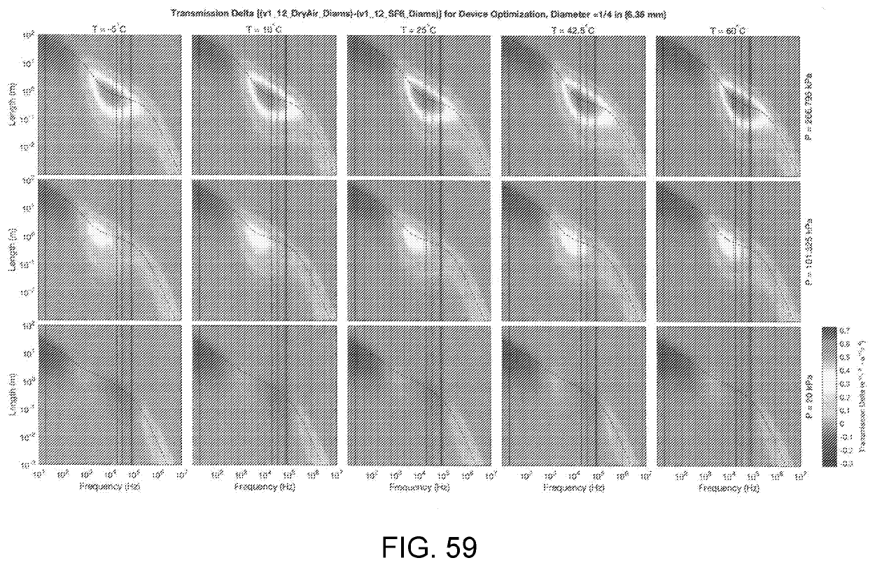

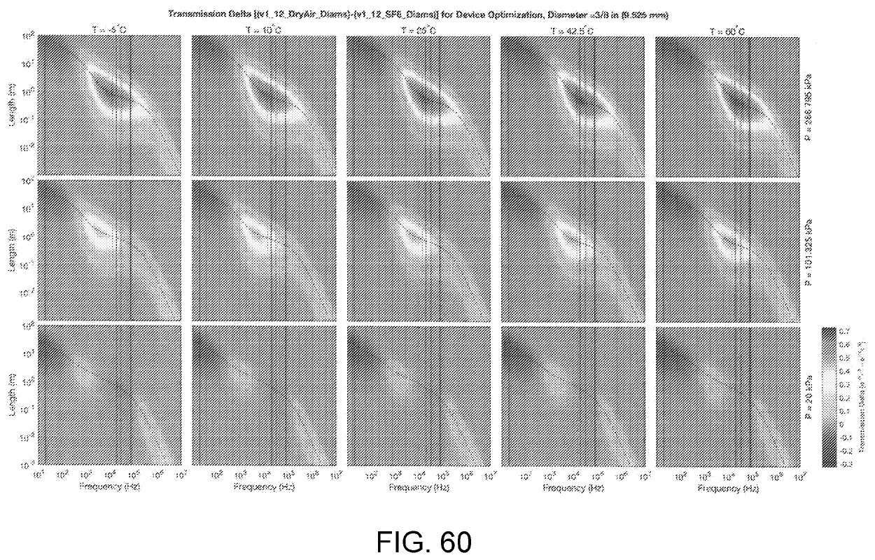

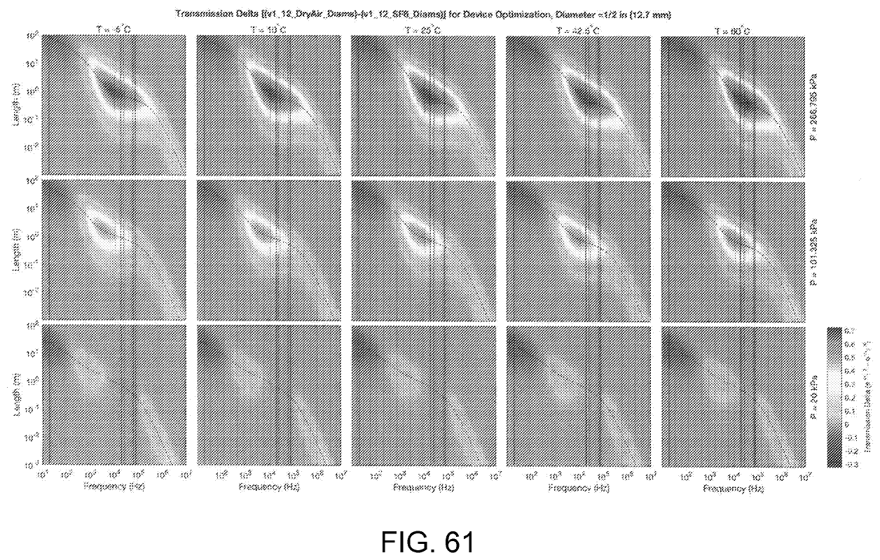

To determine how the classical and nonclassical terms compared, simulations were run on sulfur hexafluoride for a variety of commercially available internal tube diameters. FIG. 55 shows the simulated total attenuation for a variety of tube diameters which are color coded. Results for different diameters containing both dry air attenuation (plotted as a solid line) and sulfur hexafluoride attenuation (plotted as a dashed line) are shown. Nonclassical attenuation is, as expected, obscured by the classical attenuation in smaller diameter tubes more so than in larger diameter tubes.

### Curvature

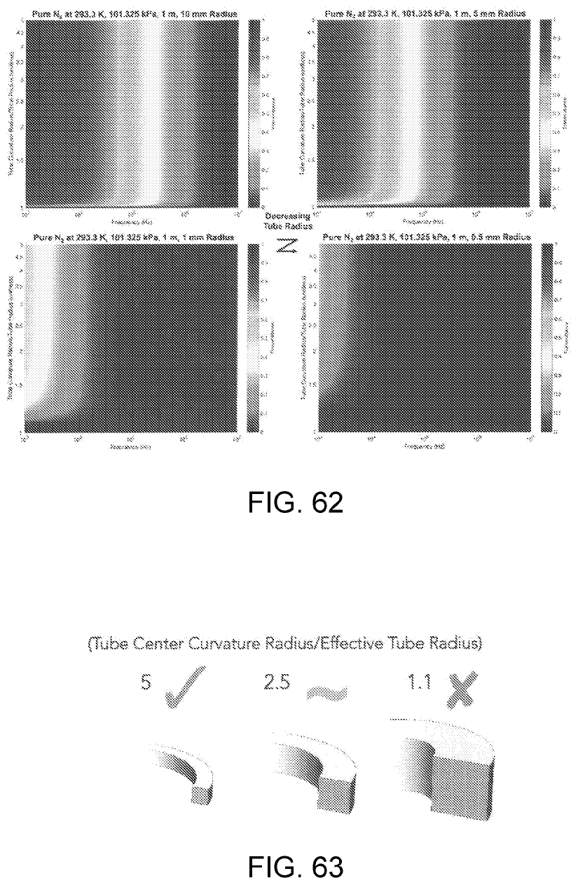

As discussed previously in the Curvature Effect, attenuation due to tube curvature can be orders of magnitudes larger than bulk losses in straight ducts. In simulations of pure nitrogen at 293.3K and 101.325 kPa, the transmittance for different frequencies was investigated and tube curvatures where the tube curvature were characterized as the tube center radius of curvature divided by the effective tube radius (which has no units). FIG. 62 shows the results of these simulations for four different effective tube radii. For tube curvatures of 5 (or greater), theoretical values for attenuation due to tube curvature were negligible compared to theoretical attenuation from straight tubes. For curvatures around 2.5, theoretical values for attenuation due to tube curvature did begin to increase attenuation beyond what was predicted by the straight tube analysis (for small diameter tubes). Finally, curvatures near 1.1 or smaller led to theoretical attenuation from curvature was overwhelming. For reference, CAD models of tubes with square cross section that have curvatures of 5, 2.5 and 1.1 are shown in FIG. 63.

### Version 3.2 Design

With acoustic attenuation measured using the version 3.1 device and optimization information in-hand, efforts were focused on designing a device that could compare gases with different sound speeds.

### Eliminating Speaker and Microphone Dynamics

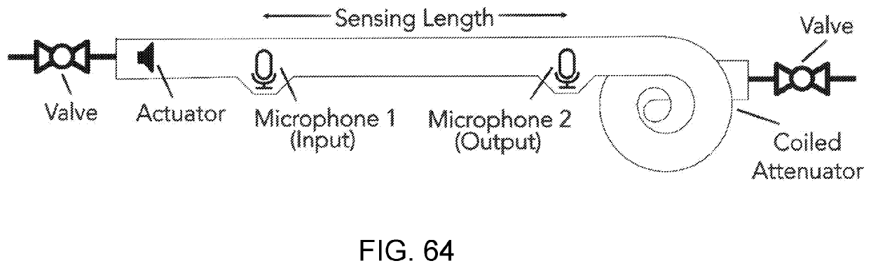

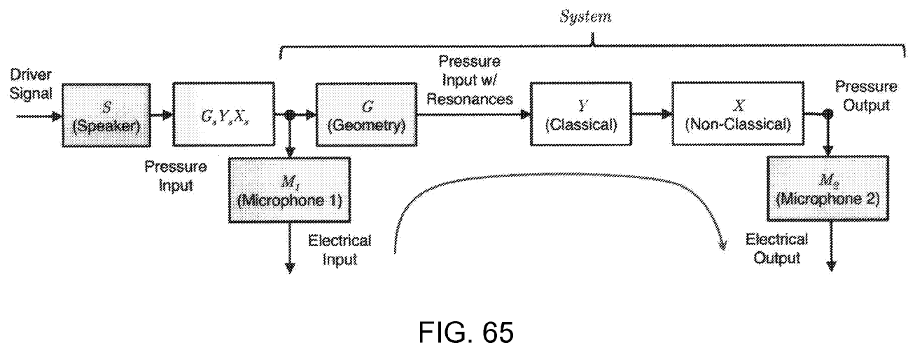

It was determined that the addition of an upstream microphone would allow for the removal of the speaker and microphone transfer functions. FIG. 64 shows a schematic and FIG. 65 sketches out the block diagram.

Previously for versions 1 through 3.1, the system comprised of SGY XM, where these terms represented the dynamics of the speaker, geometry, classical attenuation, nonclassical attenuation, and microphone respectively. This was because the input to the system was the input to the speaker and the output from the system was the measured signal from the downstream microphone.

By taking the input (in the redesigned system) as the measurement from the upstream microphone and the output of the system as the measurement from the downstream microphone, the system in version 3.2 comprised of

$$\frac{{GYXM}_{downstream}}{{M}_{upstream}}$$

where

Mᵤₚₛₜᵣₑₐₘ and M_{downstream} represented the dynamics of the upstream and downstream microphone, respectively. It was assumed that the upstream and downstream microphone dynamics were identical as the microphones were of high quality and mass produced. With this assumption, the upstream and downstream microphone dynamics would cancel leaving just GY X as the system under test. Additionally, following in the direction established by version 3.1, a longer path length was implemented.

### Hardware and Software

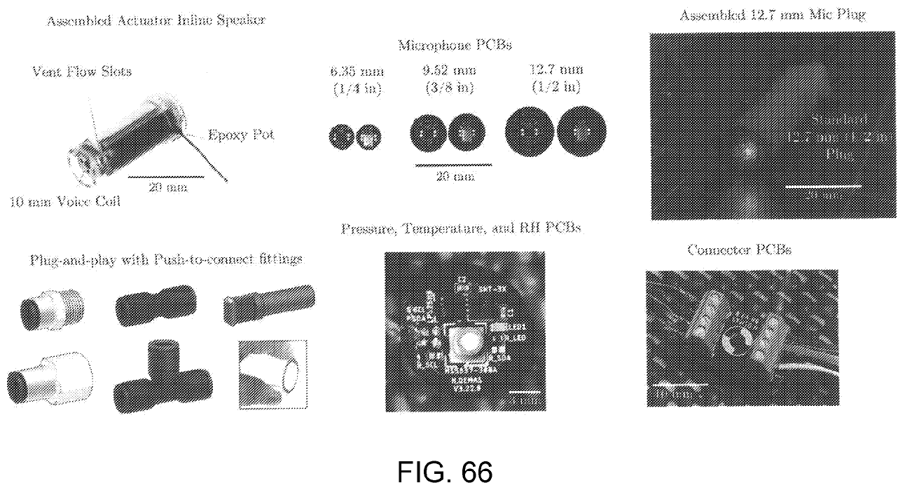

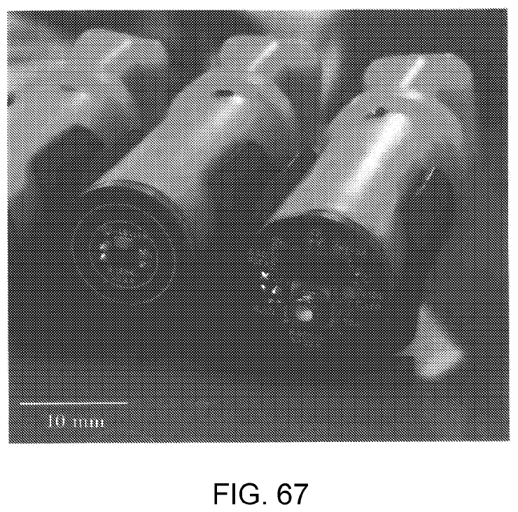

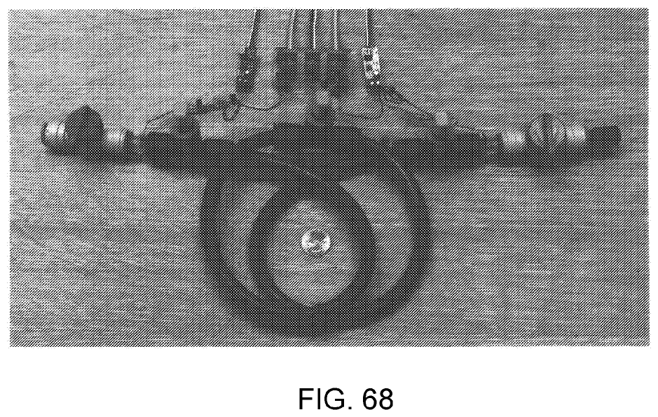

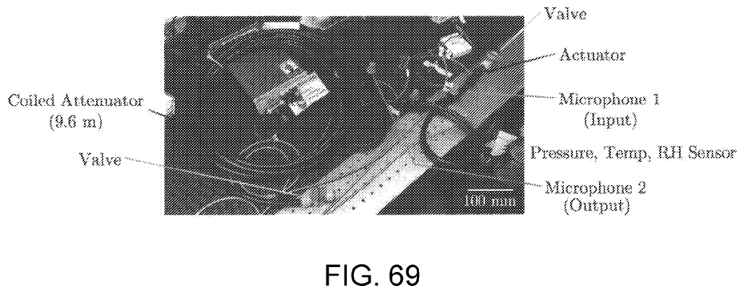

For version 3.2, as many commercially available components as possible were used to decrease development time, improve reliability, and reduce cost. It also made the system reconfigurable. FIG. 66 shows the hardware components for version 3.2. FIG. 67 shows a detail of the custom sensors. FIG. 68 shows an assembled version of the sensor, and FIG. 69 shows another. The latter was used for experimental measurements.

Showing the functionality of the sensor for the three optimization cases, namely, to distinguish between carbon dioxide, helium, sulfur hexafluoride, and dry air (or nitrogen) was of interest. Therefore, as mentioned previously, 1 m was chosen as the transmission length. A coiled attenuator (which was additional tubing length with a push-to-connect ball valve at the end) was added to the far end to minimize reflections.

Data acquisition was performed using an upgraded version of the custom Lab-VIEW VI shown in FIG. 38. Analysis was conducted in MATLAB.

### Pure Delays and a Linear Phase Fitting Method for Sound Speed Estimation

To be able to remove the dynamics of the cavity G, the sound speed (which controls the frequency at which the supported modes of the chamber will resonate at) needed to be experimentally measured. A method which measured conduction velocity of action muscle potentials was used. These methods are applicable to acoustic sensing. While these methods did not work in versions 1 to 3.1 (likely due to the presence of the dynamics of the microphone and speaker in the measurement, in addition to other effects from the resonant cavity's multiple reflected path lengths), the high aspect ratio cavity of version 3.2 proved functional.

For a system that is a pure delay, the phase if Φ(f) is linearly related to frequency such that,

Φ(f)=af+b (4.6)

where a is the slope and b is the y-intercept. It was assumed that the acoustic propagation can be well modeled as a pure delay. A line can be fit to experimental data, using least squares as the cost function and the magnitude squared coherence as the weighting function (see System Identification). Once fit, if ψ(f) is in degrees and f is in Hz, the delay D in seconds is given by,

$$D = \frac{a}{360} . \qquad ( 4.7 )$$

Given knowledge of the transmission distance, this delay can be converted into sound speed (by dividing the transmission distance by the delay).

Pure Delay Measurements using Version 2

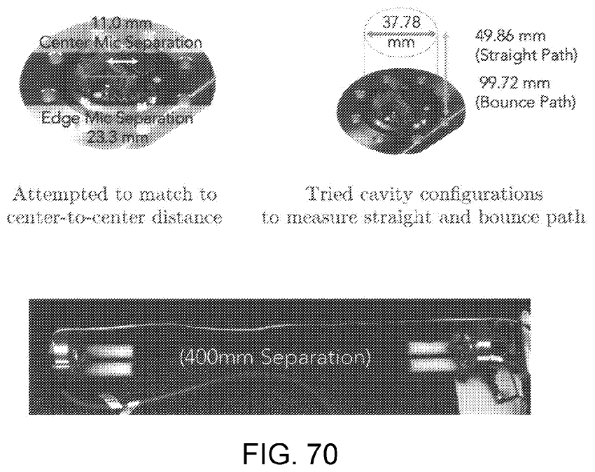

Various configurations with version 2 hardware were tested, are shown in FIG. 70. Unfortunately, none of these preliminary configurations provided reliable measures using the phase fitting technique.

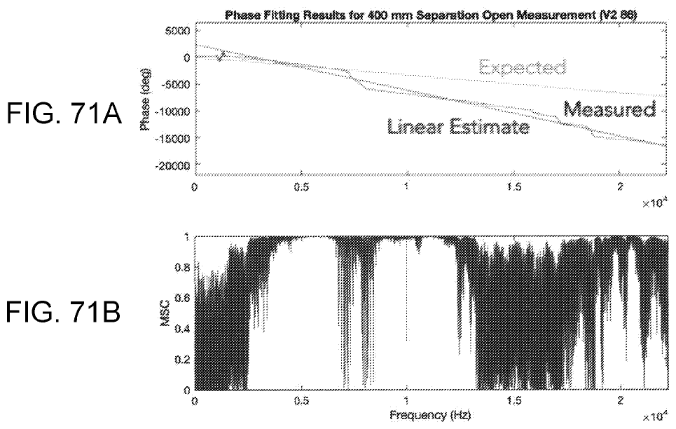

The poor estimates were likely due to the lack of linearity in the unwrapped phase results. FIGS. 71A-71B shows the resulting phase and magnitude squared coherence plots (estimated using the system identification techniques presented in System Identification).

In these preliminary setups, the input was the electrical input to the speaker and the output was the measurement from the microphone (see FIG. 31 for a schematic). This meant that the transfer function of the microphone and speaker (the gain for each is presented in FIG. 40 and FIG. 41, respectively) were part of the dynamic system being characterized.

While the phase for the microphones and speakers are not reported, it is safe to assume that the phase is not zero for all frequencies. This alone would nullify the presumption that the system is a pure delay. Additional issues arising from geometric considerations (G in FIG. 31, which could, for example, arise from multiple path lengths due to acoustic reflections) push the dynamics further away from a pure delay.

Pure Delay Measurements using Version 3.2

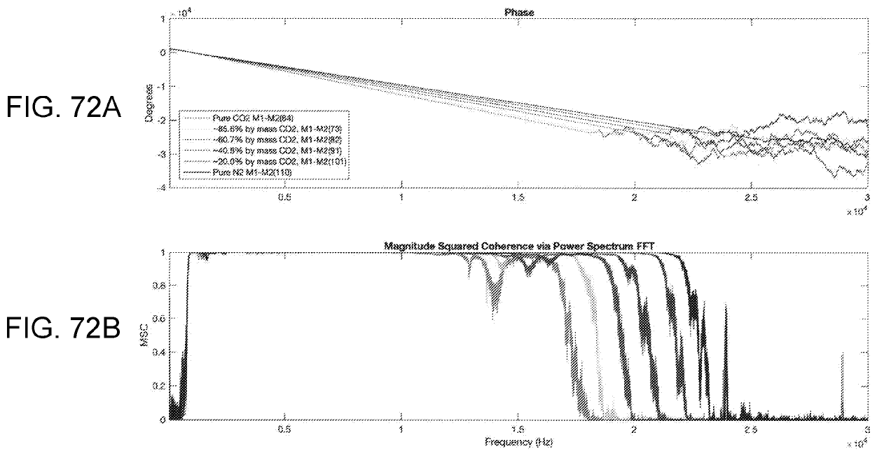

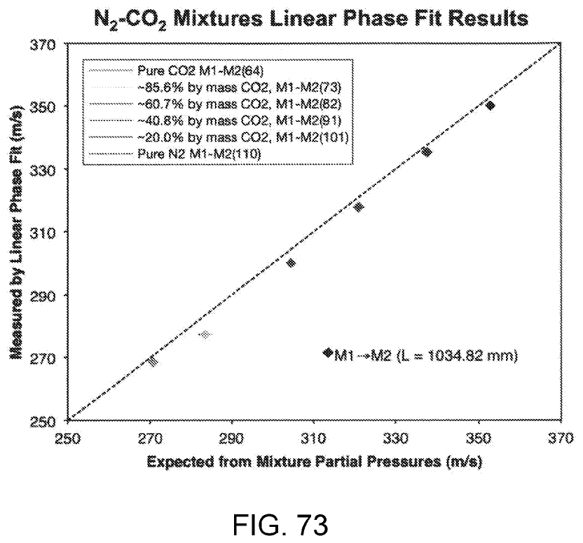

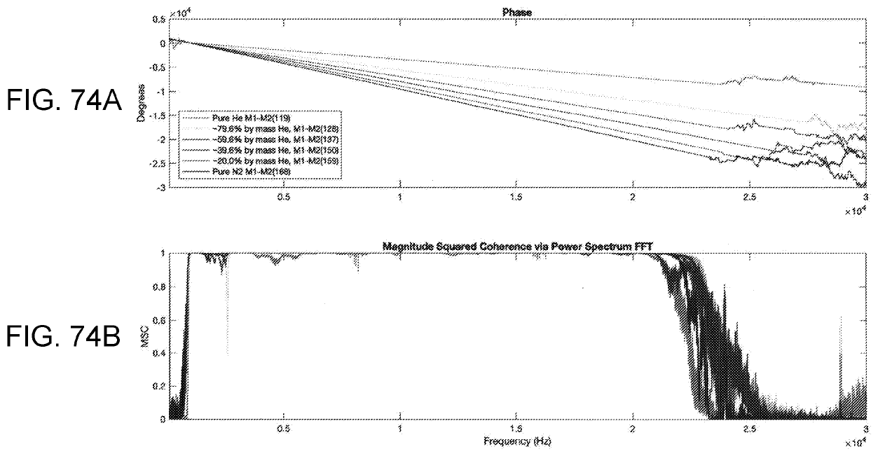

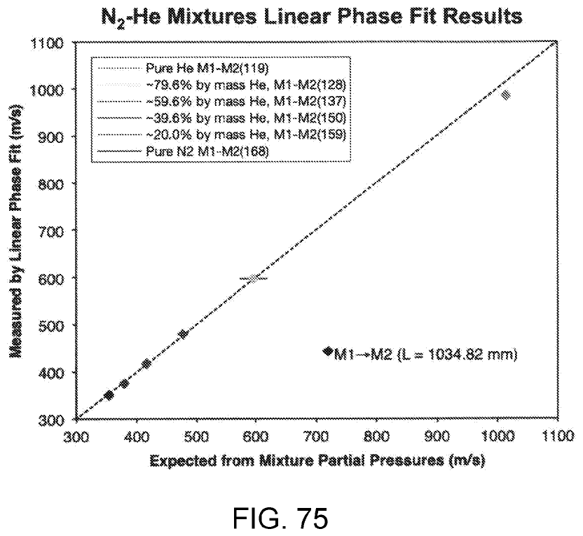

By removing the speaker and the microphone dynamics from the measured system, in addition to changing to a high chamber aspect ratio (producing a longer transmission length), the sound speed estimates derived using the linear phase fit method were greatly improved, as shown in FIG. 73 and FIG. 75. The measurements from which these estimates were derived are shown in FIGS. 72A-72B and FIGS. 74A-74B. Mixtures were created using the method described in Selected Measurement Results Version 2 Design.

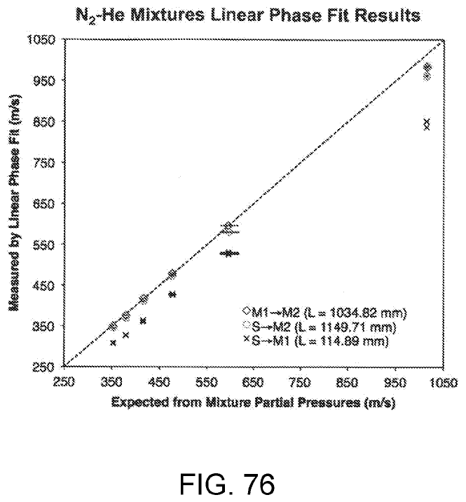

Furthermore, since the version 3.2 device includes two microphones and one speaker, the sound speed estimate with the linear phase fit approach for the inter-microphone system identification results could also be calculated (presented in FIG. 73 and FIG. 75) in addition to the dynamic system measurement between the speaker and the upstream microphone (mic 1) and between the speaker and the downstream micro-phone (mic 2). As shown in FIG. 76, the inter-microphone sound speed estimates derived by the linear phase fit showed the smallest errors of these three possible configurations.

A Second Method for Sound Speed Estimation using Numerical Derivatives

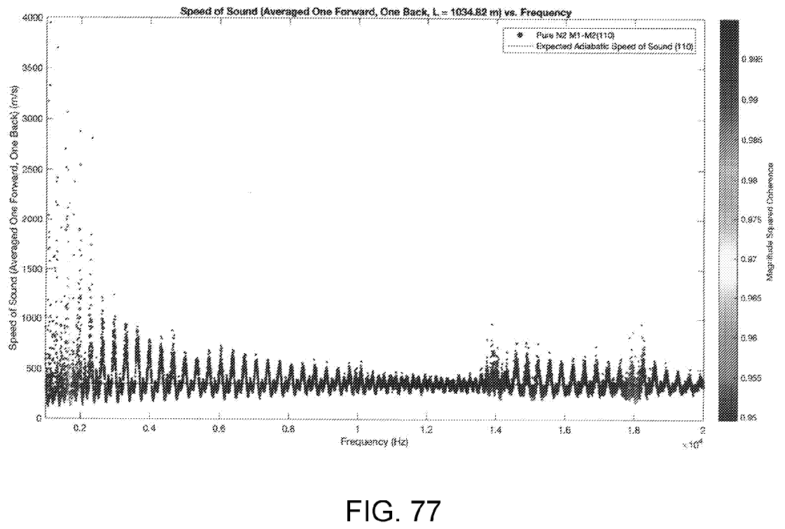

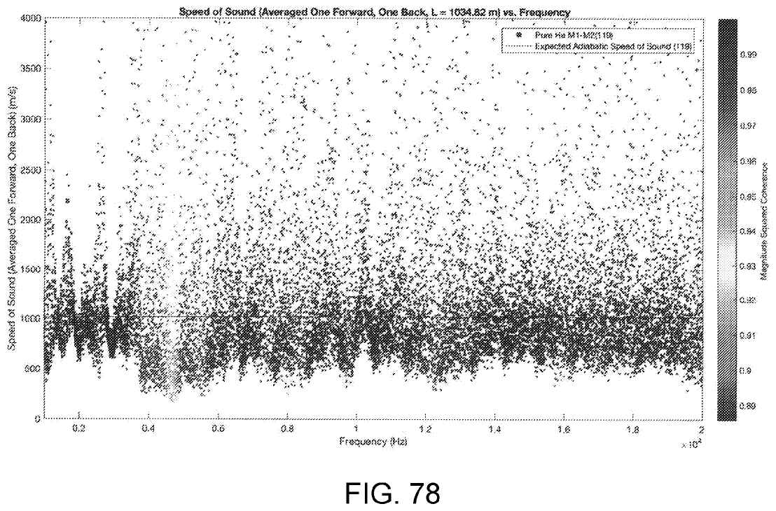

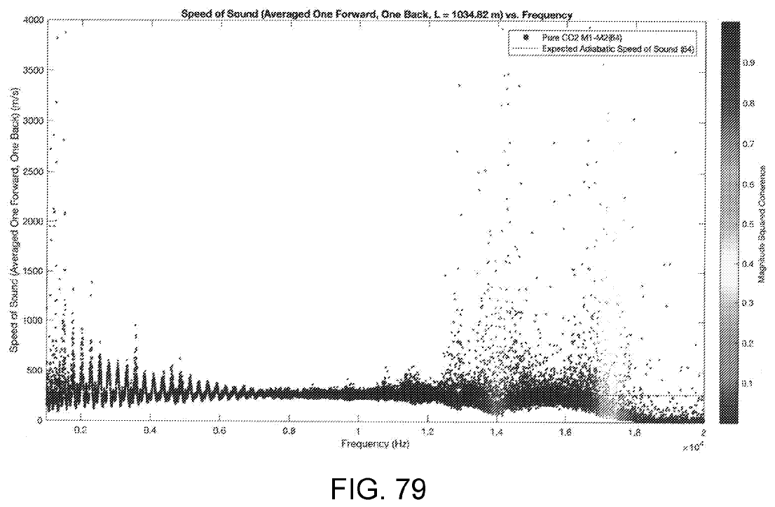

Another method for determining the sound speed involved taking the numerical derivative. The algorithm averaged the forward and backward derivative to the n+1 and n−1 neighbor. This will be referred to as the one-forward-one-back (1f1b) method moving forward. These averaged derivatives were then manipulated following the approach detailed herein under Pure Delays and a Linear Phase Fitting Method for Sound Speed Estimation to produce a sound speed estimate at each point. The results for nitrogen, helium, and carbon dioxide are shown in FIGS. 77-79 for which the test ID parameters are listed in Table 4 and Table 3.

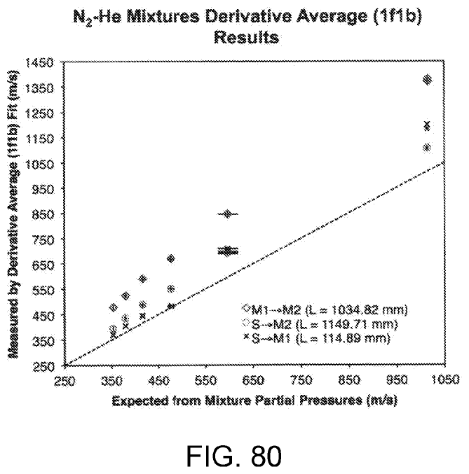

The sound speed estimate using the 1f1b method was produced by averaging the sound speed estimates within the region of perturbation (1 kHz to 20 kHz), using the magnitude squared coherence as the weights. The results of this method, as compared to the adiabatic estimate for sound speed calculated using Eqn. 2.14 with the values listed in Table 4 and Table 3, are presented in FIG. 80. Note that, in addition to the measurements taken between upstream microphone and downstream microphone (M1 and M2), results between the speaker S and each of the microphones is included. Note that estimates produced by the 1f1b method are not as accurate nor precise as the estimates produced using the linear phase fit method described herein under Pure Delays and a Linear Phase Fitting Method for Sound Speed Estimation.

### Experimental Results

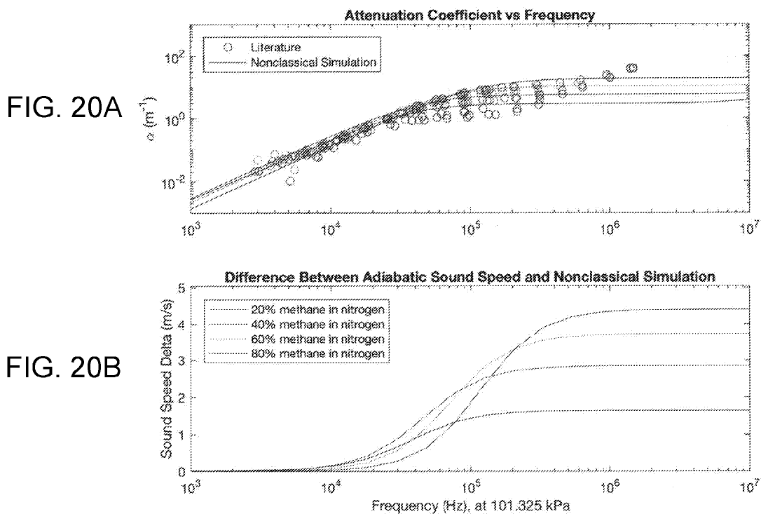

Having finalized the version 3.2 hardware and software, the device to measure acoustic attenuation in various gas samples was addressed next. This section details experimental results for nitrogen, carbon dioxide, helium, and sulfur hexafluoride. The classical and nonclassical modeling package presented herein does a very good job at predicting the behavior for various mixtures of nitrogen, carbon dioxide, and helium. The model over-predicts the measured attenuation in sulfur hexafluoride. Additionally, predictions about the expected attenuation for different mixtures of methane and nitrogen are made. While the mixing approach detailed in Selected Measurement Results Version 2 Design was not capable of safely handling pressurized methane, the behavior could be simulated with the modeling package. These results compared well to the expected nonclassical simulated attenuation (see FIGS. 19A-19B and FIGS. 20A-20B).

### Simulations and Experimental Results for Carbon Dioxide and Nitrogen Mixtures

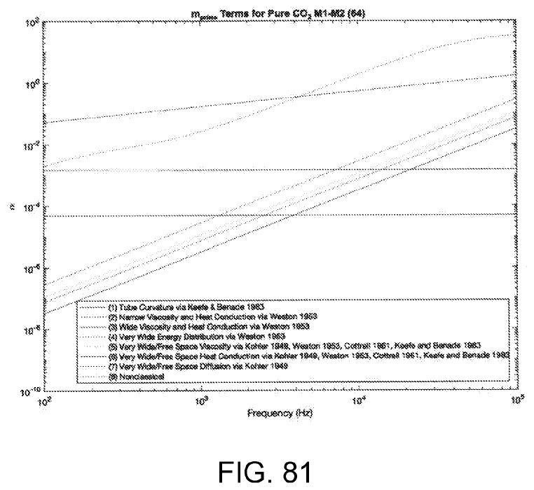

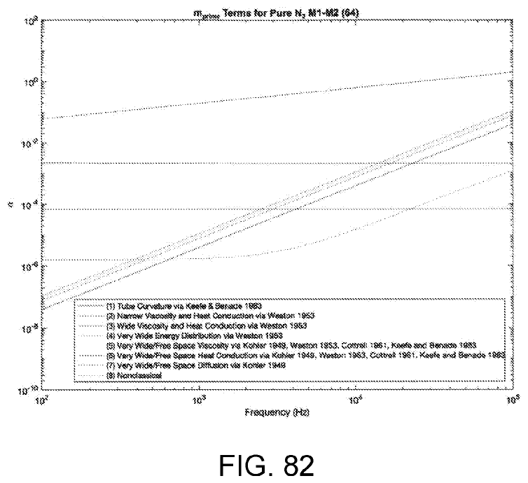

Table 2 shows the experimental conditions for several different mixture of carbon dioxide and nitrogen (with trace amounts of water). Using tabulated parameters and the simulation package described herein, all relevant attenuation terms for test ID 64 and 110 were calculated. These results are shown in FIGS. 81-82. While both gas mixtures are made up exclusively of polyatomic gases, note how prominent the nonclassical attenuation is for the carbon dioxide (test ID 64). Note that this behavior arises in carbon dioxide from complex interactions between molecules, the concentration of particular species and their vibration modes, and the equilibrium pressure and temperature. In other words, it is difficult to attribute the presence of nonclassical attenuation to any one parameter.

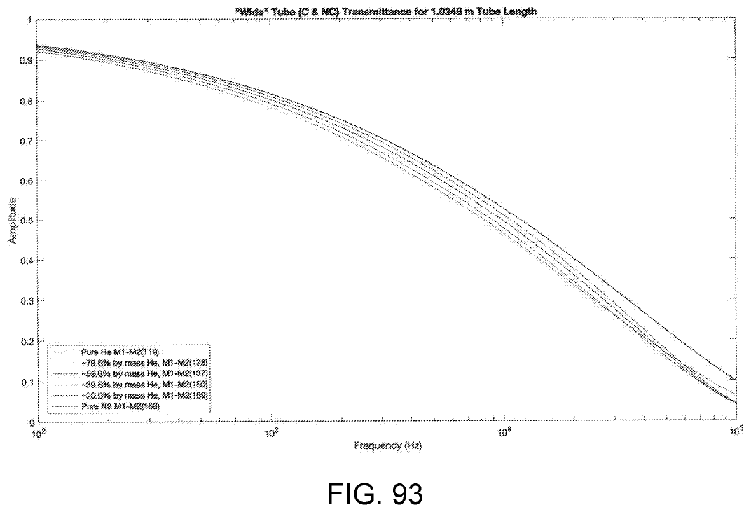

The transmittances (which arise from the total attenuation) given the design of version 3.2 for each of these samples were simulated and are shown in FIG. 93.

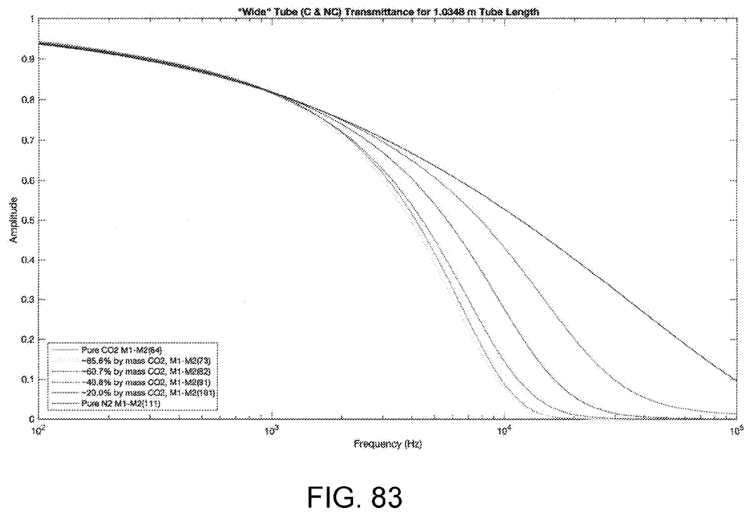

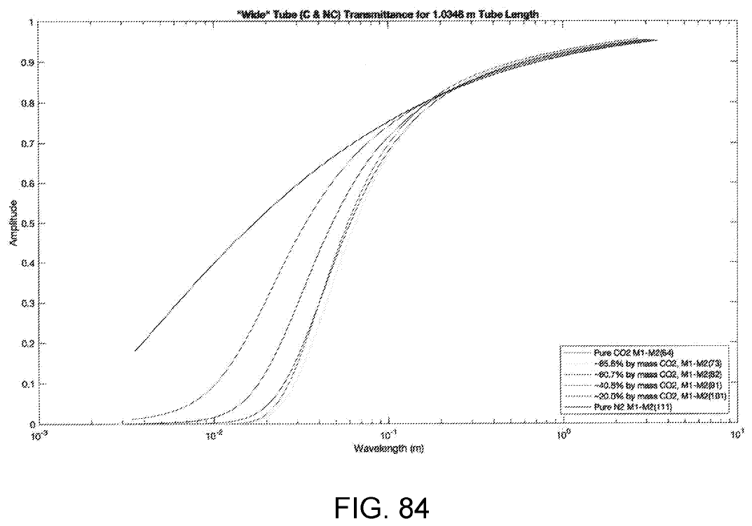

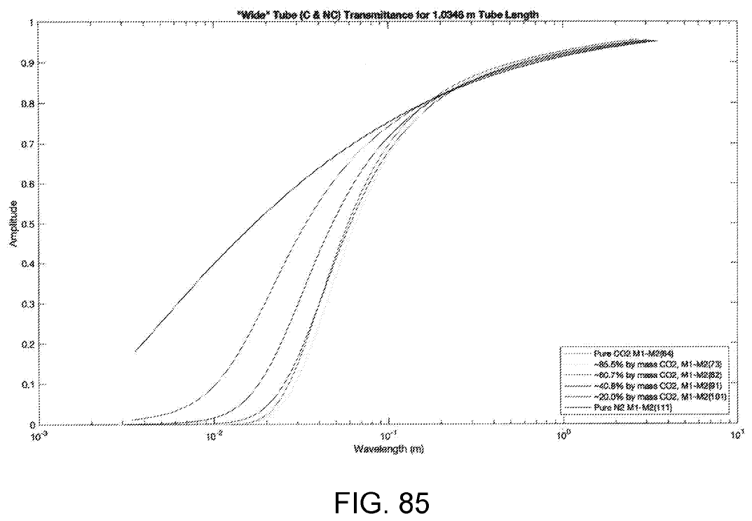

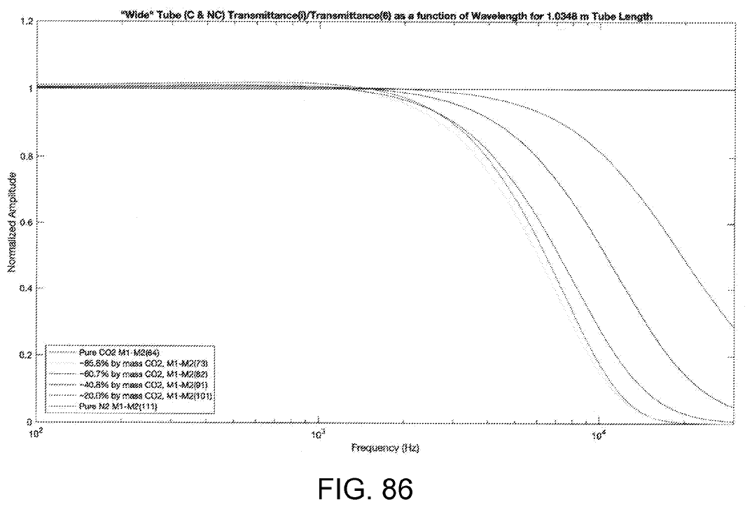

Furthermore, the transmittances (which are affected by the total attenuation) given the design of version 3.2 can be modeled for each of these samples. These results are shown in FIG. 83. These transmittances were then plotted as a function if wavelength and normalized (with respect to the nitrogen simulated standard, test ID 110) (FIG. 84 and FIG. 85). The result of this normalization, when replotted as a function of frequency is shown in FIG. 86.

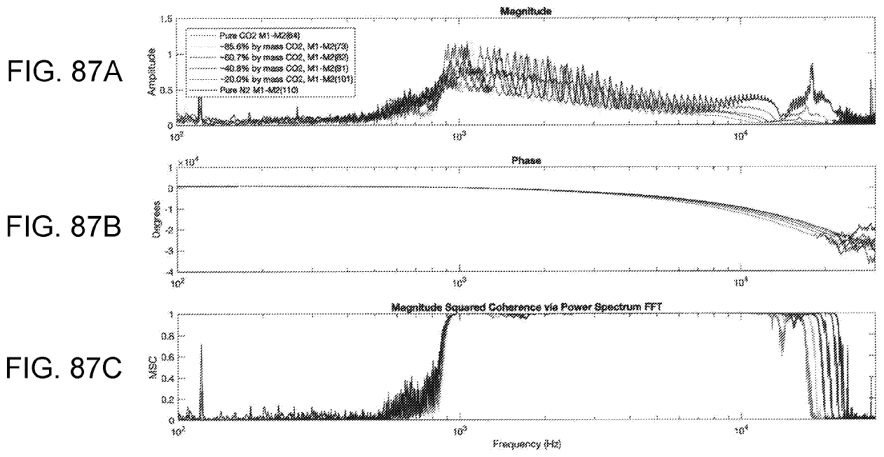

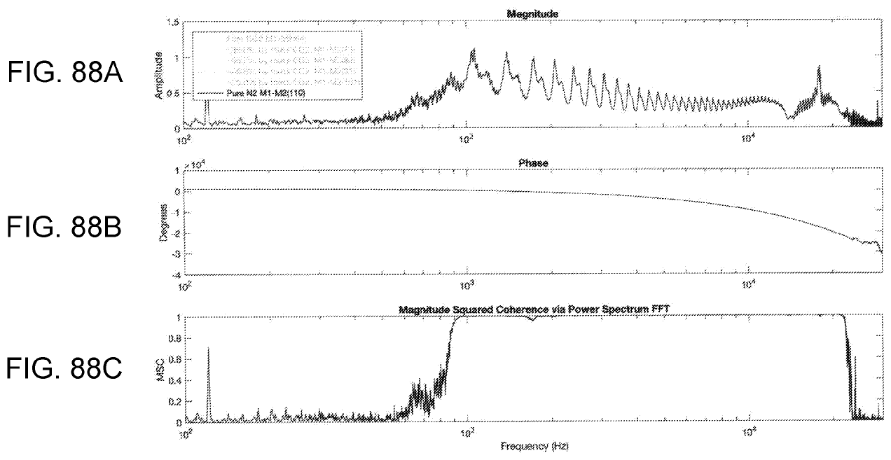

The gas mixtures listed in Table 2 were then realized in version 3.2 and probed using the system identification methods described herein. The raw results are shown in FIGS. 87A-87C. The amplitude response for the standard gas will be used to normalize against is shown in FIGS. 88A-88C (test ID 110).

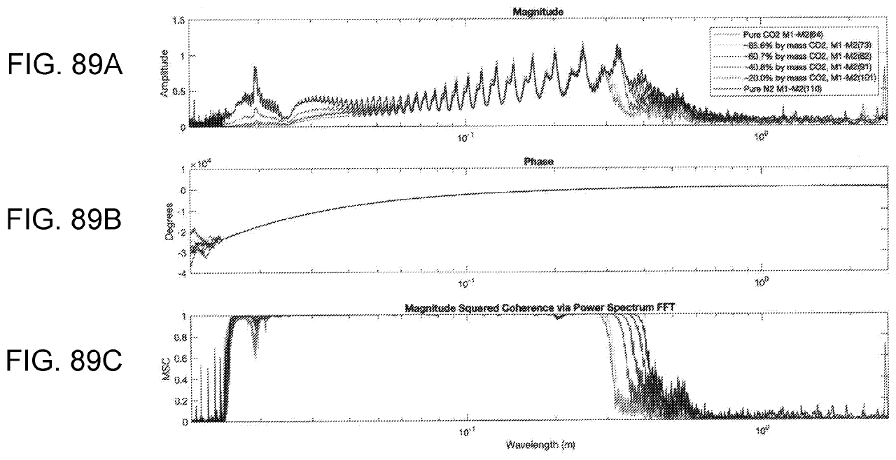

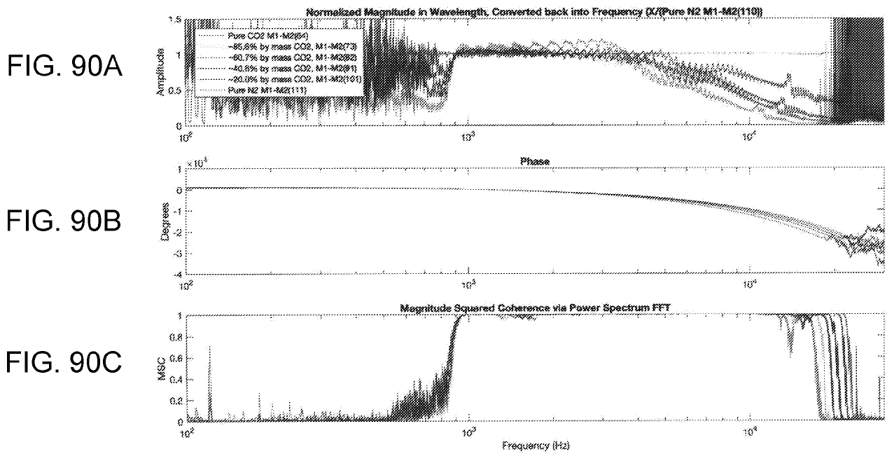

The next step was to use the phase and magnitude squared coherence to estimate the sound speed, as described herein under Pure Delays and a Linear Phase Fitting Method for Sound Speed Estimation. With this measure, the bode plot in FIGS. 87A-87C was converted from a function of frequency to a function of wavelength (FIGS. 89A-89C). Because the transfer function of the speaker and microphone were no longer part of the system being characterized, this transformation simply aligned the resonant structures and allows the dynamics caused by the geometry, G, to be removed. The attenuation due to classical and nonclassical effects normalized against a standard gas as a function of wavelength were left. Using the sound speed estimates again for each sample, these normalized results were converted back into a function of frequency, which is shown in FIGS. 90A-90C.

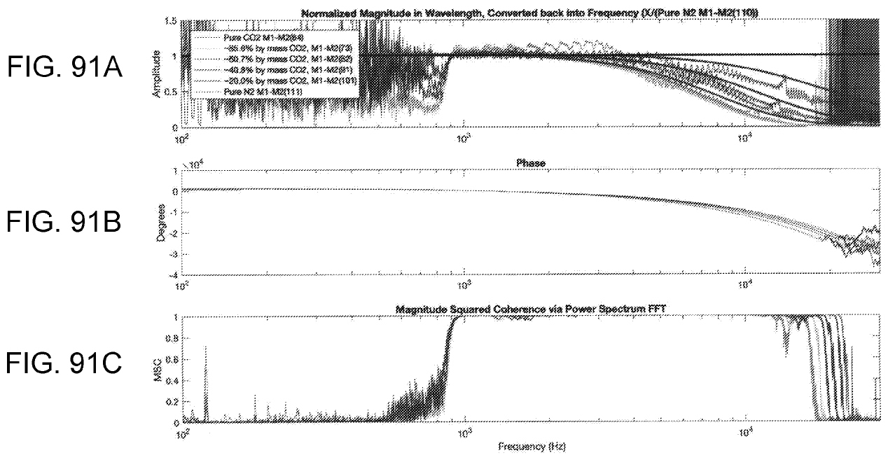

Then the simulated normalized results were plotted on top of these normalized experimental results. This plot is shown in FIGS. 91A-91C. Note that the simulation provides good estimates for nearly all of the normalized amplitude responses.

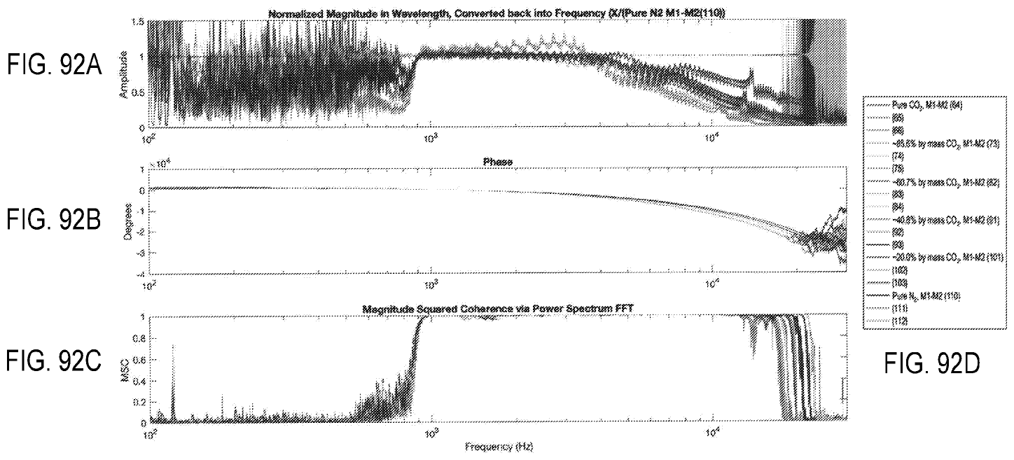

These measurements were repeated three times for each gas mixture and all of these normalized results are shown in FIGS. 92A-92C with the legend shown in FIG. 92D. This plot gives an idea of the repeatability between measurements.

The oscillations present in the normalized results are likely due to slight mis-alignments of the resonant dynamics, which can occur because of minor inaccuracies in the sound speed estimation. If a sound speed estimation is slightly wrong, the amplitude structure, when recast as a function of wavelength, will not exactly align with the standard gas amplitude. When the normalization is carried out, the offset manifests as an oscillation. The error in the sound speed estimate could be caused by many things, including nonuniform temperature along the transmission length, communication of sound energy into the tube walls (which could be transmitted at a different speed and, if detected by the microphone, could muddle the signals being transmitted through the gas alone), or dispersion within the gas (which, while minor for these mixtures over the current bandwidth, is not zero).

Table 2 shows nitrogen and carbon dioxide mixture parameters organized by test ID number. Pressure, temperature and relative humidity measurements were taken with dedicated sensors in the version 3.2 instrument. Water partial pressure was calculated, and the molar fractions were determined based on the partial pressures of the constituents in the mixing chamber (prior to introducing the test gas to the instrument).

TABLE 2
Nitrogen and carbon dioxide mixture parameters organized by test ID number

| Test ID Number | 64 | 73 | 82 | 91 | 101 | 110 |
|---|---|---|---|---|---|---|
| Pressure (kPa) | 101.22 | 108.29 | 102.97 | 102.70 | 102.52 | 102.51 |
| Temperature (K) | 300.99 | 300.81 | 299.79 | 300.06 | 300.06 | 299.76 |
| RH (%) | 9.2607 | 7.9835 | 6.4805 | 6.4408 | 5.5947 | 3.1861 |
| Water Partial Pressure (Pa) | 347.03 | 296.16 | 226.36 | 228.60 | 198.61 | 111.12 |
| CO₂ Mole Fraction | 0.99657 | 0.78860 | 0.49441 | 0.30424 | 0.13741 | 0 |
| N₂ Mole Fraction | 0 | 0.20867 | 0.50339 | 0.69353 | 0.86065 | 0.99892 |
| H₂O Mole Fraction | 0.00343 | 0.00273 | 0.00220 | 0.00223 | 0.00194 | 0.00108 |

### Simulations and Experimental Results for Helium and Nitrogen Mixtures

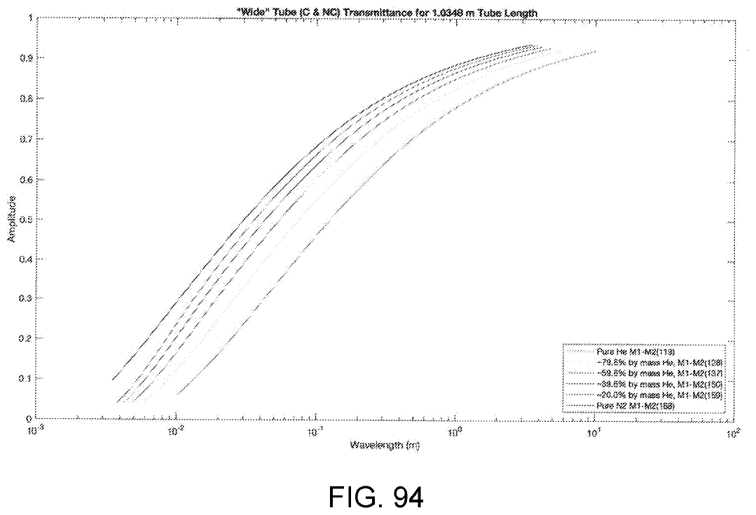

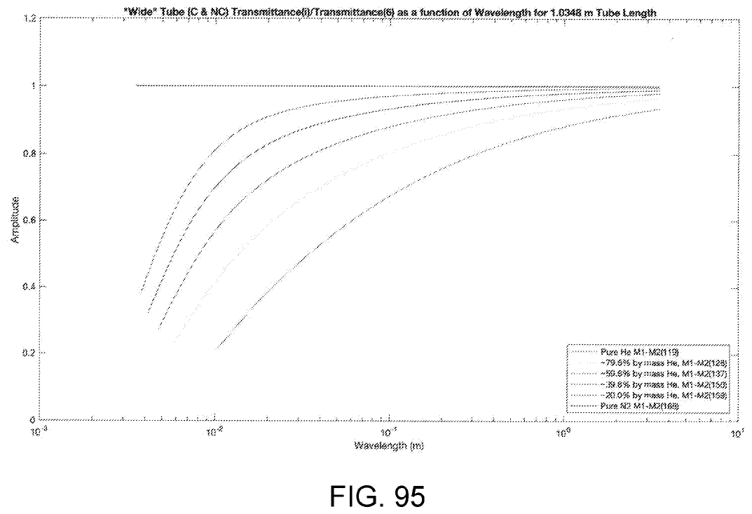

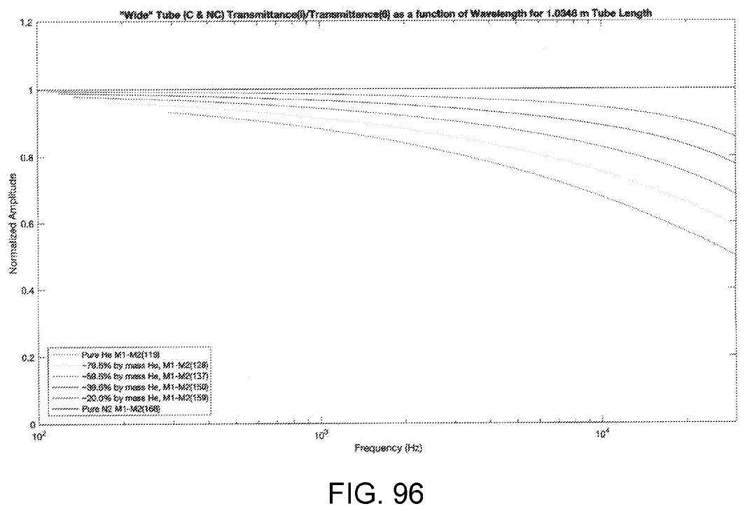

The classical attenuation differences present in mixtures of helium and nitrogen (with trace amounts of water vapor) were also measured. Table 3 shows the experimental conditions for the tests. The transmittances (which are affected by the total attenuation) given the design of version 3.2 for each of these samples were simulated and are shown in FIG. 93. These transmittances were plotted as a function if wavelength and normalized (with respect to the nitrogen simulated standard, test ID 168) (FIG. 94 and FIG. 96). These normalized simulated transmittances were converted back into a function of frequency and are shown in FIG. 96.

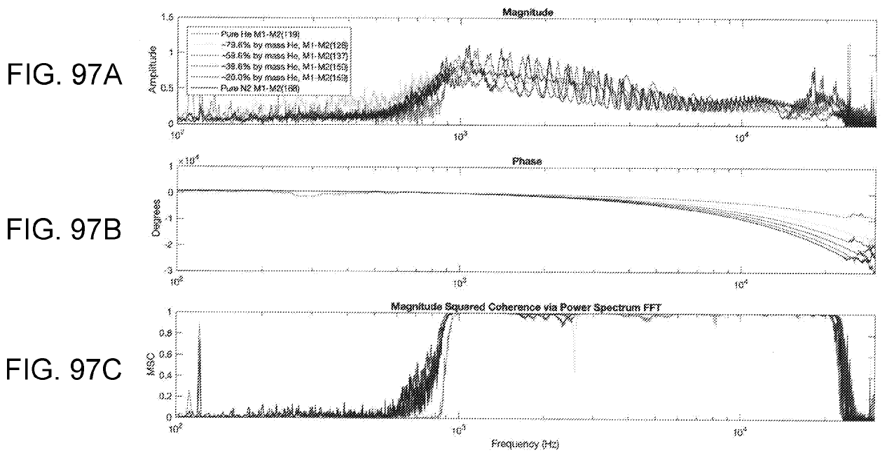

The gas mixtures listed in Table 3 were then realized in version 3.2 and probed using the system identification methods described in System Identification. The raw results are shown in FIGS. 97A-97C.

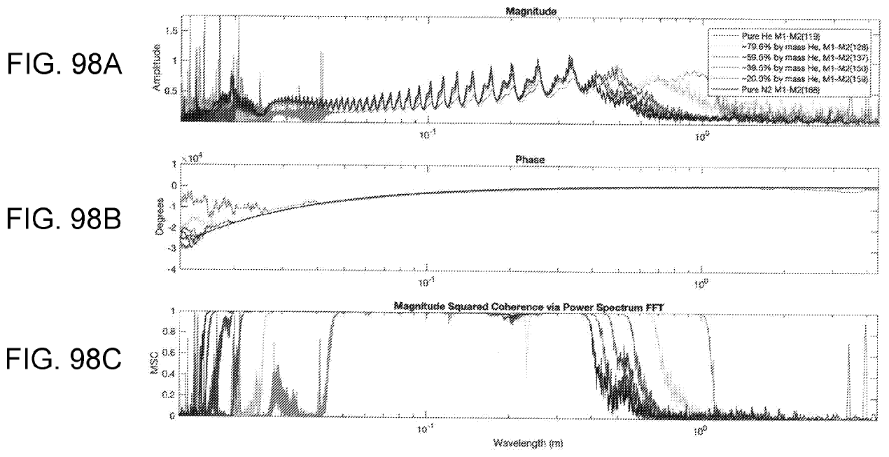

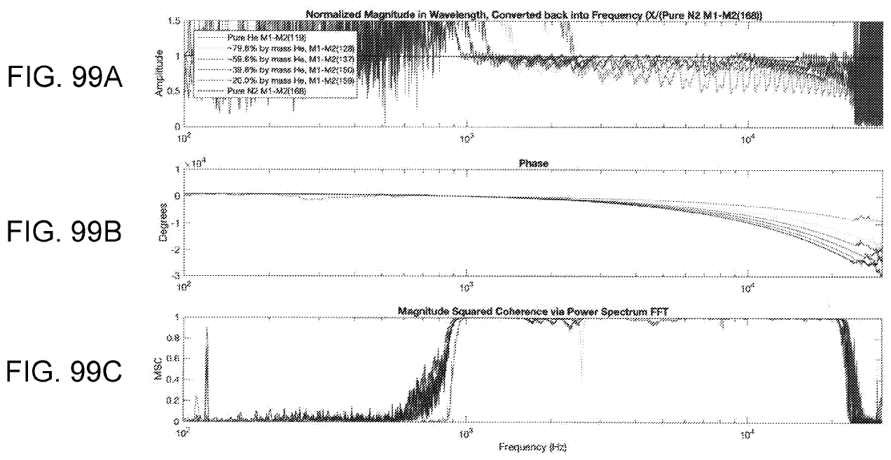

The next step was to use the phase and magnitude squared coherence to estimate the sound speed, as described herein under Pure Delays and a Linear Phase Fitting Method for Sound Speed Estimation. With this measure, d the bode plot in FIGS. 97A-7C was converted from a function of frequency to a function of wavelength (FIGS. 98A-98C). The amplitude was normalized with respect to the nitrogen standard, test ID 168. Using the sound speed estimates again for each sample, these normalized results were converted back into a function of frequency, which is shown in FIGS. 99A-99C.

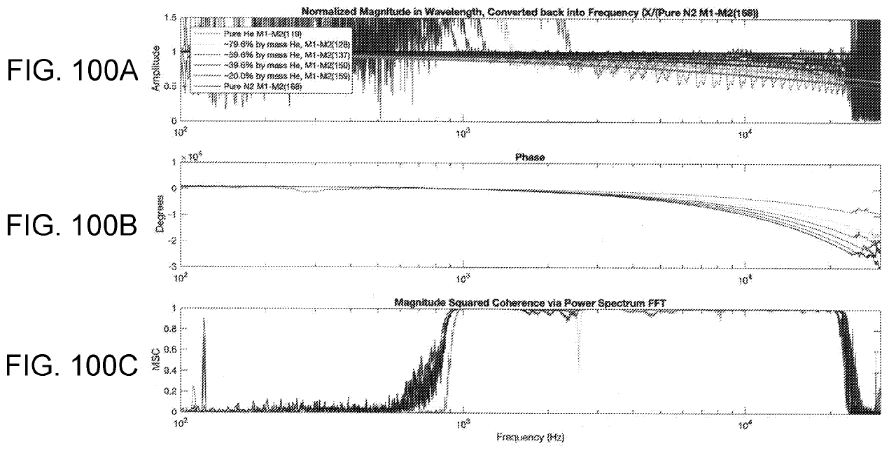

Then the simulated normalized results were plotted on top of these normalized experimental results. This plot is shown in FIGS. 100A-100C. Note that the simulation provides very accurate predictions for the classical attenuation across all mixtures tested.

Table 3 shows nitrogen and helium mixture parameters organized by test ID number. Pressure, temperature and relative humidity measurements were taken with dedicated sensors in the version 3.2 instrument. Water partial pressure was calculated and the molar fractions were determined based on the partial pressures of the constituents in the mixing chamber (prior to introducing the test gas to the instrument).

TABLE 3
Nitrogen and helium mixture parameters organized by test ID number.

| Test ID Number | 119 | 128 | 137 | 150 | 159 | 168 |
|---|---|---|---|---|---|---|
| Pressure (kPa) | 102.61 | 102.32 | 102.21 | 102.33 | 102.17 | 102.30 |
| Temperature (K) | 298.95 | 299.18 | 299.42 | 299.92 | 300.01 | 300.31 |
| RH (%) | 3.2906 | 3.4424 | 3.1357 | 4.3885 | 2.6062 | 2.6764 |
| Water Partial Pressure (Pa) | 109.39 | 116.01 | 107.17 | 154.51 | 92.21 | 96.36 |
| He Mole Fraction | 0.99893 | 0.71163 | 0.48363 | 0.29391 | 0.13702 | 0 |
| N₂ Mole Fraction | 0 | 0.28724 | 0.51532 | 0.70458 | 0.86208 | 0.99906 |
| H₂O Mole Fraction | 0.00107 | 0.00113 | 0.00105 | 0.00151 | 0.00090 | 0.00094 |

### Simulations and Experimental Results for Sulfur Hexafluoride and Nitrogen

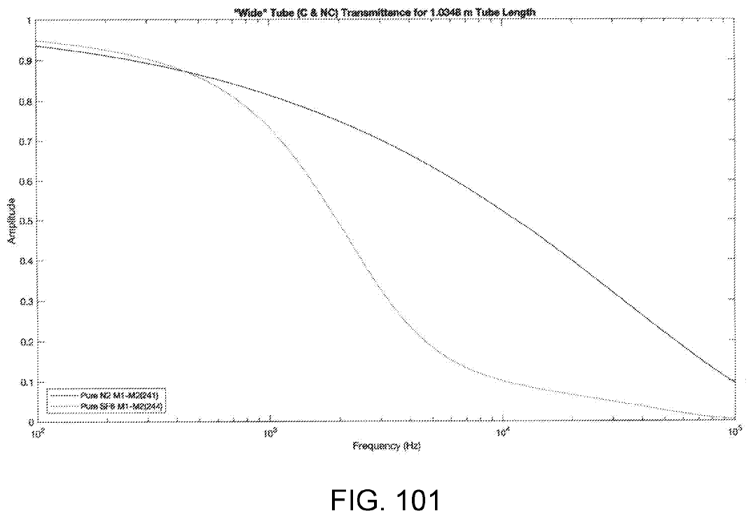

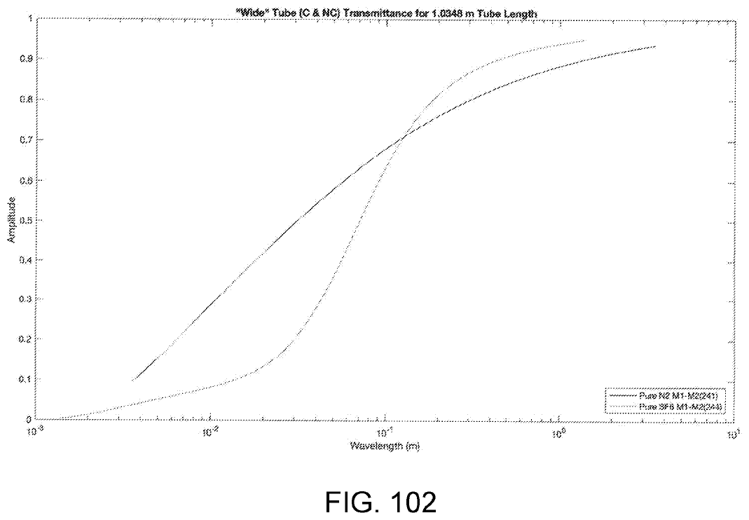

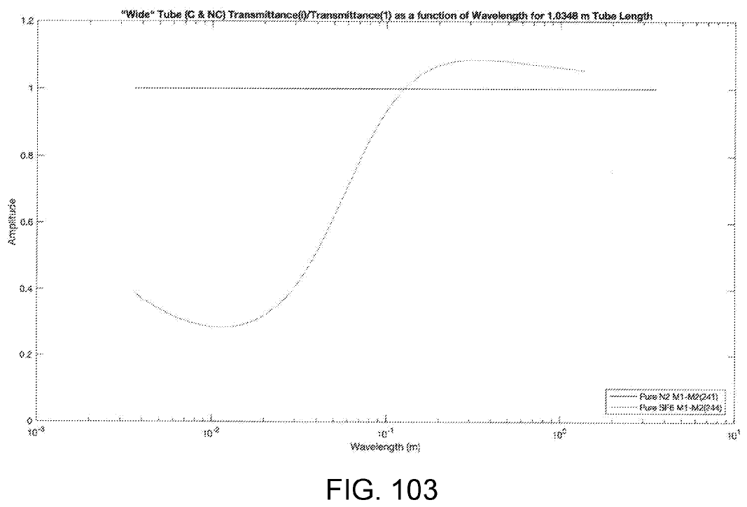

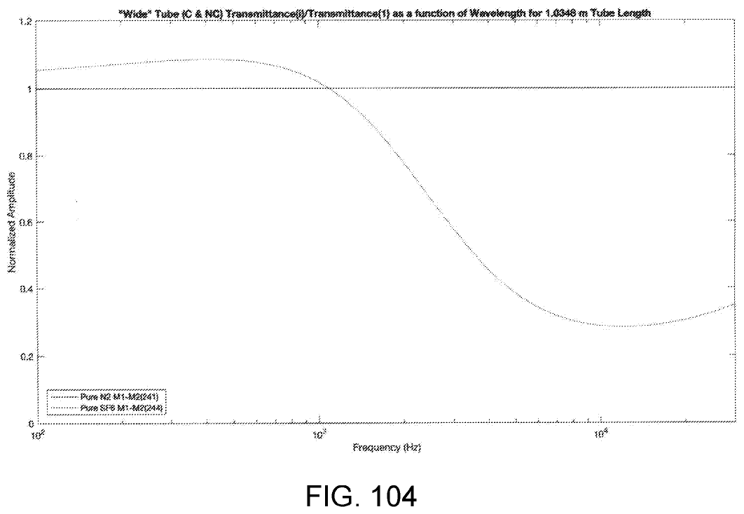

Finally, the classical attenuation differences present pure sulfur hexafluoride and nitrogen (with trace amounts of water vapor) were measured. Table 4 shows the experimental conditions for the tests. The transmittances (which are affected by the total attenuation) given the design of version 3.2 for each of these samples were simulated and are shown in FIG. 101. These transmittances were plotted as a function if wavelength and normalized (with respect to the nitrogen simulated standard, test ID 241) (FIG. 102 and FIG. 103). These normalized simulated transmittances were converted back into a function of frequency and are shown in FIG. 104.

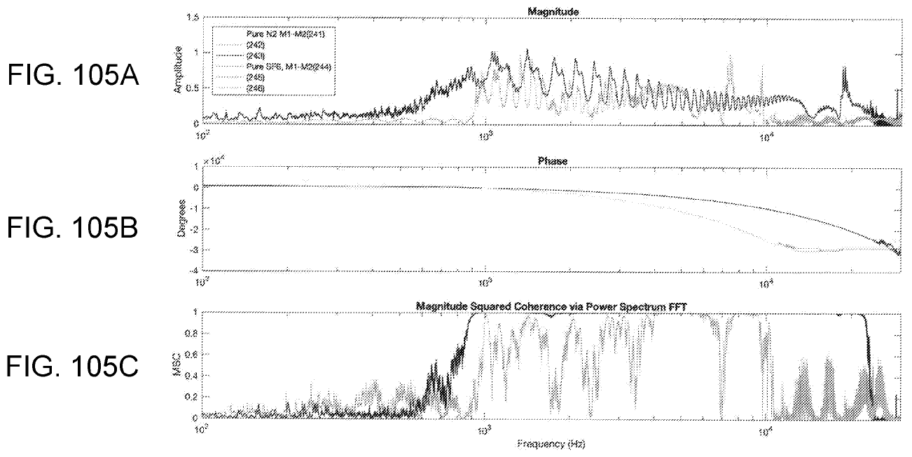

The gas mixtures listed in Table 4 were then realized in version 3.2 and probed using the system identification methods described herein. The raw results are shown in FIGS. 105A-105C.

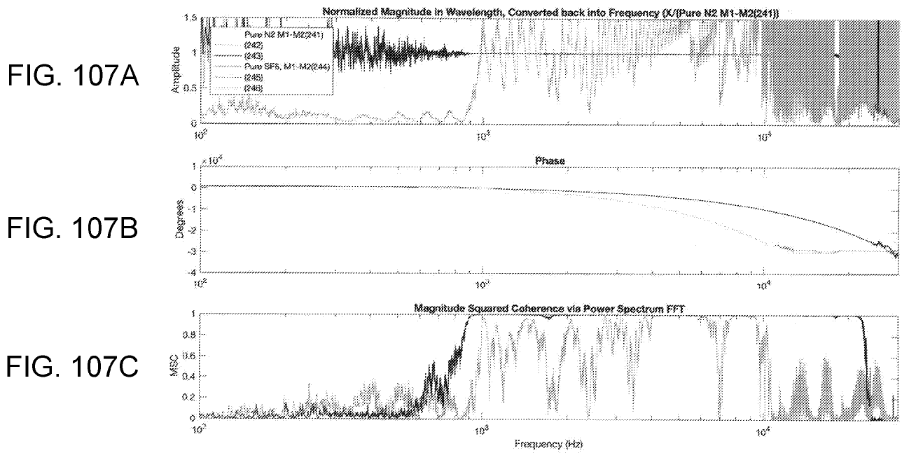

The next step was to use the phase and magnitude squared coherence to estimate the sound speed, as described herein under Pure Delays and a Linear Phase Fitting Method for Sound Speed Estimation. With this measure, the bode plot in FIGS. 105A-105C was converted from a function of frequency to a function of wavelength (FIGS. 106A-106C). The amplitude was normalized with respect to the nitrogen standard, test ID 241. Using the sound speed estimates again for each sample, these normalized results were converted back into a function of frequency, which is shown in FIGS. 107A-107C.

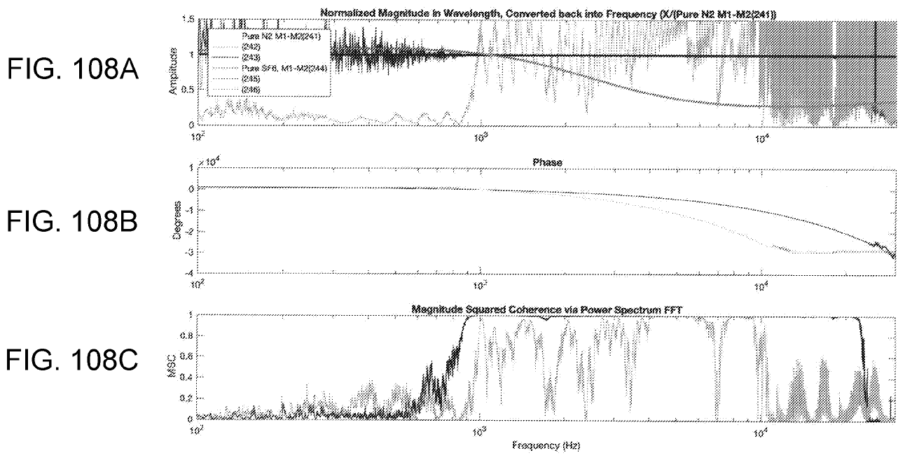

Then, the simulated normalized results were plotted on top of these normalized experimental results. This plot is shown in FIG. 108A-108C. Note that the simulation greatly overestimates the strength of the attenuation in sulfur hexafluoride with respect to nitrogen. There was not an expected baseline behavior other than the model disclosed herein. Approximations were made to locate a number of molecular parameters for sulfur hexafluoride used in the model herein.

Table 4 shows nitrogen and sulfur hexafluoride parameters organized by test ID number. Pressure, temperature and relative humidity measurements were taken with dedicated sensors in the version 3.2 instrument. Water partial pressure was calculated. Note that only pure samples were investigated (with trace amounts of water).

TABLE 4
Nitrogen and sulfur hexafluoride parameters organized by test ID number.

| Test ID Number | 241 | 242 | 243 | 244 | 245 | 246 |
|---|---|---|---|---|---|---|
| Pressure (kPa) | 100.31 | 100.38 | 100.46 | 100.48 | 100.62 | 100.68 |
| Temperature (K) | 301.85 | 301.86 | 301.85 | 302.01 | 302.20 | 302.27 |
| RH (%) | 0.6531 | 1.0109 | 1.1238 | 0.4005 | 0.6538 | 0.8019 |
| Water Partial Pressure (Pa) | 25.73 | 39.86 | 44.29 | 15.93 | 26.29 | 32.37 |
| SF₆ Mole Fraction | 0 | 0 | 0 | 0.99984 | 0.99974 | 0.99968 |
| N₂ Mole Fraction | 0.99974 | 0.99960 | 0.99956 | 0 | 0 | 0 |
| H₂O Mole Fraction | 0.00026 | 0.00040 | 0.00044 | 0.00016 | 0.00026 | 0.00032 |

### Simulations for Methane and Nitrogen Mixtures

Not all gases are compatible with version 3.2. This includes flammable and toxic gases. However, with the simulation package, the expected attenuation could be predicted. As a potent greenhouse gas, methane has a global warming potential thirty times worse than carbon dioxide over 100 years. As such, the ability for this sensing paradigm to detect methane would be of great utility for the protection of the environment.

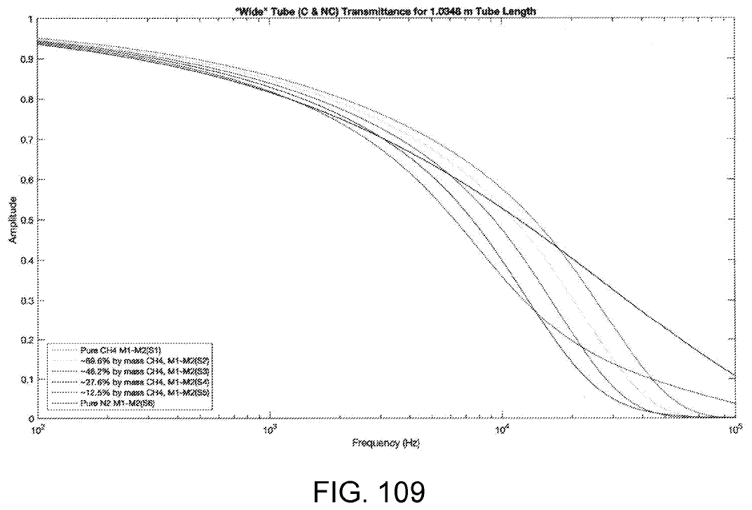

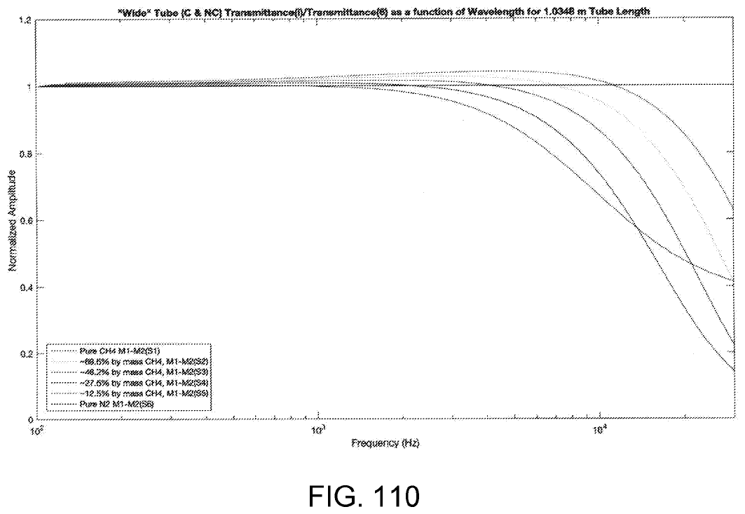

The transmittances (which are affected by the total attenuation) given the design of version 3.2 for each of these samples are shown in FIG. 109, and the normalized simulations (with respect to the nitrogen standard S6, when curves were plotted as a function of wavelength) are shown in FIG. 110. Note that intermediate steps, like those shown in previous sections, are not shown for brevity. With the design of version 3.2, a strong discriminatory potential was predicted between nitrogen and methane by using acoustic attenuation.

### Impulse Response Results

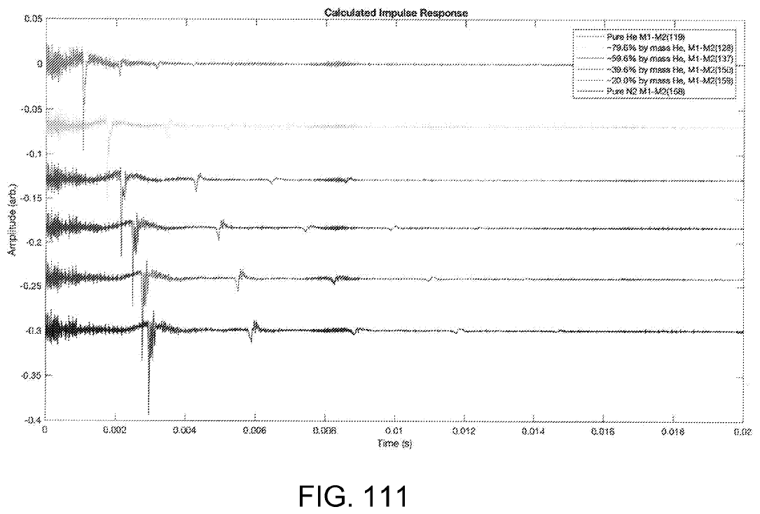

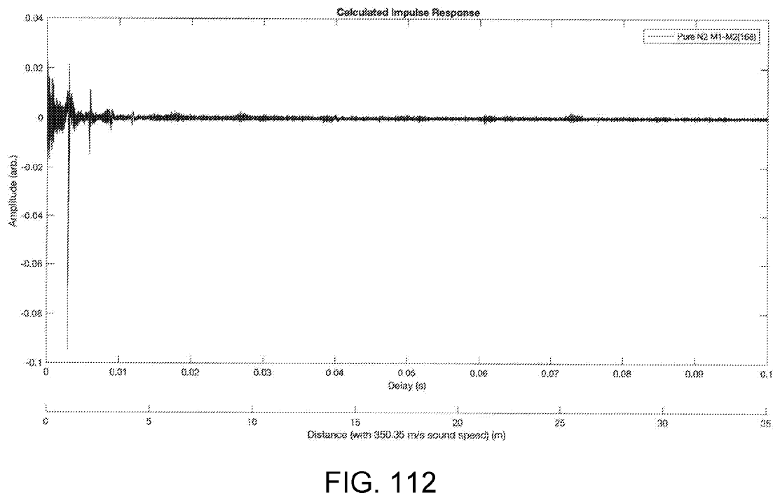

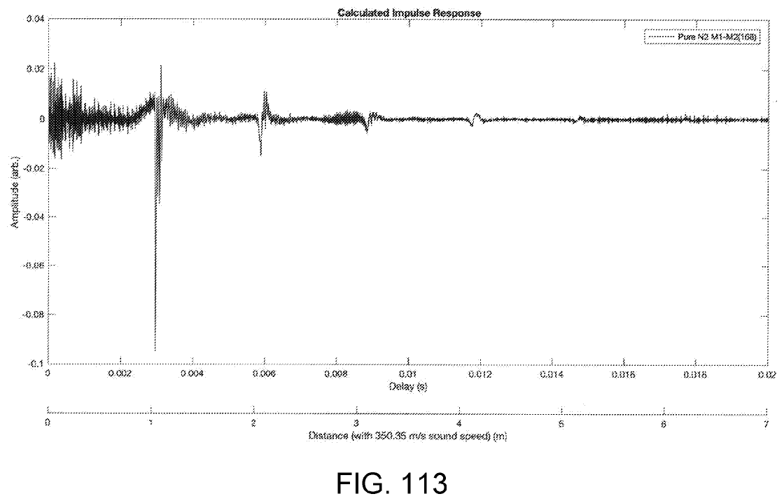

A bode plot displays the dynamics of a linear, time invariant system as a function of frequency. However, the dynamics of such a system can also be displayed as a function of time. The impulse response is the inverse Fourier transform of the frequency response. This section shows the impulse response calculated for various mixtures of helium and nitrogen (shown in FIG. 111), the impulse response of nitrogen (with the sound speed used to plot a second x-axis indicating distance traveled with respect to the lag, shown in FIG. 112), and a second plot of FIG. 112 zoomed in to a shorter lag length (shown in FIG. 113).

### Simulation Package Refinement

The acoustic attenuation spectrometers disclosed herein may also be used to model bromomethane, bromine, chloroform, chloromethane, deuterium, ethane, fluoromethane, hydrogen cyanide, nitrogen dioxide, nitrogen trifluoride, propane, or any additional gasses with similar properties. Further, all fundamental resonant modes of acetylene, ethylene, and sulfur hexafluoride could be used to improve the simulation accuracy.

### Additional Applications

The classical model can be further expanded to vertical acoustic motion in curved ducts. The nonclassical model can be expanded to improve fitting of the exponential potential to take into account interactions between polar molecules.

### Plasma Actuator

The high frequency microphones (SPU0410LR5H by Knowles) can be used to perform analysis at higher frequencies., up to 80 kHz. Alternatively, a plasma actuator could be used as a high frequency actuator

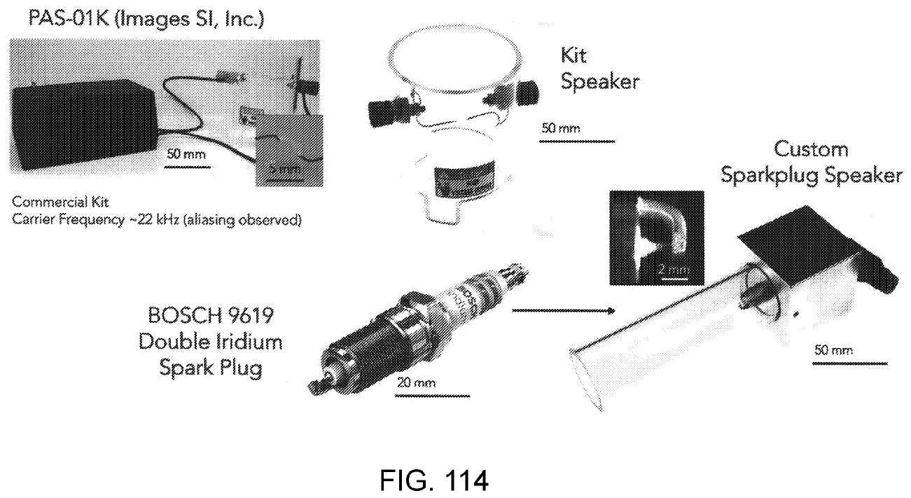

Plasma actuators operate by modulating an ionized arc at acoustic frequencies. These actuators have the ability to be modulated at extremely high frequencies, as they are not limited in bandwidth by the mass of a traditional diaphragm. A kit (PAS-01K by Images SI, Inc.) in addition to a custom spark gap speaker fitted with an automotive spark plug (9619 Double Iridium Spark Plug by Bosch) were constructed and are shown in FIG. 114.

### Square Tube Cross Section

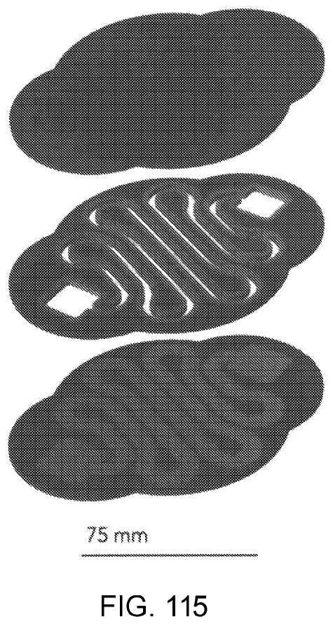

Ducts bends with square cross sections have been shown to be more efficient at transmitting acoustic plane waves versus circular cross section tubes. A sandwiched PCB design for a serpentine square cross section transmission length is shown in FIG. 115.

### Mirrored Actuators

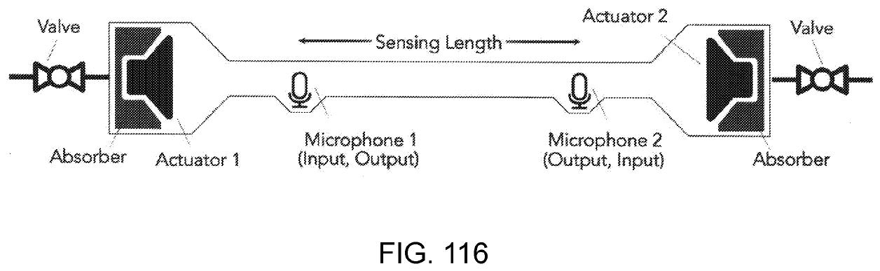

Implementing dual fire actuators (as shown in the assembled hardware shown in FIG. 68 and, more clearly, in the schematic shown in FIG. 116) may provide useful symmetry to confirm correct sensor and actuator function, double check readings, and take flow measurements (half of the difference in the sound speed between the forward and backward sound speed measurement would produce the flow speed). The model can be further expanded to perform backwards and forwards characterization simultaneously if the signal emanating from actuator 1 was uncorrelated with the signal emanating from actuator 2. Note that in one direction, the first microphone would be upstream and the second microphone would be downstream, but in the opposite direction the upstream and downstream designation would be flipped. Version 3.2, can be modified to use this configuration due to the plug-and-play nature of the design.

### Minimum Sensor Size

Of central importance for many applications is the minimum sensor size, given current understanding of the physics. Full analysis for each gas using our simulation package is required for an accurate notion of minimum sensor constraints. For example, distinguishing between pure nitrogen and pure carbon dioxide. Given the maximum frequency measurable using currently available broadband transducers (80 kHz), the acoustic spectrometer has a minimum optimal length of approximately 100 mm for detecting differences arising from nonclassical attenuation (see FIG. 52). While highly resonant ultrasonic piezoelectric actuators may able to probe much higher frequencies (and thus operate optimally at detecting differences in acoustic attenuation at much shorter transmission lengths), these transducers are limited to single-frequency measurements , and the sensor would be more prone to errors arising from interference or noise). However, the system identification techniques disclosed herein would still prove useful to deploy. Recall (Eqn. 3.3) that the viscous and thermal conductivity classical attenuation coefficient goes as a 1/rₑ (inverse effective radius) in wide tubes and as 1/r²ₑ and 1/r³ₑ for narrow tube corrections. Because, in this case, the interest is in leveraging nonclassical effects, keeping the transmission tube as wide as possible would reduce the effects of confined classical attenuation. Finally, the minimum radius of curvature is of interest. In following the work presented herein, a curvature of at least 2.5 (shown in FIG. 63) is safe. Therefore, a tube with a diameter of 12.7 mm could have a center curvature radius of 31.75mm with no ill effect. However, given the already short transmission length of 100mm, this curvature would simply curve the device into a half circle and coiling the device is useful for longer optimal transmission lengths.

### Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of.” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A spectrometer, comprising:
an emitter to perturb a material with acoustic energy in response to an input signal, acoustic energy having at least two distinct frequency components;
a set of receivers to generate a set of output signals, each receiver in the set of receivers disposed at a different distance from the emitter than each other receiver of the set of receivers, each receiver measuring a response of the material to the acoustic energy as an output signal in the set of output signals, the output signal for that receiver based on the distance of that receiver to the emitter; and
a controller, operably coupled to the emitter and the set of receivers, to drive the emitter with the input signal, to measure the set of output signals from the set of receivers, and to perform a signal analysis based on the input signal and the set of output signals, the signal analysis yielding a characteristic response of the material to the acoustic energy.

2. The spectrometer of claim 1, wherein the materials a fluid.

3. The spectrometer of claim 1, he input signal comprises a stochastic signal.

4. The spectrometer of claim 1, wherein the emitter and the set of receivers are operable over a frequency band from about 20 Hz to about 20 kHz.

5. The spectrometer of claim 1, wherein the emitter and the set of receivers are operable over a bandwidth greater than about 20 kHz.

6. The spectrometer of claim 1, wherein the signal analysis comprises determining a linear dynamic component to model the characteristic response.

7. The spectrometer of claim 6, wherein the signal analysis further comprises determining a non-linear static component to model the characteristic response.

8. The spectrometer of claim 1, wherein the signal analysis comprises determining a first-order Volterra kernel and at least one higher-order Volterra kernel to model the characteristic response.

9. The spectrometer of claim 1, wherein the signal analysis comprises determining at least one of a parallel cascade, a NARMAX representation, or a Wiener kernel.

10. The spectrometer of claim 1, further comprising a chamber coupled to the emitter and defining a cavity to receive the material.

11. The spectrometer of claim 10, wherein the chamber includes an opening.

12. The spectrometer of claim 10, wherein the chamber is a sealed vessel.

13. The spectrometer of claim 10, wherein the chamber has at least one resonant mode with a resonance frequency that falls within a range of frequencies contained in the input signal.

14. The spectrometer of claim 10, further comprising an acoustic reflector to reflect at least a portion of the acoustic energy, wherein the cavity to receive the material is at least partly disposed between the emitter and the acoustic reflector.

15. The spectrometer of claim 10, wherein the chamber includes a switchgear operable for electrical circuit protection.

16. The spectrometer of claim 15, wherein the material includes sulphur hexafloride.

17. The spectrometer of claim 1, further comprising an acoustic reflector to reflect at least a portion of the acoustic energy, wherein the material is at least partly disposed between the emitter and the acoustic reflector.

18. The spectrometer of claim 1, wherein the material includes methane gas.

19. A method of characterizing a material, the method comprising:
perturbing, via an emitter, the material with acoustic energy, the acoustic energy having at least two distinct frequency components;
measuring, with each receiver of a set of receivers, a response of the material to the acoustic energy as an output signal, wherein each receiver is disposed at a different distance from the emitter than each other receiver of the set of receivers and the output signal for that receiver is based on the distance of that receiver with respect to the emitter; and
performing a signal analysis based on the output signals to generate a characteristic response of the material to the acoustic energy.

20. The method of claim 19, further comprising driving the emitter with an input signal to generate the acoustic energy, wherein the input signal comprises a stochastic signal, and wherein the performing the signal analysis is based on the input signal and the output signals.

21. The method of claim 19, wherein the performing the signal analysis further comprises determining a linear dynamic component to model the characteristic response.

22. The method of claim 19, wherein the performing the signal analysis further comprises determining a non-linear static component to model the characteristic response.

23. The method of claim 19, wherein the performing the signal analysis further comprises determining a first Volterra kernel and at least one higher-order Volterra kernel to model the characteristic response.

24. The method of claim 19, wherein the performing the signal analysis further comprises determining at least one of a parallel cascade, a NARMAX representation, or a Wiener kernel.

25. The method of claim 19, wherein the performing the signal analysis further comprises:
segmenting the input signal into a set of input signal segments of length N samples each, where N is a positive integer;
segmenting the output signal into a set of output signal segments of length N samples each; calculating an input power auto-correlation spectrum for each input signal segment to generate a set of input power auto-correlation spectrums;
calculating an input output power cross-correlation spectrum for each input signal segment and its corresponding output signal segment to generate a set of input-output power cross-correlation spectrums; and
calculating the characteristic response of the material based on a ratio of an average of the set of input-output power cross-correlation spectrums to an average of the set of input power auto-correlation spectrums.

26. The method of claim 19, further comprising reflecting at least a portion of the acoustic energy with an acoustic reflector on a far side of the material from the emitter.

27. The method of claim 19, wherein the material includes methane gas.

28. A method of detecting methane in ambient ambient air, the method comprising:
driving an emitter with an input signal, the emitter including an interface to interact with the ambient air;
perturbing, via the interface of the emitter, the ambient air with acoustic energy generated in response to the input signal, the acoustic energy having at least two distinct frequency components;
measuring a set of output signals with a set of receivers, wherein each receiver is disposed at a different distance from the emitter than each other receiver of the set of receivers, a response of the methane to the acoustic energy as an output signal of the set of output signals, the output signal for that receiver based on the distance of that receiver to the emitter; and
performing a signal analysis based on the input signal and the set of output signals to generate a characteristic response of the methane to the acoustic energy, thereby identifying the presence of methane in the ambient air, the signal analysis including:
segmenting the input signal into a set of input signal segments of length N samples each;
segmenting the output signal into a set of output signal segments of length N samples each;
calculating an input power auto-correlation spectrum for each input signal segment to generate a set of input power auto-correlation spectrums;
calculating an input output power cross-correlation spectrum for each input signal segment and its corresponding output signal segment to generate a set of input output power cross-correlation spectrums; and
calculating the characteristic response of the methane in the ambient air based on a ratio of an average of the set of input output power cross-correlation spectrums to an average of the set of input power auto-correlation spectrums.

29-32. (canceled)
